(19) United States
(12) Patent Application Publication
(10) Pub. No.: US 2015/0203931 A1
(43) Pub. Date: Jul. 23, 2015

(54) METHOD FOR PRODUCING METALLIC IRON

(71) Applicant: KABUSHIKI KAISHA KOBE SEIKO SHO (KOBE STEEL, LTD.), Kobe-shi, Hyogo (JP)

(72) Inventors: Takeshi Sugiyama, Kobe-shi (JP); Takao Harada, Kobe-shi (JP); Junichi Shiino, Kobe-shi (JP); Tsuyoshi Mimura, Kobe-shi (JP); Katsuyuki Iijima, Kobe-shi (JP); Takanori Oka, Kobe-shi (JP)

(73) Assignee: KABUSHIKI KAISHA KOBE SEIKO SHO (KOBE STEEL, LTD.), Kobe-shi, Hyogo (JP)

(21) Appl. No.: 14/416,175

(22) PCT Filed: Aug. 5, 2013
(86) PCT No.: PCT/JP2013/071178

§ 371 Date: Jan. 21, 2015

(30) Foreign Application Priority Data
Aug. 3, 2012 (JP) 2012-173453
Aug. 3, 2012 (JP) 2012-173454
Apr. 23, 2013 (JP) 2013-090688
May 24, 2013 (JP) 2013-110283

(51) Int. Cl. C21B 11/08; B03C 1/30; C22B 5/10; C21B 13/10; C22B 1/16; C22B 1/24; B03C 1/02; B07B 9/00

(52) U.S. Cl. CPC C21B 11/08; B03C 1/02; B03C 1/30; B07B 9/00; C21B 13/10; C22B 1/16; C22B 1/24; C22B 5/10; B03C 2201/20

(57) ABSTRACT

The first purpose of the present invention is to provide a method for producing metallic iron, whereby, in the production of metallic iron by heating an agglomerate, which comprises an iron oxide-containing material and a carbonaceous reductant, in a movable hearth type heating furnace, metallic iron can be efficiently collected from a reduced product containing metallic iron and a slag, said reduced product being obtained by heating the agglomerate. The method for producing metallic iron according to the first embodiment of the present invention comprises: a step for forming an agglomerate of a mixture which comprises an iron oxide-containing material and a carbonaceous reductant; a step for introducing the obtained agglomerate into a movable hearth type heating furnace and reducing the same by heating; a step for crushing a reduced product containing metallic iron and a slag, said reduced product being discharged from the movable hearth type heating furnace, using an impact crusher; and a step for selecting and collecting the metallic iron using a separator.

### TECHNICAL FIELD

The present invention relates to a method for producing metallic iron by heating an agglomerate, obtained by forming an agglomerate of a mixture including iron oxide-containing material and a carbonaceous reductant, in a movable hearth type heating furnace.

### BACKGROUND ART

Methods for producing metallic iron from iron oxide-containing material such as iron ore or the like are classified into several types, depending on the method of separating gangue component included in the iron oxide-containing material.

An iron making process in a consistent way, using a blast furnace, is the method which enables the greatest amount of metallic iron to be produced. This method involves using high-grade iron ore including little gangue component, or using an iron oxide-containing material consisting of iron ore of which the grade of iron has been improved by concentration, which are heated in a blast furnace to be reduced and melted, and separated into the gangue component and pig iron (carbon saturated iron) in the molten state, thereby producing the metallic iron.

A method which is next regarding the amount of metallic iron which can be produced is the gas DR method using natural gas. This method involves reducing pellets, obtained by sintering extremely high-grade iron ore, using natural gas to form reduced pellets, which are introduced into an electric furnace, melted and smelted, thereby producing steel (low-carbon steel) from which the gangue component has been completely separated.

Metallic iron production methods developed in recent years include a FASTMET method where an agglomerate, obtained by mixing an iron oxide-containing material such as iron ore or the like and a carbonaceous reductant such as carbon material, is heated at a high temperature, around 1300° C., to produce a reduced agglomerate, and an ITmk3 method where a reduced agglomerate is further heated and melted, and metallic iron nuggets (granular metallic iron) are produced.

The FASTMET method enables the gangue component to be completely separated from the steel, by melting and smelting the obtained reduced agglomerate in an electric furnace. This method resembles the above-described DR method with regard to the point that all gangue components in the reduced agglomerate are introduced into the electric furnace, but is different in that the reduced agglomerate includes gangue component in the carbonaceous reductant. Introducing a great amount of gangue component into the electric furnace in the gas DR method and FASTMET method increases the melting heat of the electric furnace. Accordingly, using material containing little gangue is a prerequisite.

On the other hand, a feature of the ITmk3 method is that hardly any slag is carried over into the steelmaking process, since separation into metallic iron and slag occurs on the hearth of the furnace, which is similar to the blast furnace method described above. However, the blast furnace method and ITmk3 method involve heating at high temperatures, and accordingly exhibit increased energy if a great amount of gangue component is present in the material. Accordingly, using material containing little gangue is a prerequisite for the raw material.

Thus, the FASTMET method and ITmk3 method both require as little gangue component included in the material as possible. For example, a reduced product, obtained by reducing by heating an agglomerate including iron ore having a gangue component of 9% (total amount of SiO₂ and Al₂O₃) and coal having ash content of 10%, contains 15% slag (total amount of SiO₂ and Al₂O₃), so use in either of an electric furnace or blast furnace is difficult.

PTL 1 through 3 are known technologies for producing metallic iron by heating an agglomerate obtained by mixing iron oxide-containing material and a carbonaceous reductant.

PTL 1 describes performing a process of reducing by heating a mixture containing an iron oxide material and coal under a high-temperature atmosphere, performing a crushing process of the obtained reduced iron, and then sorting by granularity with a predetermined grain size as a boundary. Specifically, a granularity separator is used to separate and sort grains exceeding an average grain size of 100 μm and grains having an average grain size of 100 μm or smaller. The grains having an average grain size of 100 μm or smaller are separated by magnetic force into strongly magnetically attractable grains including a great iron content and weakly magnetically attractable grains including little iron content, and the aforementioned reduced iron grains exceeding the predetermined granularity in the granularity separation, and the aforementioned strongly magnetically attractable grains, are used as reduced iron. On the other hand, the weakly magnetically attractable grains include little iron content and include much slag content, and accordingly are reused in cement or asphalt as they are.

PTL 2 describes a method for producing high-grade reduced iron from ironmaking dust in producing high-grade reduced iron, in which carbon-containing pellets consisting of multiple types of dust and carbon material are produced, and a reduction process thereof is performed at 1250 to 1350° C. in a rotary hearth type firing furnace. This reduces the dust within the pellets by the carbon material, and metallic iron grains are extracted employing the process in which metallic iron grains aggregated by intraparticle mass transfer are naturally separated from the low-melting-point slag portion including FeO that has been generated from the gangue in the dust.

PTL 3 describes a method for producing high-purity granular metallic iron, in which carbon-containing pellets consisting of iron ore and carbon material are produced, and a reduction process thereof is performed at 1250 to 1350° C. in a rotary hearth type firing furnace, following which the furnace temperature is further raised to 1400 to 1500° C. to induce melting, thereby causing aggregation of the metallic iron.

PTL 4 describes a method for producing metallic iron, in which a metallic iron crust is generated and grown by reducing by heating, and reduction is advanced until iron oxide becomes substantially non-existent at the interior, while an aggregate of generated slag is formed at the interior.

Now, PTL 5 describes directly reducing iron ore at 700° C. or hotter, and then crushing and separating to yield iron flakes and refractory grains. In this Literature, a sifter having a mesh size of 20 is used to screen the flakes, and the flakes remaining on the sifter and the gangue under the sifter are each crushed, following which the smelted iron is separated and collected.

### CITATION LIST

### Patent Literature

PTL 1: Japanese Unexamined Patent Application Publication No. 2002-363624

PTL 2: Japanese Unexamined Patent Application Publication No. 10-147806

PTL 3: Japanese Unexamined Patent Application Publication No. 2002-30319

PTL 4: Japanese Unexamined Patent Application Publication No. 9-256017

PTL 5: U.S. Pat. No. 6,048,382

### SUMMARY OF INVENTION

### Technical Problem

An embodiment described in the aforementioned PTL 1 aims to produce reduced pellets with a heating temperature of 1200 to 1300° C., and does not take into consideration separating into metallic iron and slag on the heating furnace hearth. Also, a roll press is used for crushing, but usage conditions thereof are not disclosed, and crushing methods other than the roll press are not mentioned. Further, according to an embodiment, the iron purity is no more than 76 to 90% even for iron with good purity having granularity of 100 μm or larger. Metallic iron having purity of this order is difficult to use as a steelmaking material. It can be conceived that the reason why the iron purity is thus no more than 76 to 90% is because the heating temperature and crushing method are not appropriate.

PTL 2 describes screening reduced iron obtained from a rotary hearth type firing furnace using a screen, and collecting reduced iron having a diameter of 5 mm or larger as a product. This technology involves producing molten iron and molten slag on the hearth, and accordingly falls under the ITmk3 method. However, this Literature does not describe the crushing process, although collecting a metallic iron product from the heating/reducing product discharged from the reducing furnace using a sifter and magnetic separator is described.

PTL 3 describes a method for completely melting reduced iron to separate into reduced iron and slag. However, this Literature only describes separating the granular metallic iron generated in the furnace and the by-product slag using a magnetic separator and sifter, and the crushing process is not described.

PTL 4 and 5 also disclose a technology where a mixture including an iron oxide-containing material and a carbon material are heated, and the obtained metallic iron and slag are separated. However, improving the separability of the metallic iron and slag is not studied. There is also required development of a method to produce metallic iron, in which a metallic iron-containing sintered body of which separability into metallic iron and slag has been improved can be efficiently separated into metallic iron and slag.

The present invention has been made in light of the above-described circumstances, and accordingly it is an object of the present invention to provide a method for producing metallic iron in which metallic iron can be efficiently collected. More specifically, it is a first object of the present invention to provide a method for producing metallic iron in which metallic iron can be efficiently collected from a reduced product including metallic iron and slag, obtained by heating an agglomerate of an iron oxide-containing material and a carbonaceous reductant in a movable hearth type heating furnace to produce metallic iron.

It is a second object of the present invention to provide a method for producing metallic iron in which metallic iron can be efficiently collected from discharged matter, when forming an agglomerate of a mixture including iron oxide-containing material and a carbonaceous reductant, heating in a movable hearth type heating furnace, and then separating waste discharged from the furnace into metallic iron and slag, and collecting the metallic iron to produce metallic iron.

### Solution to Problem

The essence of a method for producing metallic iron according to the present invention, which has been able to solve the above problem, is in that the method includes:

a process of forming an agglomerate of a mixture containing an iron oxide-containing material and a carbonaceous reductant;

a process of introducing the obtained agglomerate into a movable hearth type heating furnace and reducing by heating;

a process of crushing a reduced product containing metallic iron and slag that has been discharged from the movable hearth type heating furnace, using a crusher; and

a process of sorting using a separator and collecting the metallic iron.

In further detail, the essence of a method for producing metallic iron according to the present invention, which has been able to achieve the first object (hereinafter, also referred to as first invention), is in that the method includes: a process of forming an agglomerate of a mixture containing an iron oxide-containing material and a carbonaceous reductant; a process of introducing the obtained agglomerate into a movable hearth type heating furnace and reducing by heating; a process of crushing a reduced product containing metallic iron and slag that has been discharged from the movable hearth type heating furnace, using an impact crusher; and a process of sorting using a separator and collecting the metallic iron.

The method for producing may further include: a process of screening the reduced product containing metallic iron and slag that has been discharged from the movable hearth type heating furnace, into coarse particulate matter and fine particulate matter, using a sifter a; a process of crushing the obtained coarse particulate matter using an impact crusher; and a process of collecting the metallic iron using a separator.

A hammer crusher, cage crusher, rotor crusher, ball crusher, roller crusher, or rod crusher may be used as the crusher, for example. A crusher which applies impact from one direction is preferably used as the crusher.

The bulk density of the coarse particulate matter may be 1.2 to 3.5 kg/L.

The coarse particulate matter may be magnetically separated using a magnetic separator prior to crushing the coarse particulate matter and a magnetically attractable substance be collected, and the collected magnetically attractable substance be crushed.

A magnetic separator, wind separator, or sifter b may be used as the separator. In a case where the sifter b is used as the separator, undersieve is preferably separated using a magnetic separator and metallic iron is collected, following screening having been performed using the sifter b. A sifter having a sieve opening of 1 to 8 mm is preferably used as the sifter b.

The method for producing according to the present invention preferably further includes a pulverizing process of pulverizing the magnetically attractable substance, obtained by selecting using the magnetic selector, using a pulverizer. Also preferable is the pulverized matter obtained in the pulverizing process again being pulverized again using the pulverizer. Also preferable is the pulverized matter obtained in the pulverizing process being separated using a magnetic selector and magnetically attractable substance being collected.

The collected magnetically attractable substance may be formed into an agglomerate.

A ball crusher, rod crusher, cage crusher, rotor crusher, or roller crusher, may be used as the crusher, for example.

The above-described problem may also be solved by a method for producing metallic iron, including: a process of forming an agglomerate of a mixture containing an iron oxide-containing material and a carbonaceous reductant; a process of introducing the obtained agglomerate into a movable hearth type heating furnace and reducing by heating; a process of separating a reduced product containing metallic iron and slag that has been discharged from the movable hearth type heating furnace, into coarse particulate matter and fine particulate matter, using a sifter a; and a process of sorting the obtained fine particulate matter using a separator, and collecting the metallic iron.

A magnetic separator is preferably used as the separator, with the magnetically attractable substance obtained by selection by the magnetic separator being collected as the metallic iron.

The method for producing according to the present invention may further include a process of pulverizing the fine particulate matter using a pulverizer, metallic iron contained in the obtained pulverized matter being collected using the separator.

The pulverized matter obtained in the pulverizing process using the pulverizer may be pulverized again using the pulverizer.

A ball crusher, rod crusher, cage crusher, rotor crusher, or roller crusher, may be used as the crusher, for example.

The fine particulate matter may be magnetically separated using a magnetic separator prior to crushing the fine particulate matter using a pulverizer, with a magnetically attractable substance obtained by selecting by the magnetic separator being collected. The collected magnetically attractable substance may be formed into an agglomerate.

A sifter having a sieve opening of 2 to 8 mm is preferably used as the sifter a, for example.

The essence of a method for producing metallic iron according to the present invention, which has been able to achieve the second object (hereinafter, also referred to as second invention), is in that the method includes: a process of forming an agglomerate of a mixture containing an iron oxide-containing material and a carbonaceous reductant; a process of introducing the obtained agglomerate into a movable hearth type heating furnace and heating where the agglomerate is melted to form molten metallic iron, molten slag, and a reduced agglomerate; a process of cooling the mixture obtained in this process; a process of discharging a solid matter obtained by cooling, from the movable hearth type heating furnace; a process of crushing discharged matter including metallic iron, slag, and hearth covering material, discharged from the movable hearth type heating furnace, using a crusher; and a process of sorting the obtained crushed matter using a separator and collecting metallic iron.

The method for producing may further include: a process of screening the discharged matter including metallic iron, slag, and hearth covering material that has been discharged from the movable hearth type heating furnace, into oversieve and undersieve, using a sifter a; a process of crushing the obtained oversieve using a crusher; and a process of sorting the obtained crushed matter using a separator and collecting the metallic iron.

A hammer crusher, cage crusher, rotor crusher, ball crusher, roller crusher, or rod crusher may be used as the crusher, for example.

The oversieve preferably contains 95% or more iron in equivalent to iron component.

The oversieve may be magnetically separated using a magnetic separator prior to crushing the oversieve and a magnetically attractable substance be collected, and the collected magnetically attractable substance be crushed.

A magnetic separator, wind separator, sieve b, or the like, may be used as the separator, for example. Screening may be performed using the sifter b, following which an undersieve is separated using a magnetic separator and metallic iron is collected. A sifter having a sieve opening of 1 to 8 mm may be used as the sifter b, for example. The method for producing may further include a pulverizing process of pulverizing the magnetically attractable substance, obtained by selecting using the magnetic selector, using a pulverizer.

The pulverized matter obtained in the pulverizing process may be pulverized again using the pulverizer. The pulverized matter obtained in the pulverizing process may be separated using a magnetic selector and magnetically attractable substance be collected. The collected magnetically attractable substance may be formed into an agglomerate.

A ball crusher, rod crusher, cage crusher, rotor crusher, or roller crusher, may be used as the crusher, for example.

The above-described problem can be solved by a method for producing metallic iron including: a process of forming an agglomerate of a mixture containing an iron oxide-containing material and a carbonaceous reductant; a process of introducing the obtained agglomerate into a movable hearth type heating furnace and heating, so that the agglomerate is melted to form molten metallic iron, molten slag, and a reduced agglomerate; a process of cooling the obtained mixture; a process of discharging a solid matter obtained by cooling, from the movable hearth type heating furnace; a process of screening discharged matter containing metallic iron, slag, and hearth covering material that has been discharged from the movable hearth type heating furnace, using a sifter; and a process of sorting the undersieve obtained in the process of screening using a separator, and collecting the metallic iron.

A magnetic separator may be used as the separator, and a magnetically attractable substance obtained by selection by the magnetic separator be collected as the metallic iron. The method may further include: a process of pulverizing the obtained magnetically attractable substance using a pulverizer; and a process of separating the obtained pulverized matter using a separator and collecting metallic iron.

The method may further include a process of pulverizing at least a part of undersieve obtained in the process of screening, using a pulverizer. The pulverized matter obtained in the process of pulverizing using the pulverizer may be magnetically separated using a magnetic separator, and an obtained magnetically attractable substance be collected. Also, the pulverized matter obtained in the process of pulverizing using the pulverizer may be pulverized again using the pulverizer.

The collected metallic iron or the collected magnetically attractable substance may be formed into an agglomerate.

The pulverizer may apply the magnetically attractable substance with at least one selected from a group consisting of impact force, friction force, and compression force. A ball crusher, rod crusher, cage crusher, rotor crusher, or roller crusher, is preferably used as the crusher, for example.

A sifter having a sieve opening of 2 to 8 mm is preferably used as the sifter a.

### Advantages of the Invention

According to the first invention and the second invention, metallic iron can be efficiently collected.

In detail, according to the first invention, a reduced product containing metallic iron and slag, that is discharged from the movable hearth type heating furnace, is crushed by applying impact, so the metallic iron and slag are efficiently separated. Also, the reduced product containing metallic iron and slag that is discharged from the movable hearth type heating furnace is separated into coarse particulate material and fine particular material using a sifter, and processed according to granularity, so the metallic iron and slag are efficiently separated. That is to say, while metallic iron can be efficiently collected using a separator (e.g., sifter, magnetic separator, etc.), the metallic iron can be collected even more efficiently by combining pulverizing and a separator.

According to the second invention, discharged matter including metallic iron, slag, and hearth covering material, that is discharged from the movable hearth type heating furnace is suitably crushed or pulverized, so metallic iron can be efficiently collected from the discharged matter.

### BRIEF DESCRIPTION OF DRAWINGS

FIG. 1-1 is a schematic diagram illustrating a metallic iron producing process.

FIG. 1-2 is a graph illustrating the relationship between crushing conditions and slag percentage.

FIG. 1-3 is a schematic diagram illustrating a configuration example to continuously crush or pulverize.

FIG. 1-4 is a schematic diagram illustrating another metallic iron producing process.

FIG. 1-5 is a schematic diagram illustrating another metallic iron producing process.

FIGS. 1-6 (a) and (b) are both schematic diagrams illustrating another metallic iron producing process.

FIG. 1-7 is a schematic diagram illustrating another metallic iron producing process.

FIG. 1-8 is a schematic diagram illustrating an overall image of a metallic iron producing process.

FIG. 2-1 is a photograph serving in the stead of a diagram, where external shapes of metallic iron D obtained by an embodiment have been photographed.

FIG. 2-2 is a graph illustrating granularity distribution of magnetically attractable substance and magnetically non-attractable substance.

FIG. 2-3 is a photograph serving in the stead of a diagram, where magnetically attractable substance obtained by an embodiment has been photographed.

FIG. 2-4 is a graph illustrating the relationship between crushing time and slag percentage.

FIG. 2-5 is a graph illustrating granularity distribution of magnetically attractable substance and magnetically non-attractable substance.

FIG. 2-6 is a schematic diagram illustrating another metallic iron producing process.

FIGS. 2-7 (a) and (b) are both schematic diagrams illustrating another metallic iron producing process.

FIG. 2-8 is a schematic diagram illustrating another metallic iron producing process.

FIG. 2-9 is a schematic diagram illustrating an overall image of a metallic iron producing process.

FIG. 3-1 is a process diagram for describing a metallic iron producing method according to the present invention.

FIG. 3-2 is a schematic diagram for describing the configuration of a hammer crusher used in the present invention.

FIG. 3-3 is a process diagram for describing another metallic iron producing method according to the present invention.

FIG. 3-4 is a process diagram for describing another metallic iron producing method according to the present invention.

FIG. 3-5 is a graph illustrating granularity distribution (cumulative granularity) of a powder obtained by crushing with a hammer crusher.

FIG. 3-6 is a graph illustrating the relationship between crushing time and percentage of magnetically non-attractable substance.

FIG. 3-7 is a graph illustrating the relationship between crushing time and percentage of magnetically non-attractable substance.

FIG. 3-8 is a graph illustrating the relationship between crushing time and percentage of magnetically non-attractable substance.

FIG. 3-9 is a schematic diagram illustrating another metallic iron producing process.

FIG. 4-1 is a flowchart for describing a metallic iron producing method according to the present invention.

FIG. 4-2 is a flowchart for describing a metallic iron producing method according to the present invention.

FIG. 4-3 is a flowchart for describing a metallic iron producing method according to the present invention.

### DESCRIPTION OF EMBODIMENTS

A feature of a method for producing metallic iron according to the present invention is in that method includes:

a process of forming an agglomerate of a mixture containing an iron oxide-containing material and a carbonaceous reductant;

a process of introducing the obtained agglomerate into a movable hearth type heating furnace and reducing by heating;

a process of crushing a reduced product containing metallic iron and slag that has been discharged from the movable hearth type heating furnace, using a crusher; and

a process of sorting using a separator and collecting the metallic iron.

Particularly, in the present invention, a method of producing using an impact crusher as the crusher is defined as a “first invention”.

A method for producing, where the process of reducing by heating is a process in which the agglomerate formed in the process of forming an agglomerate is introduced into a movable hearth type heating furnace and heated, and the agglomerate is melted to form molten metallic iron, molten slag, and a reduced agglomerate, the method further including a process of cooling the mixture obtained in this process; and a process of discharging a solid matter obtained by cooling, from the movable hearth type heating furnace; in which, in the process of crushing, discharged matter including metallic iron, slag, and hearth covering material discharged from the movable hearth type heating furnace, is crushed using a crusher, is defined as a “second invention”.

First, the first invention will be described.

The Present Inventors diligently studied improving metallic iron collecting efficiency and improving metallic iron productivity when heating an agglomerate formed of a mixture including an iron oxide-containing material and a carbonaceous reductant in a movable hearth type heating furnace to produce metallic iron. As a result, it has been found that crushing a reduced product including metallic iron and slag that has been discharged from a movable hearth type heating furnace, by applying a strong impact, suitably separates the metallic iron and slag, so the collecting efficiency improves. It has also been found that separating the reduced product including metallic iron and slag that has been discharged from a movable hearth type heating furnace into coarse particles and fine particles using a sifter suitably separates the metallic iron and slag, so the collecting efficiency improves. Accordingly, the first invention has been completed.

Now, after describing the background leading up to the completion of the first invention, feature portions of the first invention will be described.

The Present Inventors prepared a low-grade iron ore including a great gangue component out of all iron ores, and heated an agglomerate containing this iron ore and a carbonaceous reductant, in a movable hearth type heating furnace. The reduced pellets obtained by this heating were finely crushed by various types of crushing, and magnetically attractable substance was collected by magnetic separation using a magnetic separator. However, the slag percentage [(SiO₂+Al₂O₃)/T.Fe×100 . . . (1)] of the magnetically attractable substance was around 17%, and improvement of the iron grade was difficult.

It was found that in a case of using low-grade iron ore with a great gangue component, melting the entirety of the agglomerate and separating into metallic iron and slag is difficult in a short heating time of 11 minutes or less on the hearth of a movable hearth type heating furnace, even if heated at a temperature of around 1300 to 1350° C., and after heating, granular metallic iron, molten slag, hollow reduced pellets, spherical reduced pellets, and so forth, were found to be intermingled.

The cause of this is as follows. When heating at a high temperature of 1300° C. or higher, heat supply by radiant heat is far greater than heat supply by heat transfer among pellets and into the pellets, but temperature increase at portions where the amount of radiant heat received is small is markedly delayed. That is to say, on the scale of individual pellets, the bottom of that pellet, and on the scale of multiple pellets which are overlaid vertically, the pellets under other pellets, will be delayed regarding temperature increase. As a result, after a short time of 11 minutes or less, parts which melt and parts which remain as reduced iron coexist. Particularly, the greater the amount of gangue in the pellets is, the more pronounced the variance in the reduced state is, and the more firmly the metallic iron and slag are adhered.

On the other hand, extending the heating time increases the amount of heat transfer, so the above-described variance in reduction state is reduced, but production efficiency falls. Accordingly, the product should be discharged from the furnace as soon as possible after reduction is completed.

Now, the Present Inventors have found that even in a case where the reduced product discharged from the furnace after heating an agglomerate in a movable hearth type heating furnace has granular metallic iron, molten slag, hollow reduced pellets, spherical reduced pellets, and so forth, in an intermingled state, metallic iron can be efficiently collected by using a combination of crushing, screening and separation using a separator. While description has been made primarily regarding a case of using low-grade iron ore (iron oxide-containing material) containing a great amount of gangue, the present invention is not restricted to using low-grade iron ore containing a great amount of gangue, and it has been confirmed that the present invention is also applicable to a case of using high-grade iron ore (iron oxide-containing material) containing little gangue.

The first invention will be described below.

A feature of the method for producing metallic iron according to the present invention is in that the method includes:

a process of forming an agglomerate of a mixture containing an iron oxide-containing material and a carbonaceous reductant (hereinafer, also referred to as agglomerate forming process);

a process of introducing the obtained agglomerate into a movable hearth type heating furnace and reducing by heating (hereinafer, also referred to as reducing by heating);

a process of crushing a reduced product containing metallic iron and slag that has been discharged from the movable hearth type heating furnace, using an impact crusher (hereinafer, also referred to as crushing process); and

a process of sorting using a separator and collecting the metallic iron (hereinafer, also referred to as metallic iron collecting process).

### [Agglomerate Forming Process]

In an agglomerate forming process, an agglomerate is formed of a mixture including an iron oxide-containing material and a carbonaceous reductant, thus producing an agglomerate.

Specific examples of the above iron oxide-containing material which can be used include iron ore, iron sand, ironmaking dust, non-ferrous smelting residue, ironmaking waste, and so forth.

High-grade iron oxide-containing material containing little gangue can be used as the iron oxide-containing material according to the present invention, but also low-grade iron oxide-containing material containing a great amount of gangue, which had not been normally used heretofore, can also be used.

Iron ore will be described as a representative example of iron oxide-containing material. Iron ore contains gangue. Gangue is a component making up iron ore mined from a mine (crude ore) other than minerals including useful metal, and normally is made up of oxides such as SiO₂ and Al₂O₃. The amount of gangue included in the iron ore differs depending on the region of production where the iron ore is mined. Iron ore containing little gangue is called high-grade iron ore, and iron ore containing a large amount of gangue is called low-grade iron ore.

Using low-grade iron ore as a raw material results in increased amount of molten slag, so heat transfer to the agglomerate is impeded, and production of metallic iron is lower. Accordingly, low-grade iron ore has hardly been used heretofore as a raw material for iron. However, low-grade iron ore is inexpensive, so industrial use is desired. A particular reason is that while the global production amount of steel is rising, there is a downward trend in the amount of high-grade iron ore being mined, and consequently an increase of the price of high-grade iron ore is expected.

On the other hand, according to the present invention, an agglomerate is reduced by heating, and then crushed using an impact crusher after which sorting is performed using a separator to collect the metallic iron, as described later, so metallic iron can be efficiently collected even if low-grade iron ore containing a large amount of gangue is used as a raw material.

The aforementioned low-grade iron oxide-containing material as used in the Present Specification means that where the percentage of the total mass of SiO₂ and Al₂O₃ as to the total iron mass (T.Fe) [slag percentage=(SiO₂+Al₂O₃)/T.Fe×100] is 10% or more. SiO₂ and Al₂O₃ are, of the various types of gangue contained in the iron oxide-containing material (e.g., iron ore), matter regarding which the content percentage is relatively high, and accordingly these are used as representative matter of gangue in the Present Specification. The percentage of the total mass of SiO₂ and Al₂O₃ as to the total iron mass is defined as the slag percentage, with that having slag percentage of 5% or less being called high-grade iron oxide-containing material, that having slag percentage of more than 5% but 10% or less being called mid-grade iron oxide-containing material, and that having slag percentage of 10% or more being called low-grade iron oxide-containing material. In a case where a large amount of titanium oxide is included, such as with iron sand or the like, the titanium oxide is also added to the SiO₂ and Al₂O₃ when calculating the slag percentage. According to the present invention, the slag percentage may be 10% or more, or may be less than 10%.

Examples of the carbonaceous reductant which can be used include coal, coke, and so forth.

It is sufficient for the carbonaceous reductant to include enough carbon to reduce the iron oxide contained in the iron oxide-containing material. Specifically, it is sufficient for the amount of carbon to be in a range of 0 to 5% by mass in excess to 0 to 5% by mass lacking as to the amount of carbon which can reduce the iron oxide contained in the iron oxide-containing material (i.e., ±5% by mass).

The mixture containing the iron oxide-containing material and the carbonaceous reductant preferably further has a melting point controlling agent added thereto.

The melting point controlling agent means matter which affects the melting point of components other than the iron oxide included in the agglomerate (particularly gangue and ash component), and excludes matter which affects the melting point of metallic iron. That is to say, by adding the melting point controlling agent to the mixture, the melting temperature of components other than the iron oxide included in the agglomerate (particularly gangue and ash component) can be affected, and the melting temperature thereof can be reduced, for example. This promotes melting of the gangue and ash, thereby forming molten slag. Part of the iron oxide is dissolved in the molten slag at this time, and is reduced and becomes metallic iron in the molten slag. The metallic iron generated in the molten slag comes into contact with metallic iron reduced in its solid state, and is aggregated as solid reduced iron.

A melting point controlling agent including at least a CaO source is preferably used as the melting point controlling agent. At least one selected from a group including CaO (quicklime), Ca(OH)₂ (slaked lime), CaCO₃ (limestone), and CaMg(CO₃)₂ (dolomite), for example, is preferably added as, the CaO source.

The aforementioned CaO source alone may be used as the melting point controlling agent, or an MgO source, Al₂O₃ source, SiO₂ source, or the like, for example, may be used in addition to the CaO source. MgO, Al₂O₃, and SiO₂ are also matters which affect the melting point of components other than iron (particularly gangue) contained in the agglomerate, in the same way as the CaO described above.

At least one selected from a group including MgO powder, Mg-containing matter extracted from natural ore or seawater or the like, and MgCO₃, for example, is preferably added as the MgO source. For example, Al₂O₃ powder, bauxite, boehmite, gibbsite, diaspore, and so forth, is preferably added as the Al₂O₃ source. Examples which can be used as the SiO₂ source include SiO₂ powder, quartz sand, and so forth.

The agglomerate may further include a binder or the like, as a component other than the iron oxide-containing material, carbonaceous reductant, and melting point controlling agent.

Examples which can be used as the binder include polysaccharides or the like (e.g., starches such as cornstarch, flour, and so forth, molasses, and so forth).

The iron oxide-containing material, carbonaceous reductant, and melting point controlling agent are preferably crushed before mixing. An average grain size of 10 to 60 μm is recommended for the iron oxide-containing material, average grain size of 10 to 60 μm for the carbonaceous reductant, and average grain size of 5 to 90 μm for the melting point controlling agent, for example.

The means by which the iron oxide-containing material and so forth are crushed is not restricted in particular, and known means may be used. For example, a vibrational crusher, roll crusher, ball crusher, or the like, may be used.

A rotating container mixer or fixed container mixer, for example, may be used as a mixer to mix the mixture.

Examples of the rotating container mixer which can be used include a rotating cylinder mixer, a double cone mixer, a V blender, or the like.

Examples of the fixed container mixer which can be used include a mixer having rotating paddles (e.g., spades) in a mixing vat.

Examples of a compactor to form an agglomerate of the mixture which can be used include a tumbling disc granulator (disc type granulator), cylinder type granulator (drum type granulator), twin-roll briquetter, or the like.

The shape of the agglomerate is not restricted in particular, and may be aggregates, grains, briquettes, pellets, rods, or the like, for example, and preferably is briquettes or pellets.

### [Process of Reducing by Heating]

In the process of reducing by heating, the agglomerate obtained in the agglomerate forming process described above is introduced to a movable hearth type heating furnace, and heated to reduce the iron oxide in the agglomerate, thereby producing a reduced product containing metallic iron and slag.

A movable hearth type heating furnace is a heating furnace where the hearth moves through the furnace like a belt conveyer, examples of which include a rotary hearth furnace and a tunnel furnace.

The aforementioned rotary hearth furnace is a furnace where the hearth is designed so as to have a circular (doughnut-shaped) external appearance, such that the starting point and ending point of the hearth is at the same position. An agglomerate supplied on the hearth is reduced by heating while traveling one round through the furnace, thereby generating metallic iron (e.g., sponge-like iron or granular metallic iron). Accordingly, a rotary hearth furnace has introducing means at farthest upstream in the rotational direction to supply the agglomerate to the furnace, and discharge means farthest downstream in the rotational direction (which is actually immediately upstream from the introducing side, due to the rotary structure).

The aforementioned tunnel furnace is a heating furnace where the hearth moves linearly through the furnace.

The agglomerate is preferably reduced by heating, by heating at 1300 to 1500° C. in the movable hearth type heating furnace. If the heating temperature is below 1300° C., the metallic iron and slag do not readily melt, and high productivity is not obtained. On the other hand, if the heating temperature exceeds 1500° C., the discharge gas temperature is high so the amount of waste heat is great, which is a waste of energy, and also damage of the furnace occurs.

Laying hearth covering material on the hearth of the movable hearth type heating furnace before introducing the agglomerate into the furnace is also a preferable form. Laying hearth covering material can protect the hearth.

The items exemplified above as carbonaceous reductants may be used as hearth covering material, and also fireproof particles may be made.

The grain size of the hearth covering material is preferably 3 mm or smaller, so that the agglomerate or molten material do not burrow in. The lower limit of the grain size is preferably 0.5 mm or larger, so as not to be blown away by burner combustion gas.

### [Crushing Process]

An impact crusher is used in the crushing process to crush the reduced product containing metallic iron and slag that is discharged from the movable hearth type heating furnace. The slag is a brittle matter formed of molten oxides, and accordingly is resistant to friction but weak under impact force and breaks easily. On the other hand, the metallic iron exhibits a certain level of plastic deformation. Accordingly, a strong impact is applied to the reduced product in the present invention, thereby fracturing the slag so as to be separated from the metallic iron.

Examples of the impact crush that can be used include a hammer crusher, cage crusher, rotor crusher, ball crusher, roller crusher, rod crusher, and so forth.

The impact crusher is preferably a crusher which applies impact from one direction, and of the crushers exemplified above, the hammer crusher, cage crusher, and rotor crusher come under crushers which apply impact from one direction. Rod crushers also can be preferably used, as they drop a heavy rod to instantaneously apply a great force to the object to be fractured.

### [Metallic Iron Collecting Process]

In the metallic iron collecting process, metallic iron is collected from the fractured material, obtained in the crushing process, by sorting using a separator.

The separator may be provided to the crusher used in the crushing process, or may be provided separately from that provided to the crusher. Alternatively, a crusher not having a separator may be used as the crusher, and a separator provided separately.

In a case of using a crusher having a separator as the crusher, the coarse particle side separated by the separator can be collected as metallic iron (product). On the other hand, the fine particle side sorted by the separator can be magnetically selected/separated using a magnetic separator, and magnetically attractable substance can be collected as metallic iron (product). The magnetically non-attractable substances sorted by the magnetic separator are primarily slag. It is sufficient for this separator to have a sifter.

A hammer crusher can be exemplified as a crusher having a separator. There is a hammer crusher where a sifter is provided as a separator, so that the crushed product crushed by the hammer crusher is sifted at the sifter, and separated into oversieve (powder remaining above the sifter) and undersieve (powder which has passed through the sifter). The hammer crusher may be provided with a wind separator, and the fine powder crushed by the hammer crusher may be separately recovered by this wind separator. The fine powder collected by the wind separator may be pulverized using a cage crusher, for example, and the obtained pulverized matter may be sorted by a magnetic separator so as to be separated into magnetically attractable substance and magnetically non-attractable substance. The magnetically attractable substance can be used as an iron source, and the magnetically non-attractable substance can be used as a pavement material, for example, since slag is the primary component.

Metallic iron is preferably collected from powder at the fine particle side, that has been sorted by the separator provided to the crusher, and the crushed product obtained using the crusher not provided with a separator, using a second separator.

A separator using the difference in specific gravity between the metallic iron and slag, such as a wind separator or jig or the like, may be used as the second separator, besides a sifter b and magnetic separator.

In a case of using the sifter b as the second separator, after screening using the sifter b, the undersieve is preferably subjected to magnetic separation using a magnetic separator, to collect the obtained magnetically attractable substance as metallic iron. The slag percentage of the collected metallic iron is relatively low. On the other hand, the non-magnetic material separated by magnetic separation using a magnetic separator is primarily slag.

After screening using the sifter b, the oversieve is metallic iron of which the grain size is large, so the oversieve may be used as the product as it is, or magnetic separation may be performed using a magnetic separator to collect obtained magnetically attractable substance as metallic iron. The oversieve may be agglomerated by adding binder or the like and forming into briquettes or the like, as necessary. On the other hand, the non-magnetic material separated by magnetic separation using a magnetic separator is primarily slag.

A sifter having a sieve opening of 1 to 8 mm is preferably used as the sifter b, for example.

A magnetic separator can be used as the second separator, besides the sifter b.

A known magnetic separator can be used to sort into magnetically attractable substances and magnetically non-attractable substances. The magnetically attractable substance can be collected as metallic iron (product), and may be agglomerated into shapes such as briquettes and used as iron source. Note however, that in a case of using a magnetic separator as the separator, metallic iron with slag adhering thereto is also collected, so further pulverizing and separation of the slag component is desirable.

Note that the present invention is similar to the known FASTMET method and ITmk3 method in with regard to the point that an agglomerate formed of a mixture containing an iron oxide-containing material and a carbonaceous reductant is heated at high temperature to produce metallic iron (reduced iron). However, this differs with regard to the point that a collected product including metallic iron and slag, which is discharged from a movable hearth type heating furnace, is crushed by applying impact and sorted using a separator to collect the metallic iron, thereby reducing the amount of slag introduced to the smelting process which is the next process.

The method for producing metallic iron according to the present invention may further include:

a process of screening the reduced product containing metallic iron and slag that has been discharged from the movable hearth type heating furnace, into coarse particulate matter and fine particulate matter, using a sifter a (hereinafter, also referred to as screening process);

a process of crushing the obtained coarse particulate matter using an impact crusher (hereinafter, also referred to as course particular matter crushing process); and

a process of sorting using a separator and collecting the metallic iron (hereinafter, also referred to as metallic iron collecting process).

### [Screening Process]

In the screening process, the above-described reduced product is separated into coarse product and fine product using a sifter a. That is to say, the reduced product including metallic iron and slag that is discharged from the movable hearth type heating furnace also includes hearth covering material for example, so it is preferable to separate and collect the hearth covering material before the later-described crushing process. Accordingly, the reduced product is screened using the sifter a, obtaining oversieve as coarse particulate matter and the undersieve as fine particulate matter.

The sieve opening of the sifter a is preferably slightly larger than the grain size of the hearth covering material, 2 to 8 mm for example.

The coarse particulate matter is primarily metallic iron which can serve as product, but the bulk density thereof differs depending on the gangue percentage in the iron oxide-containing material and carbonaceous reductant used, and the molten state of the reduced product within the heating furnace. It is sufficient that the bulk density of the coarse particulate matter be around 1.2 to 3.5 kg/L.

On the other hand, the fine particulate matter is primarily hearth covering material.

### [Coarse Particulate Matter Crushing Process]

The coarse particulate matter obtained in the above-described screening process is separated into the metallic iron and slag making up the coarse matter by applying impact in the coarse particulate matter crushing process. This coarse particulate matter crushing process is the same as the above-described coarse particle crushing process, other than the object of crushing being the coarse particulate matter.

The coarse particulate matter may be subjected to magnetic separating using a magnetic separator before crushing in the coarse particulate matter crushing process, and the obtained magnetically attractable substance be collected. The collected magnetically attractable substance may be crushed in the above-described coarse particulate matter crushing process to separate into metallic iron and slag.

The magnetically attractable substance that is collected may be pulverized using the above-described pulverizer (pulverizing process).

The pulverized matter obtained in the pulverizing process may be pulverized again using a pulverizer.

The pulverized matter obtained in the pulverizing process may be separated using a magnetic separator, with the obtained magnetically attractable substance being collected. This collected magnetically attractable substance may be formed into an agglomerate in the shape of briquettes, for example, and used as an iron source.

Examples of the pulverizer include a ball crusher, rod crusher, cage crusher, rotor crusher, and roller crusher.

After sorting into metallic iron and slag in the coarse particulate matter crushing process may be separated using a separator and the metallic iron collected (metallic iron collecting process). The above-described procedures can be used without change for the metallic iron collecting process.

A feature of the method for producing metallic iron according to the present invention is in that the method includes:

a process of forming an agglomerate of a mixture containing an iron oxide-containing material and a carbonaceous reductant (agglomerate forming process);

a process of introducing the obtained agglomerate into a movable hearth type heating furnace and reducing by heating (process of reducing by heating);

a process of separating a reduced product containing metallic iron and slag that has been discharged from the movable hearth type heating furnace, into coarse particulate matter and fine particulate matter, using a sifter a (screening process); and

a process of sorting the obtained fine particulate matter using a separator, and collecting the metallic iron (metallic iron collecting process).

The agglomerate forming process, process of reducing by heating, and the screening process, are the same as described above, so description will be omitted. The metallic iron collecting process will be described next in detail.

### [Metallic Iron Collecting Process]

In the metallic iron collecting process, metallic iron is sorted and collected from the fine particulate matter obtained in the screening process, using a separator.

A magnetic separator can be suitably used as the separator, with magnetically attractable substance obtained by selection by the magnetic separator being collected, the same as with the description regarding the second separator above. The same magnetic separator as that described above regarding the second separator may be used. The magnetically non-attractable matter magnetically separated/separated and collected by the magnetic separator is primarily hearth covering material.

The present invention may further include a process of pulverizing the fine matter obtained in the screening process (hereinafter, also referred to as fine particulate matter pulverizing process), using a pulverizer, and metallic iron contained in the obtained pulverized matter may be collected using the separator. The fine particulate matter pulverizing process will be described below in detail.

### [Fine Particulate Matter Pulverizing Process]

In the fine particulate matter pulverizing process, the fine particulate matter obtained in the screening process is pulverized using a pulverizer. That is to say, the fine particulate matter is metallic iron and slag bound to each other, and measurement of the slag percentage of the fine particulate matter yielded approximately 30%, which is high. Note that the slag percentage was calculated by the following expression (1) based on the SiO₂ amount (% by mass), Al₂O₃ amount (% by mass), and T.Fe amount (% by mass), contained in the fine particulate matter.

(SiO₂+Al₂O₃)/T.Fe×100 (1)

Specific examples of the pulverizer which can be used include a ball crusher, rod crusher, cage crusher, rotary crusher, and roller crusher.

The fine particulate matter may be subjected to selection using a magnetic separator before pulverizing in the fine particulate matter crushing process, and the magnetically attractable substance obtained by magnetic separation at the magnetic separator be collected. The collected magnetically attractable substance may be directed to the above-described fine particulate matter pulverizing process. On the other hand, the magnetically non-attractable substance magnetically selected/separated at the magnetic separator and collected, is primarily hearth covering material.

The pulverized matter obtained in the fine particulate matter pulverizing process may be pulverized again using a pulverizer. Repeating pulverizing using a pulverizer enables separation of metallic iron and slag to be furthered.

In a case where the magnetically attractable substance obtained by selecting by the magnetic separator has small grain size and is difficult to handle, this may be formed into an agglomerate in the shape of a briquette, for example, and used as an iron source. A separator using the difference in specific gravity between the metallic iron and slag, such as a wind separator or jig or the like, may be used instead of the magnetic separator.

A modification of the method for producing metallic iron according to the present invention will be described.

According to the present invention, operation may be performed including:

a process of forming an agglomerate of a mixture including an iron oxide-containing material and a carbonaceous reductant;

a process of introducing the obtained agglomerate and a reduction auxiliary material (e.g., hearth covering material) into a movable hearth type heating furnace, and reducing by heating;

a process of separating a reduced product containing metallic iron and slag, that is discharged from the movable hearth type heating furnace, into coarse particulate matter and fine particulate matter using a sifter a; and

a process of collecting non-metallic iron (e.g., hearth covering material) from the obtained fine particulate matter using a separator.

According to the present invention, operation may be performed including:

a process of forming an agglomerate of a mixture including an iron oxide-containing material and a carbonaceous reductant;

a process of introducing the obtained agglomerate into a movable hearth type heating furnace, and reducing by heating;

a process of separating a reduced product containing metallic iron and slag, that is discharged from the movable hearth type heating furnace, into a first coarse particulate matter and a first fine particulate matter using a sifter a;

a crushing process of crushing the first coarse particulate matter;

a process of screening the crushed matter obtained by the crushing process into a second coarse particulate matter and a second fine particulate matter; and

a process of pulverizing the first fine particulate matter and the second fine particulate matter.

The first fine particulate matter separated using the sifter a may be magnetically separated using a magnetic separator, and the obtained magnetically attractable substance may be mixed with the second fine particulate matter and then pulverized.

The second fine particulate matter obtained by screening the crushed matter obtained in the crushing process may be separated using a magnetic separator, and the obtained magnetically attractable substance may be mixed with the first fine particulate matter and then pulverized.

According to the present invention, operation may be performed including:

a process of forming an agglomerate of a mixture including an iron oxide-containing material and a carbonaceous reductant;

a process of introducing the obtained agglomerate into a movable hearth type heating furnace, and reducing by heating;

a process of separating a reduced product containing metallic iron and slag, that is discharged from the movable hearth type heating furnace, into a first coarse particulate matter and a first fine particulate matter using a sifter a;

a crushing process of crushing the first coarse particulate matter;

a process of screening the crushed matter obtained by the crushing process into a second coarse particulate matter and a second fine particulate matter;

a process of pulverizing the first fine particulate matter and the second fine particulate matter; and

a process of mixing the crushed matter than has been crushed and the second coarse particulate matter, and forming an agglomerate thereof.

The first fine particulate matter separated using the sifter a may be magnetically separated using a magnetic separator, and the obtained magnetically attractable substance may be mixed with the second fine particulate matter and then pulverized.

The second fine particulate matter obtained by screening the crushed matter obtained in the crushing process may be separated using a magnetic separator, and the obtained magnetically attractable substance may be mixed with the first fine particulate matter and then pulverized.

The crushed matter obtained in the crushing process may be separated using a magnetic separator, and the obtained magnetically attractable substance may be formed into an agglomerate.

Also, the collected matter collected in each process may be formed into an agglomerate and used as an iron source.

The first invention has been described so far.

Next, a second invention will be described.

The Present Inventors diligently studied improving metallic iron collecting efficiency and improving metallic iron productivity when heating an agglomerate formed of a mixture including an iron oxide-containing material and a carbonaceous reductant in a movable hearth type heating furnace, melting the agglomerate to form molten metallic iron, molten slag, and a reduced agglomerate, cooling the obtained mixture within the furnace, discharging from the movable hearth type heating furnace after having solidified, and separating and collecting metallic iron from the discharged product. As a result, it has been found that appropriately crushing or pulverizing the discharged product including metallic iron, slag, and hearth covering material that has been discharged from the movable hearth type heating furnace, raises the collecting efficiency of metallic iron. Accordingly, it has been found that productivity of metallic iron can be improved, and the second invention has been completed.

Now, after describing the background leading up to the completion of the second invention, feature portions of the second invention will be described.

First, upon performing various studies, the Present Inventors found that introducing an agglomerate containing an iron oxide-containing material and a carbonaceous reductant into a movable hearth type heating furnace and heating to melt, the reduced metallic iron is aggregated to form grains with a size of around 2 to 8 mm. Accordingly, metallic iron can be efficiently collected by collecting discharged product discharged from the movable hearth type heating furnace having a grain size of around 2 to 8 mm or larger.

However, even if the agglomerate is heated in the movable hearth type heating furnace at a high temperature around 1350 to 1500° C., making the entire agglomerate a constant temperature in a steady state is difficult due to change in installation conditions such as dissipation of heat from the furnace, the amount and overlaid state of the inserted matter, and so forth. Accordingly, in order to reduce the iron oxide contained in the agglomerate and separate the total amount on the hearth of the movable hearth type heating furnace into molten metallic iron and molten slag, it is necessary to either raise the temperature until the lowest temperature of the agglomerate is a temperature where both metallic iron and slag melt, or to extend the heating time. However, excessive heating at high temperature or extending time requires a great amount of heat energy, and is impractical. Accordingly, forming the total amount of iron oxide contained in the agglomerate into metallic iron having a grain size of around 2 to 8 mm or larger, and retrieving this as a product with a high iron purity is thought to be difficult. That is to say, even if the grain size is around 2 to 8 mm or larger, 20 to 50% of the iron amount contained in the agglomerate will either be deformed granular iron containing slag within, or clumps of iron where multiple agglomerates formed by reduced iron forming into agglomerates (hereinafter also referred to as reduced agglomerate) are connected and slag is adhered thereto, or metallic iron retaining the shell form of the reduced iron, or the like. If incomplete metallic iron intermingled with slag in this way exists, the purity of the iron product is low, even if those with a grain size of around 2 to 8 mm or larger are collected.

Accordingly, it has been found in the present invention that metallic iron can be efficiently collected by crushing the discharged product containing metallic iron and slag that has been discharged from the movable hearth type heating furnace, using a crusher, and then sorting using a separator. That is to say, calculating the slag percentage [(SiO₂+Al₂O₃)/T.Fe×100] contained in the discharged product yielded 1.68%, but crushing this discharged product using a crusher and magnetically separating using a magnetic separator reduced the slag percentage contained in the magnetically attractable substance to 0.72%. Taking granular metallic iron having a grain size of around 2 to 8 mm or larger and also sufficiently separating the slag can suppress the slag percentage contained therein to 0.20% or lower, but that with a slag percentage around 0.72% is fully economically usable as material in a melting refining furnace.

On the other hand, at the time of heating an agglomerate in a movable hearth type heating furnace, there may be formed very small metallic iron having a grain size of 2 mm or smaller in the furnace, from powder and fractured pieces coming from the agglomerate being transported into the furnace along with the agglomerate, and a part of the metallic iron generated in the reducing process. There may also be generated very small metallic iron particles having a grain size of 2 mm or smaller by mechanical impact at the time of the agglomerate reduced in the furnace being discharged from the movable hearth type heating furnace. Of the discharged matter discharged from the movable hearth type heating furnace, the discharged matter having a grain size of 2 mm or smaller contains very small metallic iron, but primarily is hearth covering material introduced into the furnace to protect the hearth, hearth covering material, slag, and so forth, and accordingly has been screened, magnetically separated, and reused as hearth covering material. Attempting to collect the metallic iron contained in the magnetically attractable substance obtained by magnetic selection/separation requires an operation to separate into metallic iron and slag, since this magnetically attractable substance contains a great amount of slag (slag percentage of around 14%, for example). In a case of not removing the slag, this is metallic iron with low product value. It has been found that the slag contained in such magnetically attractable substance is adhered to the surface of the metallic iron, and accordingly the slag can be removed by using a pulverizer applying at least one type selected from a group consisting of impact force, friction force, and compression force, such as with a ball crusher or rod crusher, for example.

As described above, crushing and pulverizing is appropriately performed in a method for producing metallic iron using a movable hearth type heating furnace which is conventionally known. Accordingly, the amount of slag contained in the metallic iron can be reduced, the added value of the metallic iron can be markedly improved, and variance in quality of the metallic iron due to operational changes of the movable hearth type heating furnace can be reduced.

The second invention will be described below.

A feature of the method of producing metallic iron according to the present invention is in that the method includes:

a process of forming an agglomerate of a mixture containing an iron oxide-containing material and a carbonaceous reductant (hereinafter, also referred to as agglomerate forming process);

a process of introducing the obtained agglomerate into a movable hearth type heating furnace and heating, so that the agglomerate is melted to form molten metallic iron, molten slag, and a reduced agglomerate (hereinafter, also referred to as heating process);

a process of cooling the obtained mixture (hereinafter, also referred to as cooling process);

a process of discharging a solid matter obtained by cooling, from the movable hearth type heating furnace (hereinafter, also referred to as discharging process);

a process of crushing discharged matter containing metallic iron, slag, and hearth covering material that has been discharged from the movable hearth type heating furnace, using a crusher (hereinafter, also referred to as crushing process); and

a process of sorting the obtained crushed matter using a separator, and collecting the metallic iron (hereinafter, also referred to as first metallic iron collecting process).

### [Agglomerate Forming Process]

In the agglomerate forming process, an agglomerate is formed of a mixture including an iron oxide-containing material and a carbonaceous reductant, thus producing an agglomerate.

Specific examples of the above iron oxide-containing material which can be used include iron ore, iron sand, ironmaking dust, non-ferrous smelting residue, ironmaking waste, and so forth.

Examples of the carbonaceous reductant which can be used include coal, coke, and so forth.

It is sufficient for the carbonaceous reductant to include enough carbon to reduce the iron oxide contained in the iron oxide-containing material. Specifically, it is sufficient for the amount of carbon to be 0 to 5% by mass in excess as to the amount of carbon which can reduce the iron oxide contained in the iron oxide-containing material.

The mixture containing the iron oxide-containing material and the carbonaceous reductant preferably further has a melting point controlling agent added thereto.

The melting point controlling agent means matter which affects the melting point of components other than the iron oxide included in the agglomerate (particularly gangue and ash component), and excludes matter which affects the melting point of metallic iron. That is to say, by adding the melting point controlling agent to the agglomerate, the melting point of components other than the iron oxide included in the agglomerate (particularly gangue and ash component) can be affected, and the melting point thereof can be reduced, for example. This promotes melting of the gangue and ash component, thereby forming molten slag. Part of the iron oxide is dissolved in the molten slag at this time, and is reduced and becomes metallic iron in the molten slag. The metallic iron generated in the molten slag comes into contact with metallic iron reduced in its solid state, and is aggregated as solid reduced iron.

A melting point controlling agent including at least a CaO source is preferably used as the melting point controlling agent. At least one selected from a group including CaO (quicklime), Ca(OH)₂ (slaked lime), CaCO₃ (limestone), and CaMg(CO₃)₂ (dolomite), for example, is preferably added as the CaO source.

The aforementioned CaO source alone may be used as the melting point controlling agent, or an MgO source, Al₂O₃ source, SiO₂ source, or the like, for example, may be used in addition to the Cao source. MgO, Al₂O₃, and SiO₂ are also matters which affect the melting point of components other than iron (particularly gangue) contained in the agglomerate, in the same way as the CaO described above.

At least one selected from a group including MgO powder, Mg-containing matter extracted from natural ore or seawater or the like, and MgCO₃, for example, is preferably added as the MgO source. At least one selected from a group including Al₂O₃ powder, bauxite, boehmite, gibbsite, diaspore, and so forth, is preferably added as the Al₂O₃ source. Examples which can be used as the SiO₂ include SiO₂ powder, quartz sand, and so forth.

The agglomerate may further include a binder or the like, as a component other than the iron oxide-containing material, carbonaceous reductant, and melting point controlling agent.

Examples which can be used as the binder include polysaccharides or the like (e.g., starches such as cornstarch, flour, and so forth, molasses, and so forth).

The iron oxide-containing material, carbonaceous reductant, and melting point controlling agent are preferably crushed before mixing. An average grain size of 10 to 60 μm is recommended for the iron oxide-containing material, average grain size of 10 to 60 μm for the carbonaceous reductant, and average grain size of 5 to 60 μm for the melting point controlling agent, for example.

The means by which the iron oxide-containing material and so forth are crushed is not restricted in particular, and known means may be used. For example, a rod crusher, roll crusher, ball crusher, or the like, may be used.

A rotating container mixer or fixed container mixer, for example, may be used as a mixer to mix the mixture.

Examples of the rotating container mixer which can be used include a rotating cylinder mixer, a double cone mixer, a V blender, or the like.

Examples of the fixed container mixer which can be used include a mixer having paddles (e.g., spades) in a mixing vat.

Examples of a compactor to form an agglomerate of the mixture include a tumbling disc granulator, cylinder type granulator (drum type granulator), twin-roll briquetter, or the like.

The shape of the agglomerate is not restricted in particular, and may be aggregates, grains, briquettes, pellets, rods, or the like, for example, and preferably is briquettes or pellets.

### [Process of Heating]

In the process of reducing by heating, the agglomerate obtained in the agglomerate forming process described above is introduced to a movable hearth type heating furnace, and heated to melt the agglomerate, thereby forming molten metallic iron, molten slag, and a reduced agglomerate.

A movable hearth type heating furnace is a heating furnace where the hearth moves through the furnace like a belt conveyer, examples of which include a rotary hearth furnace and a tunnel furnace.

The aforementioned rotary hearth furnace is a furnace where the hearth is designed so as to have a circular (doughnut-shaped) external appearance, such that the starting point and ending point of the hearth is at the same position. An agglomerate supplied on the hearth is reduced by heating while traveling one round through the furnace, thereby generating metallic iron (e.g., sponge-like iron or granular metallic iron). Accordingly, a rotary hearth furnace has introducing means at farthest upstream in the rotational direction to supply the agglomerate to the furnace, and discharge means farthest downstream in the rotational direction (which is actually immediately upstream from the introducing side, due to the rotary structure).

The aforementioned tunnel furnace is a heating furnace where the hearth moves linearly through the furnace.

The agglomerate is preferably heated in the movable hearth type heating furnace at 1350 to 1500° C. If the heating temperature is below 1350° C., the agglomerate does not readily melt. On the other hand, if the heating temperature exceeds 1500° C., this is a waste of energy, and also damage of the furnace occurs.

Laying hearth covering material on the hearth of the movable hearth type heating furnace before introducing the agglomerate into the furnace is also a preferable form. Laying hearth covering material can protect the hearth of the movable hearth type heating furnace.

The items exemplified above as carbonaceous reductants may be used as hearth covering material, and also fireproof particles may be made.

The grain size of the hearth covering material is preferably 3 mm or smaller, so that the agglomerate or molten material do not burrow in. The lower limit of the grain size is preferably 0.5 mm or larger, so as not to be blown away by burner combustion gas.

### [Cooling Process]

In the cooling process, the mixture obtained in the heating process (i.e., the molten metallic iron, molten slag, and reduced agglomerate) is cooled in the movable hearth type heating furnace.

While the cooling means are not restricted in particular, a cooling chamber may be provided on the downstream side of the movable hearth type heating furnace where no combustion burners are provided, and coolant is passed through the wall face so as to cool inside the chamber.

### [Discharging Process]

In the discharging process, the solid matter obtained by cooling in the cooling process is discharged from the movable hearth type heating furnace. The discharged solid matter may be further cooled outside of the movable hearth type heating furnace.

### [Crushing Process]

In the crushing process, the solid matter (i.e., discharged matter including metallic iron, slag, and hearth covering material) discharged from the movable hearth type heating furnace in the discharging process is crushed using a crusher.

A crusher configured to apply impact to the object matter is preferably used as the crusher. More preferably used is a crusher configured to apply strong impact to the object matter. Examples of a crusher which can be used include a hammer crusher, cage crusher, rotor crusher, ball crusher, roller crusher, rod crusher, and so forth. Further, from the perspective of impact force and durability, a hammer crusher, cage crusher, or rod crusher is preferably used.

In a case of using a hammer crusher as the crusher, the screen bar spacing is preferably set to 5 to 20 mm. If the screen bar spacing is set too large, the rate of discharged matter discharged without receiving hardly any impact from the crusher increases, so the upper limit preferably is 20 mm. On the other hand, if the screen bar spacing is set to smaller than 5 mm which is too small, impact needs to be repeatedly applied until the grain diameter is equal to or smaller than the spacing. This is undesirable since it is over-pulverizing and also increases wear on the machine and uses much energy. Accordingly, the lower limit preferably is 5 mm. The screen bar spacing more preferably is 10 to 15 mm. The reason is that in a case where there is temperature fluctuation under standard operational conditions, the percentage of discharged matter of which the grain diameter is 10 to 15 mm is approximately 50%.

### [First Metallic Iron Collecting Process]

In the first metallic iron collecting process, the crushed product obtained in the above-described crushing process is sorted using a separator and metallic iron is collected. That is to say, the metallic iron collected from the above crushed product contains little slag, and can be used as a product as it is.

The method invention may include:

a process of screening the discharged matter including metallic iron, slag, and hearth covering material that has been discharged from the movable hearth type heating furnace, into oversieve and undersieve, using a sifter a (hereinafter, also refereed to as screening process);

a process of crushing the obtained oversieve using a crusher (crushing process); and

a process of sorting the obtained crushed matter using a separator and collecting the metallic iron (metallic iron collecting process).

### [Screening Process]

In the screening process, the discharged matter containing metallic iron, slag, and hearth covering material, that is discharged from the movable hearth type heating furnace, is screened using a sifter a.

A sifter having a sieve opening of 2 to 8 mm is preferably used as the sifter a. If the sieve opening is smaller than 2 mm or larger than 8 mm, improving collecting efficiency of the metallic iron becomes difficult even if combined with pulverization and magnetic separating, which will be described later.

The oversieve obtained in the screening process includes 95% or less iron in terms of iron content, and the oversieve contains molten metallic iron, molten slag, incompletely molten metallic iron, incompletely molten slag, and so forth.

The oversieve obtained in the screening process may be subjected to magnetic separating by a magnetic selector before crushing by the crusher, and the collected magnetically attractable substance be crushed. The magnetically non-attractable substance collected using the magnetic separator may be crushed using a crusher, and the obtained crushed matter may be magnetically separated again using the magnetic separator. Repeating pulverizing and magnetic separation enables separation of metallic iron and slag to be furthered, and the collecting rate of the metallic iron can be improved. The magnetically attractable substance obtained by performing magnetic separation by the magnetic separator again may be collected as metallic iron, which can increase the collection percentage of the metallic iron. The magnetically non-attractable substance is primarily slag and hardly contains any metallic iron, and thus can be recycled as a raw material such as roadbed material or the like.

A separator such as a magnetic separator, wind separator, sifter b, or the like, may be used as the separator.

In a case of using the sifter b as the separator, after screening using the sifter b, the undersieve is preferably subjected to magnetic separation using a magnetic separator, to collect the obtained magnetically attractable substance as metallic iron. The slag percentage of the collected metallic iron is relatively low. On the other hand, the non-magnetic material separated by magnetic separation using a magnetic separator is primarily slag.

After screening using the sifter b, the oversieve is metallic iron of which the grain size is large, so the oversieve may be used as the product as it is, or magnetic separation may be performed using a magnetic separator to collect obtained magnetically attractable substance as metallic iron. The oversieve may be formed into an agglomerate by adding binder or the like and forming into briquettes or the like, as needed. On the other hand, the magnetically non-attractable substance separated by magnetic separation using a magnetic separator is primarily slag.

A sifter having a sieve opening of 1 to 8 mm is preferably used as the sifter b, for example.

The present invention may further include a pulverizing process to pulverize by a pulverizer the magnetically attractable substance obtained by selecting using the magnetic separator. The pulverized matter obtained in the pulverizing process may be pulverized again using the pulverizer. The pulverized matter obtained in the pulverizing process may be separated using the magnetic separator, with the obtained magnetically attractable substance being collected as metallic iron. This collected magnetically attractable substance may be formed into an agglomerate in the shape of briquettes, for example, and used as an iron source.

Examples of the pulverizer include a ball crusher, rod crusher, cage crusher, rotor crusher, and roller crusher. In a case where the pulverizing object is small, impact force is not readily applied, and separation of metallic iron and slag is difficult. Accordingly, using a cage crusher or rotor crusher is preferable. The reason is that a cage crusher or rotor crusher is capable of applying strong impact even to small grains.

Next, another method of producing metallic iron according to the present invention will be described.

A feature of the present invention is including:

a process of forming an agglomerate of a mixture containing an iron oxide-containing material and a carbonaceous reductant (agglomerate forming process);

a process of introducing the obtained agglomerate into a movable hearth type heating furnace and heating, so that the agglomerate is melted to form molten metallic iron, molten slag, and a reduced agglomerate (heating process);

a process of cooling the obtained mixture (cooling process);

a process of discharging a solid matter obtained by cooling, from the movable hearth type heating furnace (discharging process);

a process of screening discharged matter containing metallic iron, slag, and hearth covering material that has been discharged from the movable hearth type heating furnace, using a sifter; and

a process of sorting the undersieve obtained in the process of screening using a separator, and collecting the metallic iron (hereinafter, also referred to as second metallic iron collecting process).

Of the above processes, the agglomerate forming process, heating process, cooling process, discharging process, and screening process are the same as described above, so description will be omitted, and the second metallic iron collecting process will be described in detail.

### [Second Metallic Iron Collecting Process]

In the second metallic iron collecting process, metallic iron is sorted and collected from the undersieve obtained in the screening process, using a separator. On the other hand, almost all other than the metallic iron sorted using a separator is slag, and hardly no metallic iron is included at all, so this can be used as a raw material such as a roadbed material or a soil improvement material or the like.

A magnetic separator can be suitably used as the separator, for example, with magnetically attractable substance obtained by selection by the magnetic separator being collected as metallic iron (hereinafter also referred to as magnetically attractable substance collecting process).

That is to say, in the magnetically attractable substance collecting process, the undersieve obtained in the screening process is magnetically separated using a magnetic separator, and magnetically attractable substance is collected. On the other hand, the magnetically non-attractable substance magnetically separated is almost all hearth covering material, and can be recycled.

The present invention may further include a pulverizing process of pulverizing by a pulverizer the magnetically attractable substance collected in the magnetically attractable substance collecting process (hereinafter, also referred to as pulverizing process), and

a collecting process of sorting the obtained pulverized matter using a separator, and collecting metallic iron.

It is sufficient that the pulverizer be a device which applies the magnetically attractable substance with at least one selected from a group consisting of impact force, friction force, and compression force, so as to separate slag from the magnetically attractable substance by applying impact force, friction force, or compression force.

Examples of the pulverizer that can be used include a ball crusher, rod crusher, cage crusher, rotor crusher, roller crusher, and so forth. Also, a hammer crusher may be used as the pulverizer.

The present invention may further include in operations a pulverizing process of pulverizing at least a part of the undersieve obtained in the screening process using a pulverizer. The pulverized matter obtained in the process of pulverizing using a pulverizer may be subjected to magnetic separation using a magnetic separator, and the magnetically attractable substance collected. The pulverized matter obtained in the process of pulverizing using a pulverizer may be pulverized again using a pulverizer. In the present embodiment, the undersieve may be subjected to magnetic separation using a magnetic separator before pulverizing the undersieve to collect the magnetically attractable substance, with the collected magnetically attractable substance being pulverized.

The metallic iron collected by sorting using the separator, and the magnetically attractable substance collected by selection using the magnetic separator, may be formed into an agglomerate in the shape of briquettes, for example, and used as an iron source.

A modification of the method of producing metallic iron according to the present invention will be described.

According to the present invention, operation may be performed including:

a process of forming an agglomerate of a mixture including an iron oxide-containing material and a carbonaceous reductant;

a process of introducing the obtained agglomerate and a reduction auxiliary material (e.g., hearth covering material) into a movable hearth type heating furnace, and heating to melt the agglomerate and form molten metallic iron, molten slag, and a reduced agglomerate;

a process of cooling the obtained mixture;

a process of discharging the solid matter obtained by cooling, from the movable hearth type heating furnace;

a process of separating the discharged matter containing metallic iron, slag, and hearth covering material, that is discharged from the movable hearth type heating furnace, into coarse particulate matter and fine particulate matter using a sifter a; and

a process of collecting non-metallic iron (e.g., hearth covering material) from the obtained fine particulate matter using a separator.

According to the present invention, operation may be performed including:

a process of forming an agglomerate of a mixture including an iron oxide-containing material and a carbonaceous reductant;

a process of introducing the obtained agglomerate into a movable hearth type heating furnace, and heating to melt the agglomerate and form molten metallic iron, molten slag, and a reduced agglomerate;

a process of cooling the obtained mixture;

a process of discharging the solid matter obtained by cooling, from the movable hearth type heating furnace;

a process of separating the discharged matter containing metallic iron, slag, and hearth covering material, that is discharged from the movable hearth type heating furnace, into first coarse particulate matter and first fine particulate matter using a sifter a;

a pulverizing process of pulverizing the first coarse particulate matter;

a process of screening the pulverized matter obtained in the pulverizing process into second coarse particulate matter and second fine particulate matter; and a process of pulverizing the first fine particulate matter and the second fine particulate matter.

The first fine particulate matter obtained by screening using the sifter a may be magnetically separated using a magnetic separator, and the obtained magnetically attractable substance mixed with the second fine particulate matter and then pulverized.

The second fine particulate matter obtained by screening the pulverized matter obtained in the pulverizing process may be magnetically separated using a magnetic separator, and the obtained magnetically attractable substance mixed with the first fine particulate matter and then pulverized.

According to the present invention, operation may be performed including:

a process of forming an agglomerate of a mixture including an iron oxide-containing material and a carbonaceous reductant;

a process of introducing the obtained agglomerate into a movable hearth type heating furnace, and heating to melt the agglomerate and form molten metallic iron, molten slag, and a reduced agglomerate;

a process of cooling the obtained mixture;

a process of discharging the obtained solid matter from the movable hearth type heating furnace;

a process of separating the discharged matter containing metallic iron, slag, and hearth covering material, that is discharged from the movable hearth type heating furnace, into first coarse particulate matter and first fine particulate matter using a sifter a;

a process of pulverizing the first coarse particulate matter;

a process of screening the pulverized matter obtained in the pulverizing process into second coarse particulate matter and second fine particulate matter;

a pulverizing process of pulverizing the first fine particulate matter and the second fine particulate matter; and

a process of mixing the pulverized matter that has been pulverized and the second coarse particulate matter, and forming an agglomerate thereof.

The first fine particulate matter obtained by screening using the sifter a may be magnetically separated using a magnetic separator, and the obtained magnetically attractable substance mixed with the second fine particulate matter and then pulverized.

The second fine particulate matter obtained by screening the pulverized matter obtained in the pulverizing process may be magnetically separated using a magnetic separator, and the obtained magnetically attractable substance mixed with the first fine particulate matter and then pulverized.

The pulverized matter that has been pulverized may be magnetically separated using a magnetic separator, and the obtained magnetically attractable substance be formed into an agglomerate.

The collected matter collected in each process may be formed into an agglomerate and used as an iron source.

According to the method for producing metallic iron of the present invention, discharged matter from the movable hearth type heating furnace is appropriately crushed or pulverized, so metallic iron can be efficiently collected.

The second invention has thus been described.

Even after having completed the above-described first invention and the above-described second invention, the Present Inventors diligently studied improving metallic iron collecting efficiency and improving metallic iron productivity when heating an agglomerate formed of a mixture including an iron oxide-containing material and a carbonaceous reductant in a movable hearth type heating furnace, and producing metallic iron. As a result, it has been found that

(1) Applying impact to and pulverizing a reduced product including metallic iron and slag, which is discharged matter from a movable hearth type heating furnace, suitably separates the metallic iron and slag, so the collecting efficiency of metallic iron improves,

(2) sorting the discharged matter in a magnetic separator and crushing the magnetically attractable substance by applying impact enables slag to be separated as magnetically non-attractable substance beforehand, so the collecting efficiency of metallic iron further improves,

(3) classifying using a sifter having a predetermined sieve opening before crushing the reduced product enables the reduced product to be efficiently crushed, so the collecting efficiency of metallic iron improves, and

(4) appropriately controlling the conditions for impact crushing of the reduced product improves the crushing efficiency of the reduced product, so the collecting efficiency of metallic iron improves. Thus, the third invention was completed.

Now, after describing the background leading up to the completion of the third invention, feature portions of the third invention will be described.

The Present Inventors prepared a low-grade iron ore including a great gangue component out of all iron ores, and heated an agglomerate containing this iron ore and a carbonaceous reductant, in a movable hearth type heating furnace. The reduced pellets obtained by this heating were finely crushed by various types of crushing, and magnetically attractable substance was collected by magnetic separation using a magnetic separator. However, the slag percentage [(SiO₂+Al₂O₃)/T.Fe×100 . . . (1)] of the magnetically attractable substance was around 17%, and improvement of the iron grade was difficult.

It was found that in a case of using low-grade iron ore with a great gangue component, melting the entirety of the agglomerate and separating into metallic iron and slag is difficult in a short heating time of 11 minutes or less on the hearth of a movable hearth type heating furnace, even if heated at a temperature of around 1300 to 1350° C., and after heating, granular metallic iron, molten slag, hollow reduced pellets, spherical reduced pellets, and so forth, were found to be intermingled. The cause of this is as follows. When heating at a high temperature of 1300° C. or higher, heat supply by radiant heat is far greater than heat supply by heat transfer among pellets and into the pellets, but temperature increase at portions where the amount of radiant heat received is small is markedly delayed. That is to say, on the scale of individual pellets, the bottom of that pellet, and on the scale of multiple pellets which are overlaid vertically, the pellets under other pellets, will be delayed regarding temperature increase. As a result, after a short time of 11 minutes or less, parts which melt and parts which remain as reduced iron coexist. Particularly, the greater the amount of gangue in the pellets is, the more pronounced the variance in the reduced state is, and the more firmly the metallic iron and slag are adhered.

On the other hand, extending the heating time increases the amount of heat transfer, so the above-described variance in reduction state is reduced, but production efficiency falls. Accordingly, the product should be discharged from the furnace as soon as possible after reduction is completed.

Now, the Present Inventors have found that even in a case where the reduced product discharged from the furnace after heating an agglomerate in a movable hearth type heating furnace has granular metallic iron, molten slag, hollow reduced pellets, spherical reduced pellets, and so forth, in an intermingled state, metallic iron can be efficiently collected by using a combination of crushing, screening and separation using a separator.

While description has been made primarily regarding a case of using low-grade iron ore (iron oxide-containing material) containing a great amount of gangue, the present invention is not restricted to using low-grade iron ore containing a great amount of gangue, and it has been confirmed that the present invention is also applicable to a case of using high-grade iron ore (iron oxide-containing material) containing little gangue.

The third invention will be described below.

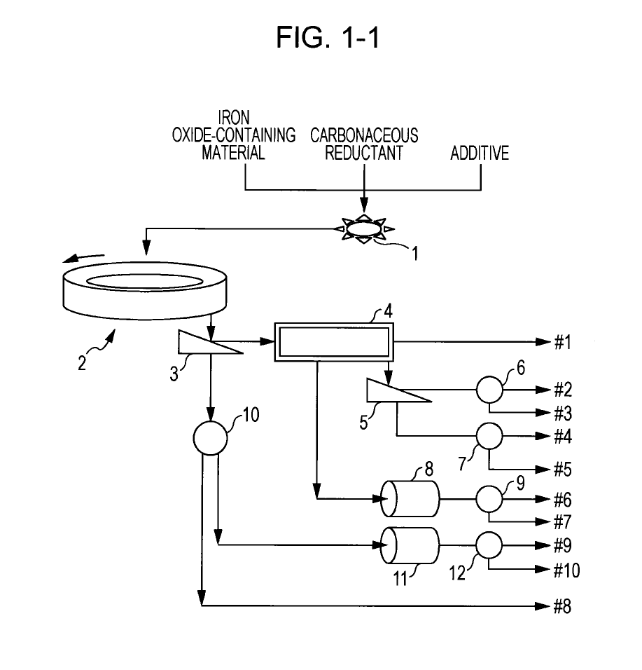

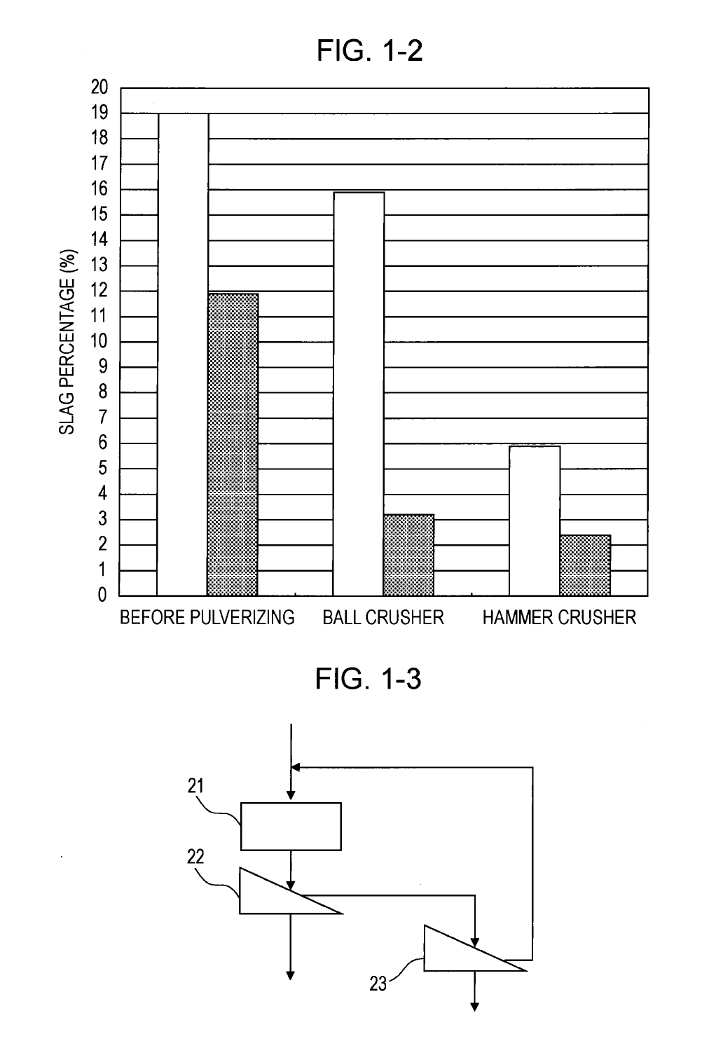

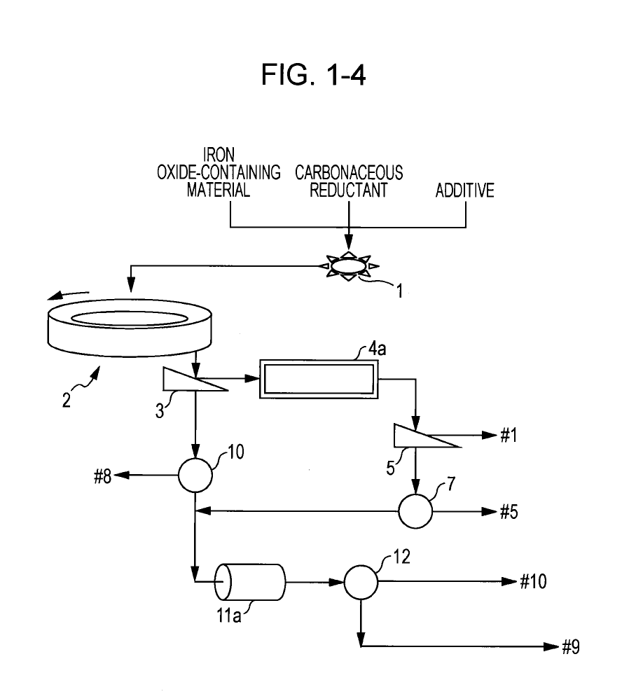

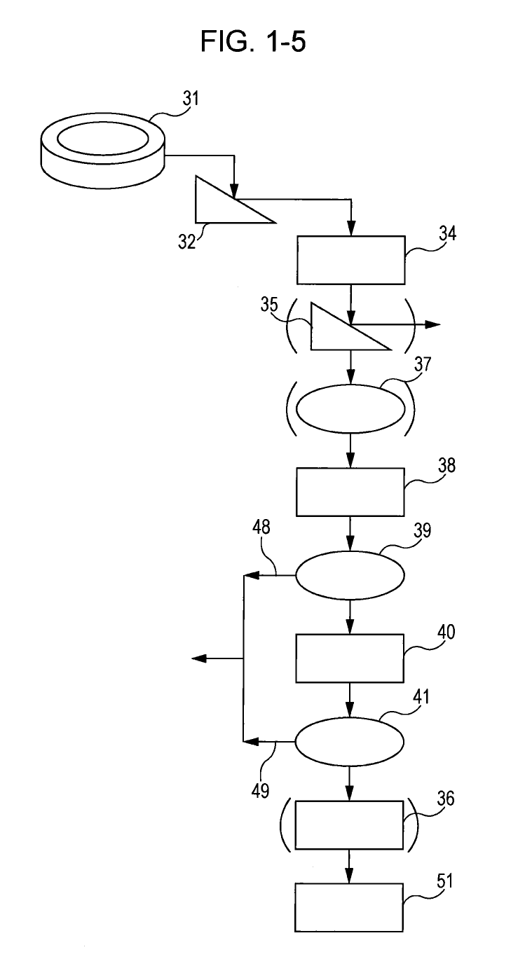

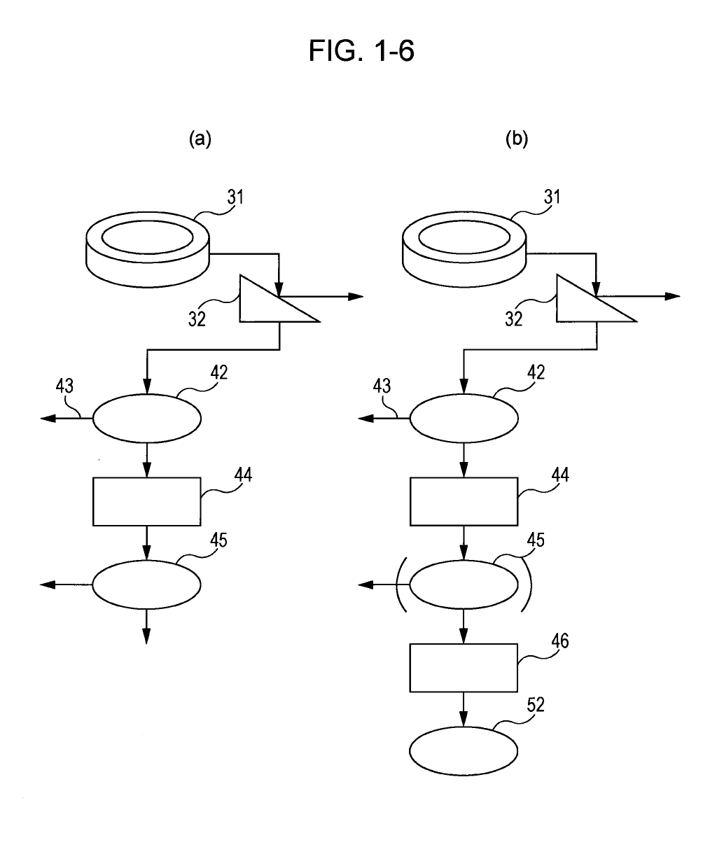

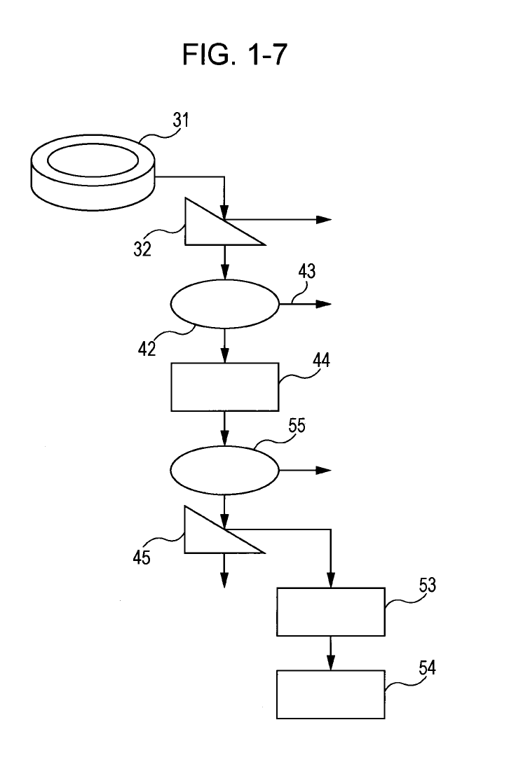

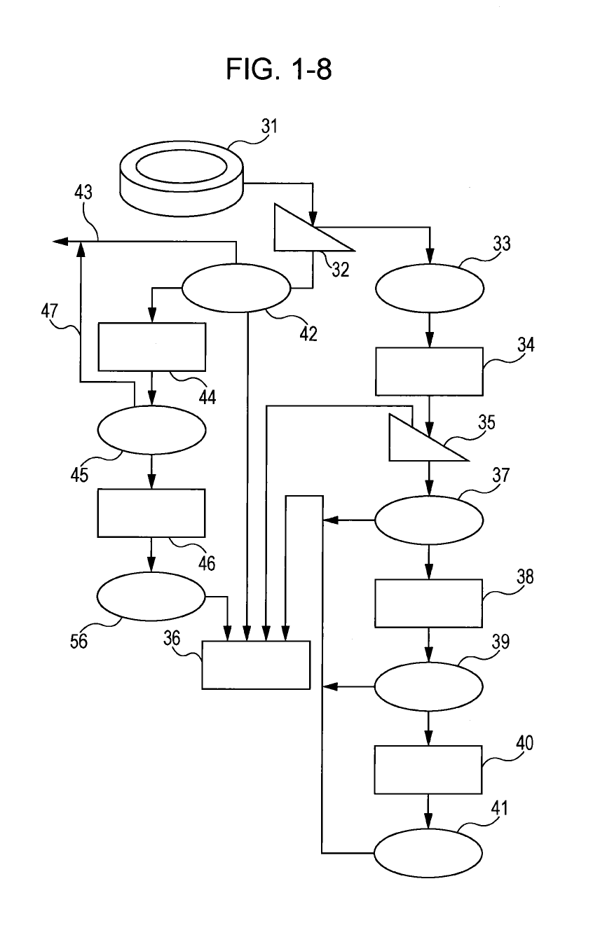

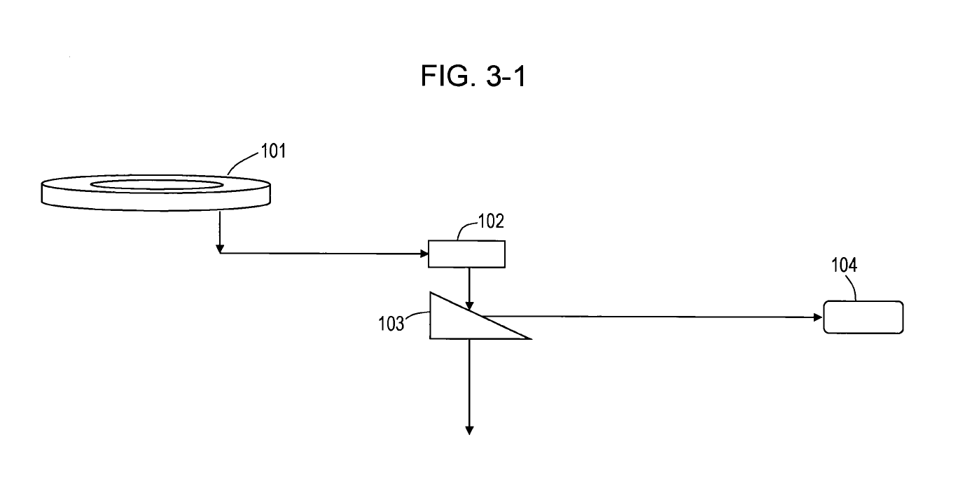

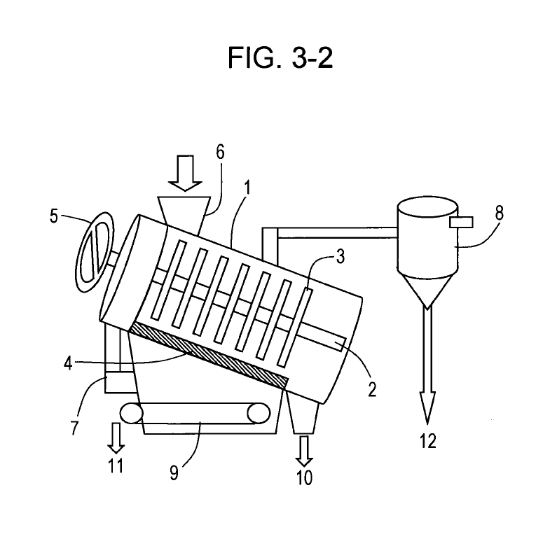

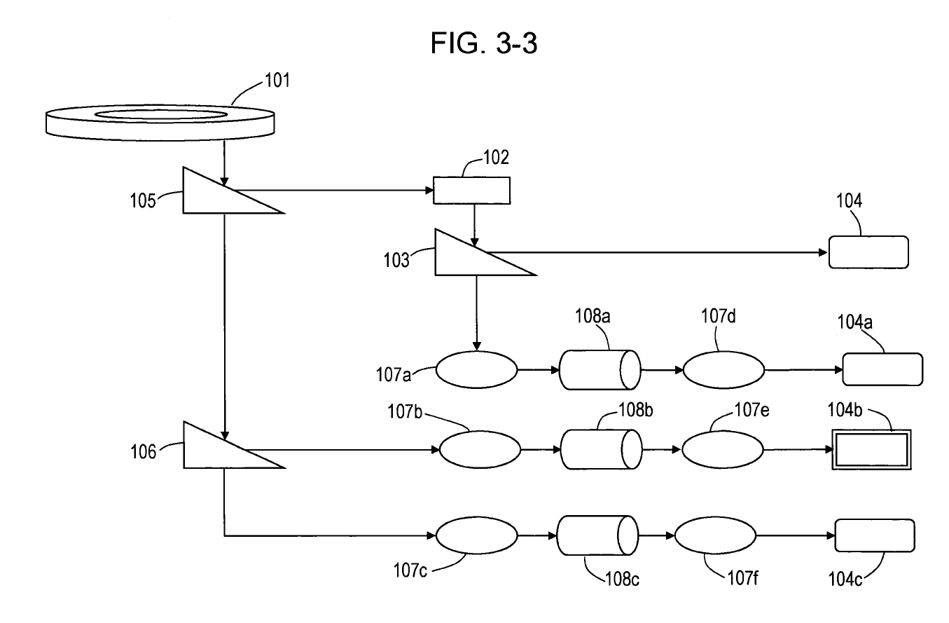

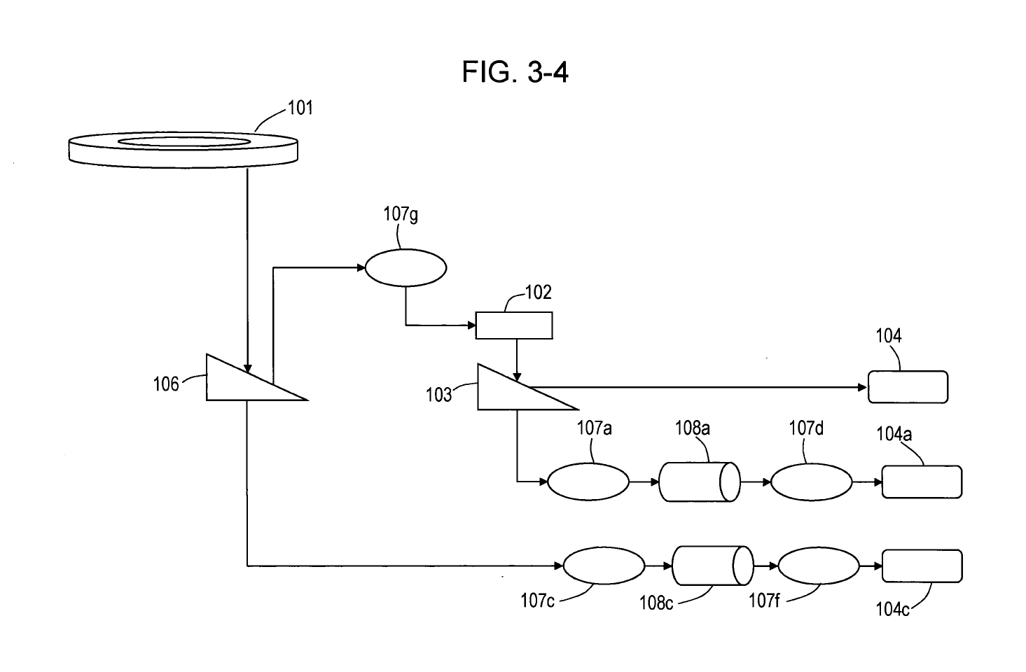

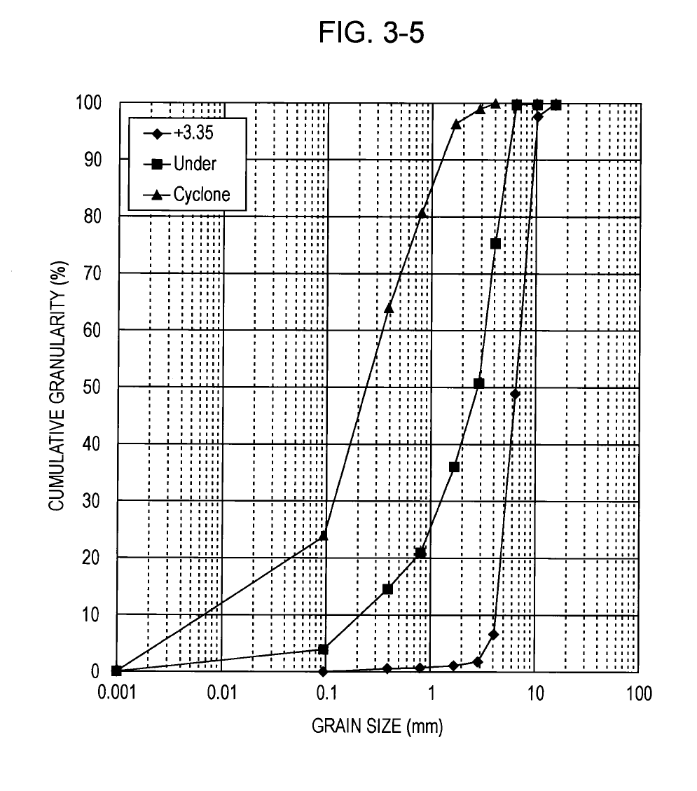

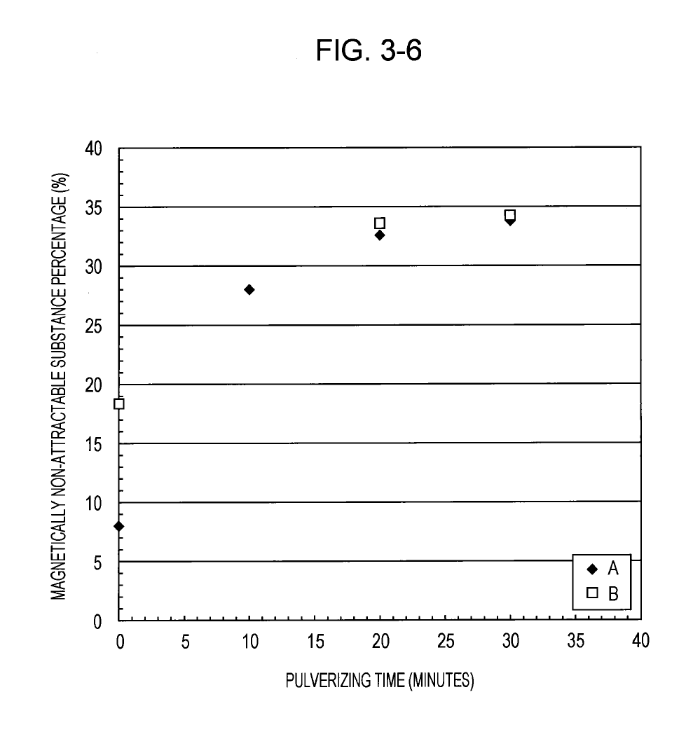

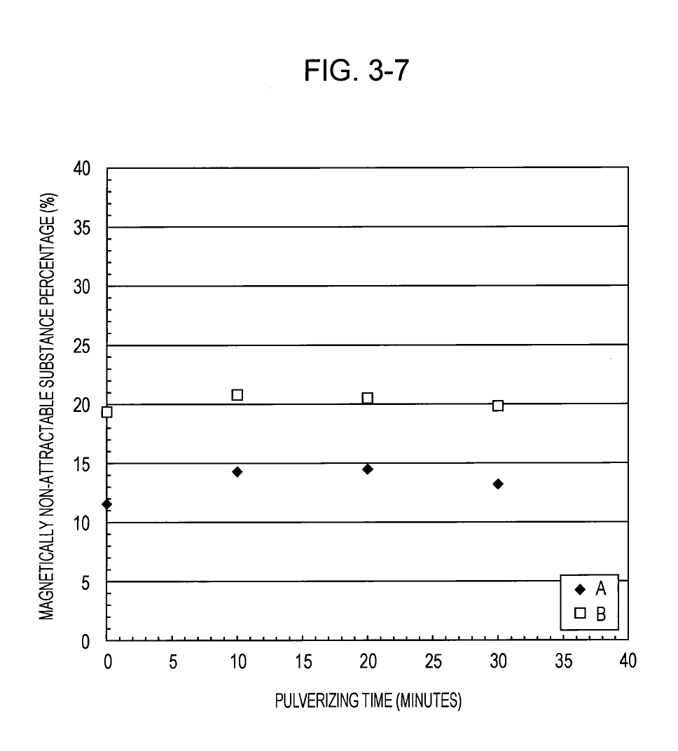

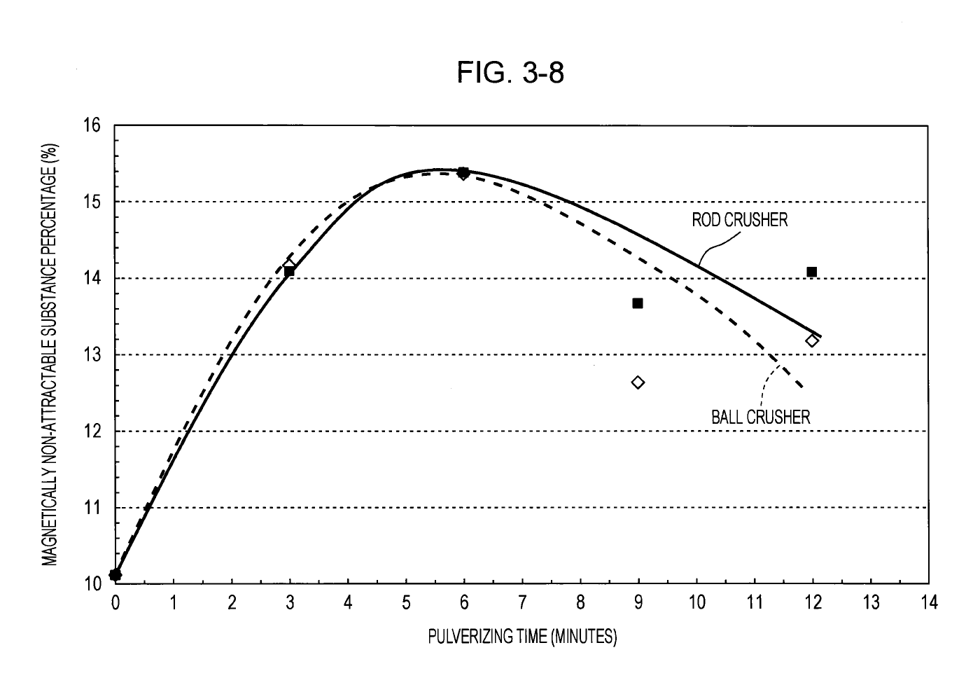

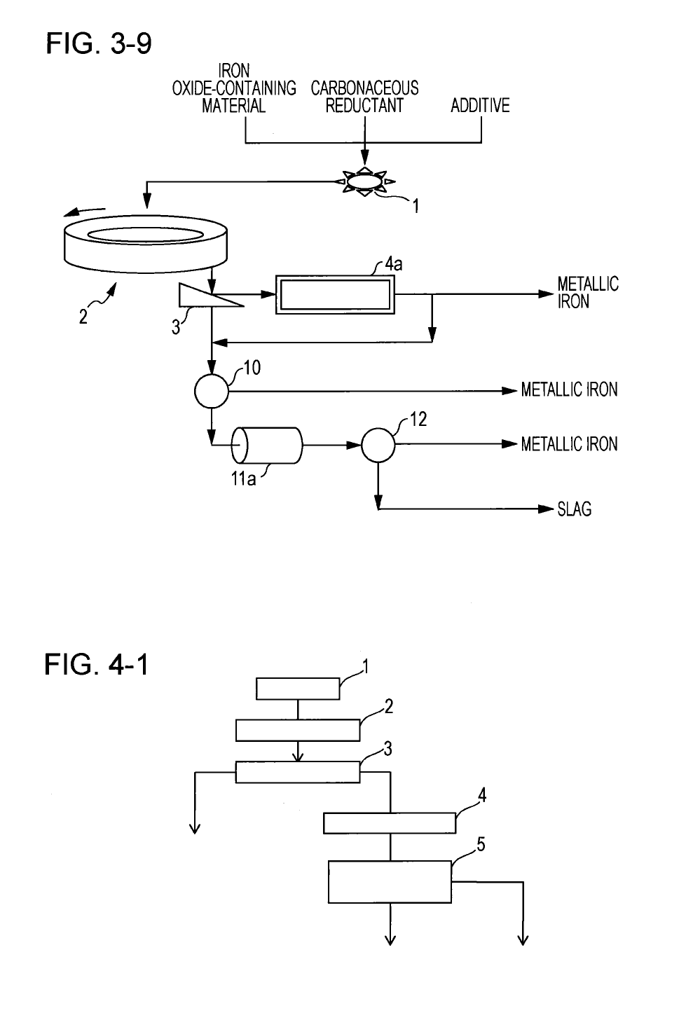

A feature of the method for producing metallic iron, is in that the method includes: a process of forming an agglomerate of a mixture containing an iron oxide-containing material and a carbonaceous reductant (hereinafter, also referred to as agglomerate forming process); a process of introducing the obtained agglomerate into a movable hearth type heating furnace and reduced by heating (hereinafter, also referred to as process of reducing by heating), a process of applying impact to the discharged matter from the movable hearth type heating furnace which is a reduced product including metallic iron and slag (hereinafter, also referred to as crushing process) so as to crush using a crusher, a process of screening the obtained crushed matter using a sifter a having a sieve opening of 3 to 5 mm (hereinafter, also referred to as screening process a); and a process of collecting oversieve a as metallic iron (hereinafter, also referred to as metallic iron collecting process a). While these processes are necessary conditions, processes such as screening, pulverizing, magnetically separating, and so forth, may be suitably combined and added. A method of producing metallic iron according to the present invention will be described with reference to FIG. 3-1.

FIG. 3-1 is a process diagram for describing a metallic iron producing method according to the present invention. 101 illustrates an external view of a rotary hearth furnace which is an example of a movable hearth type heating furnace, 102 illustrates a crusher, 103 illustrates a sifter a having a sieve opening of 3 to 5 mm, and 104 illustrates metallic iron. Note that FIG. 3-1 illustrates an example of the method of producing metallic iron according to the present invention, and the present invention is not restricted to this FIG. 3-1.

### [Agglomerate Forming Process]

In an agglomerate forming process, an agglomerate is formed of a mixture including an iron oxide-containing material and a carbonaceous reductant, thus producing an agglomerate.

Specific examples of the above iron oxide-containing material which can be used include iron ore, iron sand, ironmaking dust, non-ferrous smelting residue, ironmaking waste, and so forth. Iron ore will be described as a representative example of iron oxide-containing material. Iron ore contains gangue. Gangue is a component making up iron ore mined from a mine (crude ore) other than minerals including useful metal, and normally is made up of oxides such as SiO₂ and Al₂O₃. The amount of gangue included in the iron ore differs depending on the region of production where the iron ore is mined. Iron ore containing little gangue is called high-grade iron ore, and iron ore containing a large amount of gangue is called low-grade iron ore.

High-grade iron oxide-containing material containing little gangue can be used as the iron oxide-containing material according to the present invention, but also low-grade iron oxide-containing material containing a great amount of gangue, which had not been normally used heretofore, can also be used. Using low-grade iron ore results in increased amount of molten slag, so the cost of melting and refining in the following process increases, and depending upon the conditions to produce granular iron the heat transfer to the agglomerate is impeded, and production of metallic iron is lower. Accordingly, low-grade iron ore has hardly been used heretofore as a raw material for iron. However, low-grade iron ore is inexpensive, so industrial use is desired. A particular reason is that while the global production amount of steel is rising, there is a downward trend in the amount of high-grade iron ore being mined, and consequently an increase of the price of high-grade iron ore is expected. On the other hand, according to the present invention, an agglomerate is reduced by heating, and then crushed using an impact crusher after which selection is performed using a separator having a sieve opening of 3 to 5 mm to collect the metallic iron, so metallic iron can be efficiently collected even if low-grade iron ore containing a large amount of gangue is used as a raw material.

The aforementioned low-grade iron oxide-containing material as used in the Present Specification means that where the percentage of the total mass of SiO₂ and Al₂O₃ as to the total iron mass (T.Fe) [slag percentage=(SiO₂+Al₂O₃)/T.Fe×100] is 10% or more. SiO₂ and Al₂O₃ are, of the various types of gangue contained in the iron oxide-containing material (e.g., iron ore), matter regarding which the content percentage is relatively high, and accordingly these are used as representative matter of gangue in the Present Specification. The percentage of the total mass of SiO₂ and Al₂O₃ as to the total iron mass is defined as the slag percentage, with that having slag percentage of 5% or less being called high-grade iron oxide-containing material, that having slag percentage of more than 5% but 10% or less being called mid-grade iron oxide-containing material, and that having slag percentage of 10% or more being called low-grade iron oxide-containing material. In a case where a large amount of titanium oxide is included, such as with iron sand or the like, the titanium oxide is also added to the SiO₂ and Al₂O₃ when calculating the slag percentage. According to the present invention, the slag percentage may be 10% or more, or may be less than 10%.

Examples of the carbonaceous reductant which can be used include coal, coke, and so forth. It is sufficient for the carbonaceous reductant to include enough carbon to reduce the iron oxide contained in the iron oxide-containing material. Specifically, it is sufficient for the amount of carbon to be in a range of 0 to 5% by mass in excess to 0 to 5% by mass lacking as to the amount of carbon which can reduce the iron oxide contained in the iron oxide-containing material (i.e., ±5% by mass).

The mixture containing the iron oxide-containing material and the carbonaceous reductant preferably further has a melting point controlling agent added thereto. The melting point controlling agent means matter which affects the melting point of components other than the iron oxide included in the agglomerate (particularly gangue), and excludes matter which affects the melting point of metallic iron. That is to say, by adding the melting point controlling agent to the agglomerate, the melting temperature of components other than the iron oxide included in the agglomerate (particularly gangue) can be affected, and the melting temperature thereof can be reduced, for example. This promotes melting of the components other than the iron oxide (particularly gangue), thereby forming molten slag. Part of the iron oxide is dissolved in the molten slag at this time, and is reduced and becomes metallic iron in the molten slag. The metallic iron generated in the molten slag comes into contact with metallic iron reduced in its solid state, and is aggregated as solid reduced iron.

A melting point controlling agent including at least a CaO source is preferably used as the melting point controlling agent. At least one selected from a group including CaO (quicklime), Ca(OH)₂ (slaked lime), CaCO₃ (limestone), and CaMg(CO₃)₂ (dolomite), for example, is preferably added as the CaO source.

The aforementioned CaO source alone may be used as the melting point controlling agent, or an MgO source, Al₂O₃ source, SiO₂ source, or the like, may be used in addition to the CaO source. MgO, Al₂O₃, and SiO₂ are also matters which affect the melting point of components other than iron oxide (particularly gangue) contained in the agglomerate, in the same way as the CaO described above. At least one selected from a group including MgO powder, Mg-containing matter extracted from natural ore or seawater or the like, and MgCO₃, for example, is preferably added as the MgO source. At least one selected from a group including Al₂O₃ powder, bauxite, boehmite, gibbsite, diaspore, and so forth, is preferably added as the Al₂O₃ source. Examples which can be used as the SiO₂ include SiO₂ powder, quartz sand, and so forth.

The agglomerate may further include a binder or the like, as a component other than the iron oxide-containing material, carbonaceous reductant, and melting point controlling agent. Examples which can be used as the binder include polysaccharides or the like (e.g., starches such as cornstarch, flour, and so forth, molasses, and so forth).

The iron oxide-containing material, carbonaceous reductant, and melting point controlling agent are preferably crushed before mixing. An average grain size of 10 to 60 μm is recommended for the iron oxide-containing material, average grain size of 10 to 60 μm for the carbonaceous reductant, and average grain size of 5 to 90 μm for the melting point controlling agent, for example, which is attained by crushing.

The means by which the iron oxide-containing material and so forth are crushed is not restricted in particular, and known means may be used. For example, a vibrational crusher, roll crusher, ball crusher, or the like, may be used.

A rotating container mixer or fixed container mixer, for example, may be used as a mixer to mix the mixture. Examples of the rotating container mixer which can be used include a rotating cylinder mixer, a double cone mixer, a V blender, or the like. Examples of the fixed container mixer which can be used include a mixer having paddles (e.g., spades) in a mixing vat.

Examples of a compactor to form an agglomerate of the mixture include a tumbling disc granulator, cylinder type granulator (drum type granulator), twin-roll briquetter, or the like. The shape of the agglomerate is not restricted in particular, and may be aggregates, grains, briquettes, pellets, rods, or the like, for example, and preferably is briquettes or pellets.

### [Process of Reducing by Heating]

In the process of reducing by heating, the agglomerate obtained in the agglomerate forming process described above is introduced to a movable hearth type heating furnace 101 illustrated in FIG. 3-1, and heated to reduce the iron oxide in the agglomerate, thereby producing a reduced product containing metallic iron and slag.

A movable hearth type heating furnace is a heating furnace where the hearth moves through the furnace like a belt conveyer, examples of which include a rotary hearth furnace and a tunnel furnace. The aforementioned rotary hearth furnace is a furnace where the hearth is designed so as to have a circular (doughnut-shaped) external appearance, such that the starting point and ending point of the hearth is at the same position. An agglomerate supplied on the hearth is reduced by heating while traveling one round through the furnace, thereby generating metallic iron (e.g., sponge-like iron or granular metallic iron). Accordingly, a rotary hearth furnace has introducing means at farthest upstream in the rotational direction to supply the agglomerate to the furnace, and discharge means farthest downstream in the rotational direction (which is actually immediately upstream from the introducing side, due to the rotary structure). The aforementioned tunnel furnace is a heating furnace where the hearth moves linearly through the furnace.

The agglomerate is preferably reduced by heating, by heating at 1300 to 1500° C. in the movable hearth type heating furnace. If the heating temperature is below 1300° C., the metallic iron and slag do not readily melt, and high productivity is not obtained. On the other hand, if the heating temperature exceeds 1500° C., the discharge gas temperature is high so the amount of waste heat is great, which is a waste of energy, and also damage of the furnace occurs.

Laying hearth covering material on the hearth of the movable hearth type heating furnace before introducing the agglomerate into the furnace is also a preferable form. Laying hearth covering material can protect the hearth. The items exemplified above as carbonaceous reductants may be used as hearth covering material, and also fireproof particles may be made. The grain size of the hearth covering material is preferably 3 mm or smaller, so that the agglomerate or molten material do not burrow in. The lower limit of the grain size is preferably 0.5 mm or larger, so as not to be blown away by burner combustion gas.

### [Crushing Process]

The impact crusher 102 is used in the crushing process to crush the reduced product obtained in the process of reducing by heating (see FIG. 3-1). The reduced product where the agglomerate containing the carbonaceous reductant is heated at 1300 to 1500° C. and discharged includes metallic iron of various grain size, slag, and objects where these have adhered together, and further also includes reduced pellets where metallic iron and gangue are intermingled, and hearth protecting material and so forth. It is difficult to efficiently produce high-grade metallic iron which can be supplied to an electric furnace by screening and magnetically selecting/separating such reduced product.

However, slag is a brittle matter formed of molten oxides, and accordingly is resistant to friction but weak under impact force and breaks easily. On the other hand, the metallic iron exhibits a certain level of plastic deformation.

Accordingly, a strong impact is applied to the reduced product in the present invention, thereby fracturing the slag so as to be separated from the metallic iron.

The crusher which applies the impact is preferably a crusher which applies impact from one direction, and for example, a hammer crusher, cage crusher, or the like, can be used. Devices which primarily apply pressing force to the reduced product, like a roller crusher, are excluded.

The blade speed of the crushing means, which apply impact to the reduced product and are provided to the hammer crusher or cage crusher, is preferably 30 to 60 m/second when crushing the reduced product at the crusher. The term crushing means refers to hammers provided to a hammer crusher or impact bars provided to a cage crusher. In a case where the blade speed of the crushing means is slower than 30 m/second, crushing of the reduced product is incomplete, and a great amount of metallic iron with slag adhered thereto remains, so the amount of slag contained in the metallic iron is greater. Accordingly, the blade speed of the crushing means is preferably 30 m/second or faster. On the other hand, in a case where the blade speed of the crushing means exceeds 60 m/second, the impact force is excessive, and the metallic iron is also crushed into fine powder having a grain diameter of 1 mm or smaller, for example. As a result, there is obtained an intermingled state of fine powder of metallic iron and fine powder of slag. Even if magnetic selection/separation is performed, slag is included in the magnetically attractable substance side, so separating the metallic iron and slag well becomes difficult. Also, metallic iron having a grain size of 3 mm or larger can be used as a raw ingredient at an electric furnace without change, but metallic iron having a grain size of 1 mm or smaller presents difficulty in handling when introducing to the electric furnace. Accordingly, the blade speed of the crushing means is preferably 60 m/second or slower, preferably 55 m/second or slower, and even more preferably 50 m/second or slower.

The crushing time of the reduced product is preferably 3 to 10 seconds. The longer the crushing time is, the greater the number of times of impact between the reduced product and the crushing means, resulting in both the metallic iron and the slag contained in the reduced product becoming fine, and the problem described above occurs. Accordingly, the crushing time is preferably 10 seconds or less, more preferably 8 seconds or less. From a perspective of improving productivity of the metallic iron, the crushing time is preferably as short as possible, but the lower limit for crushing the slag is around 3 seconds, more preferably 5 seconds or more.

The hammer crusher where the rotational shaft for the hammers of the crusher is inclined as to the horizontal direction is preferably used. Inclining the rotational shaft of the hammers as to the horizontal direction enables continuous discharge of crushed product within the crusher to the outside of the crusher. That is to say, already-existing hammer crushers have been designed with the objective of crushing the entire amount of matter to be crushed that is introduced into the hammer crusher to a certain grain size or smaller. A hammer crusher normally has a screen provided thereto. The crushed matter introduced into the hammer crusher is then continuously crushed until it passes through the screen provided therein. However, the matter to be crushed in the present invention includes metallic iron particles which contain approximately 2% carbon, having a grain size of 5 to 15 mm, and are extremely hard and contain hardly no slag within, reduced pellet-shaped matter which has slag contained therein, slag particles containing fine metallic iron therein, fine metallic iron particles to which slag is adhered, and so forth, in an intermingled manner. Of these, the metallic iron particles having a grain diameter of 5 to 15 mm are high-grade, so there is no need to crush, and all that is necessary is to separate and remove the slag adhered to the surface. On the other hand, the reduced pellet-shaped matter which has slag contained therein, slag particles containing fine metallic iron therein, fine metallic iron particles to which slag is adhered, and so forth, need to be separated into the metallic iron and slag by applying impact. However, there are no already-existing hammer crushers which are capable of continuous crushing processing where impact is applied to part of the matter to be crushed and impact is not applied to another part.

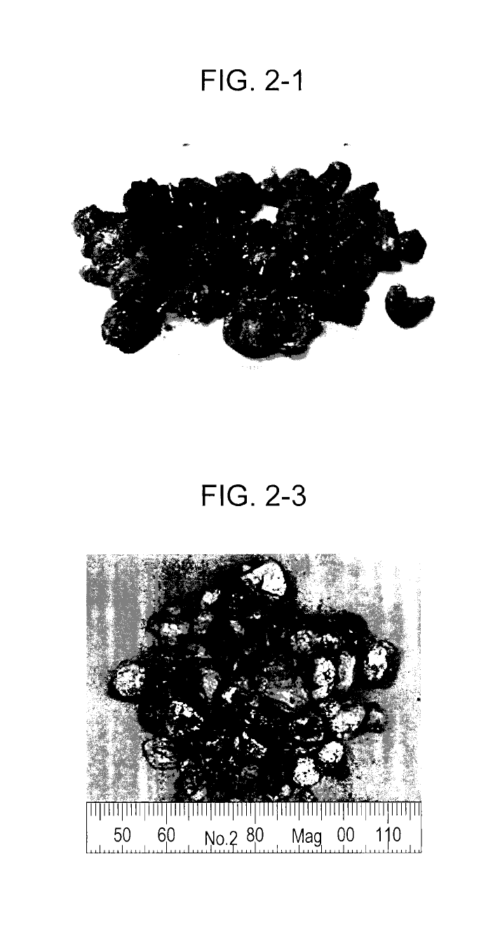

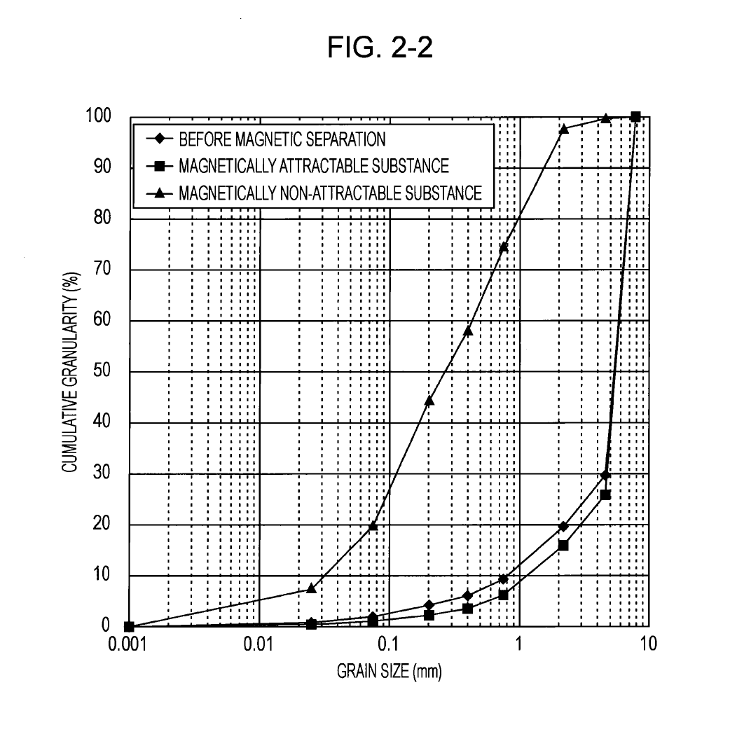

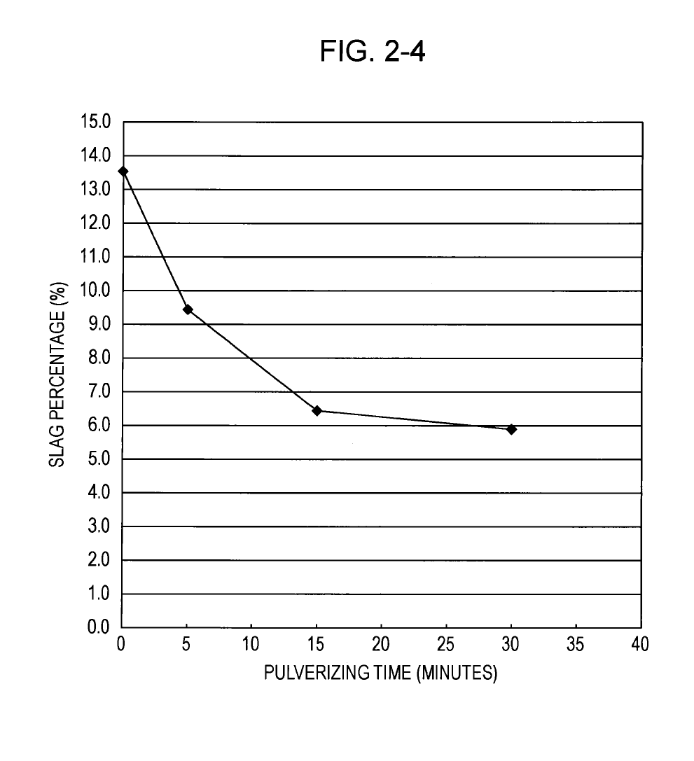

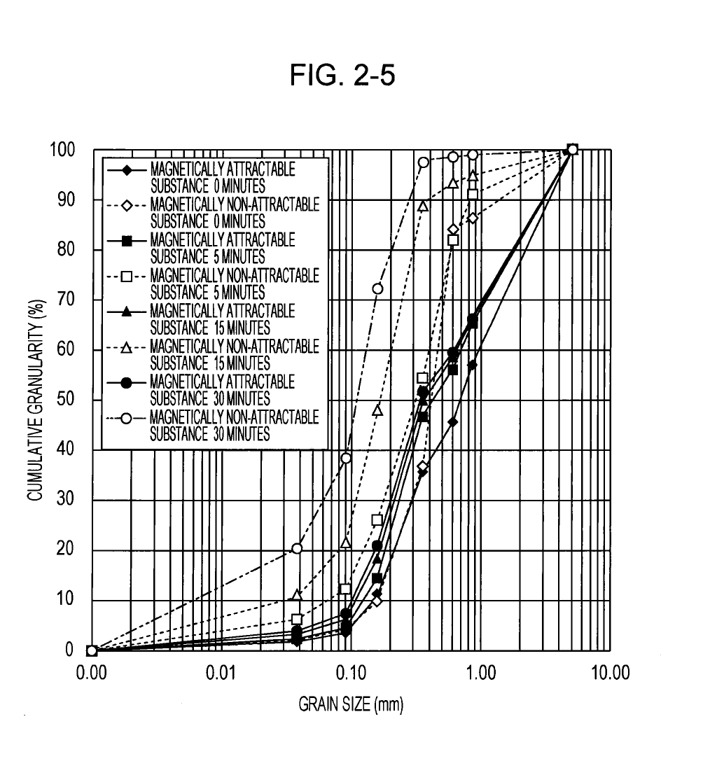

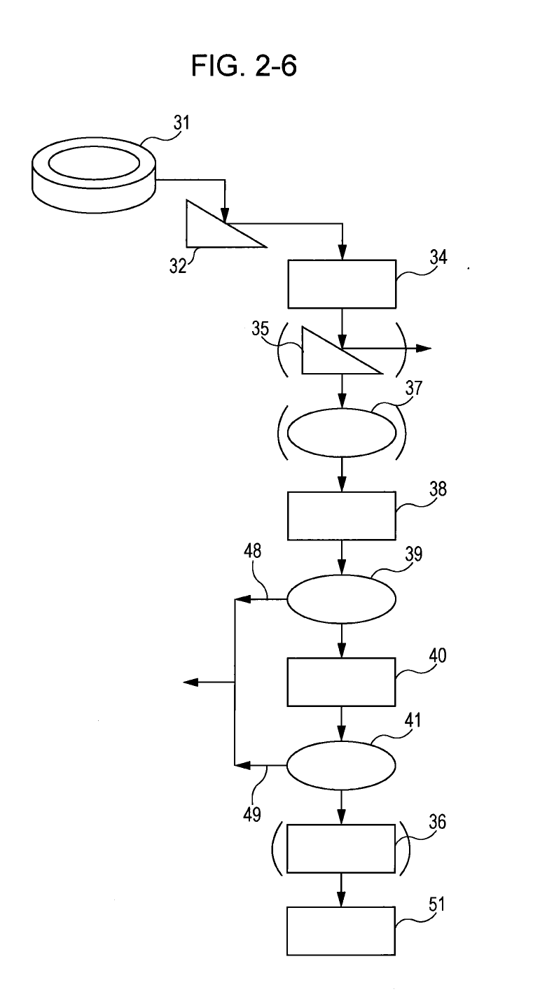

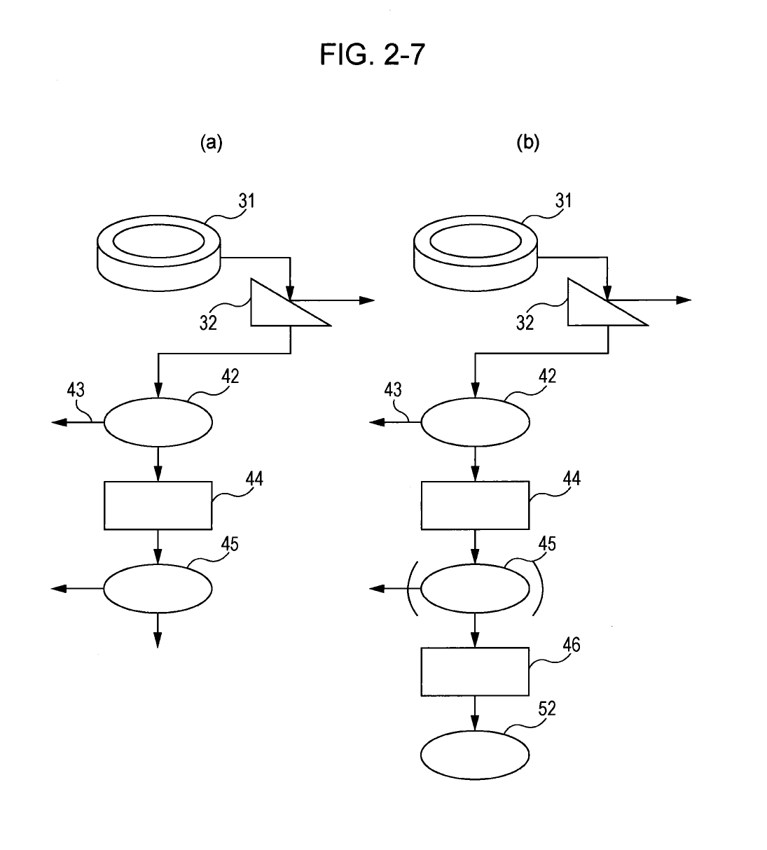

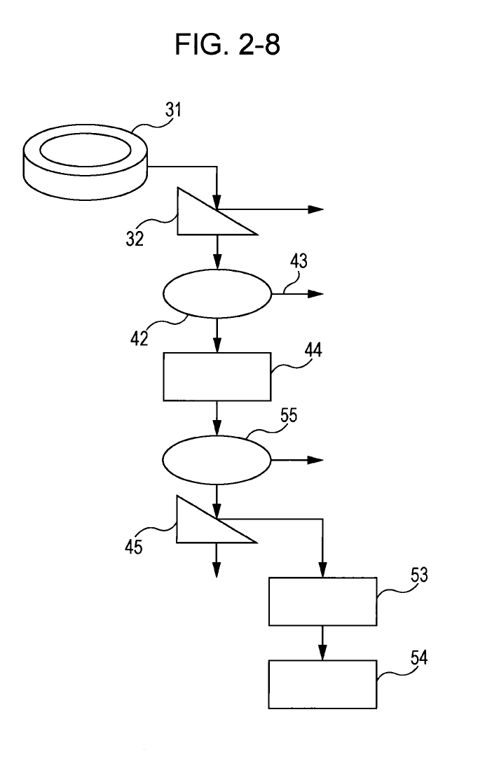

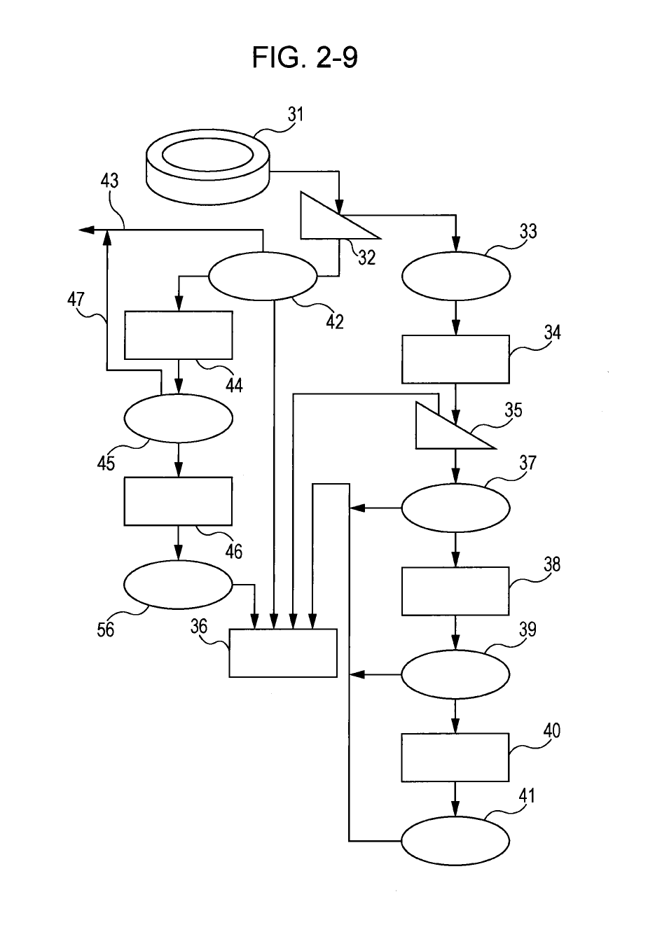

The Present Inventors thus studied providing a hammer crusher having a mechanism where automatic discharge is performed after being held for a predetermined amount of time on a screen provided to the hammer crusher. As a result, it has been found that the amount of time which the matter to be crushed stays on the screen can be adjusted by a mechanism where the rotational shaft for the hammers is inclined as to the horizontal direction, and the setting angle of the hammer rotating unit having a screen provided on the periphery thereof is variable from a horizontal position to a vertical position. The hammer crusher used in the present invention will be described with reference to the drawings. In FIG. 3-2, 1 denotes a hammer crusher main unit, 2 a rotational shaft for hammers, 3 hammers (equivalent to crushing means), 4 a screen, 5 a motor, 6 a hopper, 7 a blower (fan), 8 a cyclone separator, 9 a conveyer belt, 10 metallic iron nuggets, 11 slag and the like, and 12 powder matter, respectively.

Inside the hammer crusher main unit 1, the motor 5 is driven so as to rotate the hammers 3 on the hammer rotational shaft 2. When reduced product is introduced into the hammer crusher main unit 1 from the hopper 6, the reduced product is impacted by the hammers 3 and the slag included in the reduced product is crushed. The slag and hearth covering material, discharged as reduced product from the heating furnace, which has been crushed so as to become smaller than the sieve opening size of the screen 4, passes through the screen 4 and falls into the conveyer belt 9. That which has fallen on the conveyer belt 9 is collected as 11 illustrated in FIG. 3-2. This 11 primarily is slag and hearth covering material.

The metallic iron nuggets 10 which have had the slag separated and removed by impact from the hammers 3 and are larger than the sieve opening size of the screen 4 roll over the screen 4 and are collected.

The blower 7 is connected at the upstream side of the hammer crusher main unit 1, and the cyclone separator 8 is provided around the midstream of the hammer crusher main unit 1. The powder matter 12 generated at the hammer crusher main unit 1 is collected from the cyclone separator 8.

The amount of time over which the reduced product supplied to the hammer crusher main unit 1 comes into contact with the hammers 3 (i.e., the crushing time) can be controlled by inclining the rotational shaft of the hammers as to the horizontal direction. The greater the angle of inclination as to the horizontal angle is, the shorter the crushing time can be made, and the smaller the angle of inclination is, the longer the crushing time can be made.

The crushing time can also be adjusted by controlling the sieve opening size of the screen 4. The larger the sieve opening size of the screen 4 is, the faster the crushed matter passes through the screen 4 and falls down, so the shorter the crushing time can be made. On the other hand, the smaller the sieve opening size of the screen 4, the harder it is for the crushed matter to pass through the screen 4 and thus remains on the screen 4, so the crushing time can be made longer. In a case where the screen 4 is not provided, a great number of reduced pellet-shaped objects containing slag inside, for example, are discharged in an intermingled manner, and thus judged to be insufficiently crushed.

In a case where the sieve opening size of the screen 4 was 20 mm, the amount of magnetically non-attractable substance included in the crushed matter was little. In a case where the sieve opening size of the screen 4 was 10 mm, the amount of slag included in coarse particles having a grain diameter of 3 mm or larger was 1% or less, and extremely high-grade particulate metallic iron was obtained. The obtained coarse particles were further examined, and it was found that particles of which the grain diameter was 3.75 mm or larger were metallic iron particles of which the slag percentage was extremely small. Accordingly, it is conceivable that dropping particles crushed to a grain diameter around 5 mm below the screen is efficient, so the lower limit of the sieve opening of the screen is preferably 5 mm. The upper limit of the sieve opening of the screen is 20 mm.

While the size of the hammers (crushing means) is not restricted in particular, the greater the width of the hammer, the more opportunity there is for impact with the matter to be crushed, and so the slag is efficiently crushed. On the other hand, reducing the width of the hammer increases the shearing force on the matter to be crushed. Consideration needs to be given to the fact that the matter to be crushed which is the object in the present invention contains reduced agglomerates where fine metallic iron and slag coexist. Such reduced agglomerates merely deform under application of impact, and separating the fine metallic iron and fine slag may be difficult. As a result of repeating various experiments, it was found that the width of the hammers is suitably 4 to 20 mm.

Now, a cage crusher has no screen, so the metallic iron and slag can be separated by controlling the number of times of introduction to the cage crusher.

In the present invention, crushing is preferably performed such that a crushing index, calculated by the following expression based on the blade speed (m/second), sieve opening (m) of the screen provided to the crusher, and crushing time (seconds) in the crusher, is 800 to 2000.

Crushing index=((blade speed)²/(sieve opening size of screen)×(crushing time)^{0.5}

The blade speed represents impact energy, and the sieve opening size of the screen represents the frequency of impact per unit time. Accordingly, the crushing capability of crushing the same matter to be crushed can be expressed by the above expression. Of the matter to be crushed which is the object of the present invention, metallic iron metal is not readily crushed while slag is readily crushed. Now, metallic iron of which the grain size is 3.35 mm or larger has low slag percentage, and accordingly does not need to be crushed any finer that this. Accordingly, it is recommended in the present invention that the crushing index is controlled to be 800 to 2000. If the crushing index is below 800 or exceeds 2000, separation of slag from the metallic iron may be insufficient. The crushing index more preferably is 900 or higher and more preferably is 1500 or lower.

### [Screening Process a and Metallic Iron Collecting Process a]

In a screening process a, the crushed matter obtained in the above-described crushing process is screened using a sifter a (103 in FIG. 3-1) of which the sieve opening is 3 to 5 mm, and in the metallic iron collecting process, that remaining above the sifter a in the screening process a is collected as metallic iron (104 in FIG. 3-1). That is to say, it has been found by study made by the Present Inventors that performs screening using a sifter a of which the sieve opening is 3 to 5 mm results in high-grade metallic iron remains above the sifter a, while slag, reduced pellets, hearth protective material and so forth passes through the sifter a. If the sieve opening of the sifter a is smaller than 3 mm, slag, reduced pellets, hearth protective material and so forth also remain on the sifter a besides the high-grade metallic iron, so the iron grade of the collected product is poorer. Accordingly, the sieve opening of the sifter a is 3 mm or greater. However, in a case where the sieve opening of the sifter a exceeds 5 mm, the high-grade metallic iron also passes through the sifter a, so collecting efficiency of the metallic iron is poorer. Accordingly, the sieve opening of the sifter a is 5 mm or smaller.

The sifter a may be provided to the crusher used in the crushing process described above, or may be provided separately from the sifter provided to the above crusher. Also, a crusher not having a sifter may be used, and the sifter a may be provided separately.

The method for producing metallic iron according to the present invention may further include: a process of sorting using a magnetic separator, from undersieve a obtained by screening using the sifter a to obtain a magnetically attractable substance a (hereinafter may also be referred to as magnetic selecting/separating process a), a process of pulverizing using a pulverizer which applies friction force and/or impact force to the obtained magnetically attractable substance a (hereinafter may also be referred to as pulverizing process a), and a process of sorting the obtained pulverized matter that has been obtained, by a magnetic separator, and collecting magnetically attractable substance as metallic iron (hereinafter may also be referred to as metallic iron collecting process b). Description will be made below with reference to FIG. 3-3.

FIG. 3-3 is a process diagram for describing another metallic iron producing method according to the present invention. Parts in FIG. 3-3 which are the same as those in FIG. 3-1 are denoted with the same reference numerals to avoid redundant description. In FIG. 3-3, 105 denotes a sifter c with a sieve opening size of 15 to 20 mm, 106 a sifter b with a sieve opening size of 2 to 8 mm, 107a through 107f magnetic separators, 108a through 108c pulverizers, and 104a through 104c metallic iron, respectively.

### [Magnetic Selecting/Separating Process a]

The undersieve a obtained by screening using the sifter a (i.e., that which has passed through the sifter a) is primarily crushed slag, reduced pellets, hearth protecting material, and so forth, as described above, but also includes high-grade metallic iron. Accordingly, the undersieve a is preferably subjected to sorting by the magnetic separator (107a in FIG. 3-3), to collect the magnetically attractable substance a, separate into metallic iron and other matter in a later-described pulverizing process a, and collect the metallic iron in a later-described metallic iron collecting process b. The magnetic separator used in the magnetic selecting/separating process a is not restricted in particular, so a known magnetic separator may be used.

### [Pulverizing Process a]

The magnetically attractable substance a obtained by selection in the above-described magnetic selecting/separating process a is pulverized using the pulverizer (108a in FIG. 3-3) which applies friction force and/or impact force, in the pulverizing process a. A ball crusher or rod crusher, for example, may be used as the pulverizer.

At the time of pulverizing the magnetically attractable substance a, the mass of the magnetically attractable substance a to be supplied to the ball crusher or rod crusher is preferably 5 to 25% the mass of the balls within the ball crusher or the rods within the rod crusher. The pulverizing efficiency can be improved by setting the percentage by mass of the magnetically attractable substance a as to the balls or rods to be 5% or more. This percentage is more preferably 10% or more. However, if the percentage by mass of the magnetically attractable substance a as to the balls or rods is too high, the percentage of particles where metallic iron and slag are not separated increases. Accordingly, this percentage is preferably 25% or less, and more preferably is 20% or less.

The time of pulverizing the magnetically attractable substance a (pulverizing time) in the pulverizer (108a in FIG. 3-3) is preferably 10 minutes or less, and more preferably is 2 to 7 minutes. If the pulverizing time is too long, the pulverized slag comes to bond to the metallic iron, and the slag percentage in the metallic iron rises. Accordingly, the pulverizing time is preferably 10 minutes or less, and more preferably 7 minutes or less, and even more preferably 6 minutes or less. On the other hand, setting the pulverizing time to be 2 minutes or longer enables the slag to be pulverized and separability from the metallic iron to be increased. The pulverizing time is more preferably 3 minutes or longer.

After pulverizing in the pulverizer (108a in FIG. 3-3), sorting may be performed at the magnetic separator (107d in FIG. 3-3) to collect the magnetically attractable substance as metallic iron (104a in FIG. 3-3).

### [Other]

The method of producing metallic iron according to the third invention may further include, as a first modification, a process to perform screening of the reduced produce using a sifter c having a sieve opening of 15 to 20 mm (hereinafter, also referred to as screening process c), before crushing the reduced product discharged from the movable hearth type heating furnace, and the obtained oversieve c may be crushed using an impact crusher (crushing process).

The method of producing metallic iron according to the present invention may further include, as a second modification, the process to perform screening of the reduced produce using a sifter c having a sieve opening of 15 to 20 mm (hereinafter, also referred to as screening process c), and a process to perform screening of the obtained undersieve c using a sifter b having a sieve opening of 2 to 8 mm (screening process b), before crushing the reduced product discharged from the movable hearth type heating furnace, and the oversieve b which is undersieve c may be crushed using an impact crusher (crushing process).

The method of producing metallic iron according to the present invention may further include, as a third modification, the process to sort by a magnetic separator the obtained oversieve b which is undersieve c obtained in the second modification, and to crush the magnetically attractable substance using an impact crusher. That is to say, this may further include the process to perform screening of the reduced produce using a sifter c having a sieve opening of 15 to 20 mm (screening process c), the process to perform screening of the obtained undersieve c using a sifter b having a sieve opening of 2 to 8 mm (screening process b), before crushing the reduced product discharged from the movable hearth type heating furnace, and a process to sort the obtained oversieve b which is undersieve c using a magnetic separator and crushing the magnetically attractable substance using an impact crusher (crushing process).

The method of producing metallic iron according to the present invention may further include, as a fourth modification, the process to perform screening of the reduced produce using a sifter b having a sieve opening of 2 to 8 mm (screening process b), before crushing the reduced product discharged from the movable hearth type heating furnace, and a process to crush the oversieve b using an impact crusher (crushing process).

The method of producing metallic iron according to the present invention may further include, as a fifth modification, a process to sort the oversieve b obtained in the fourth modification using a magnetic separator, and crush the magnetically attractable substance using an impact crusher. That is to say, there may further be included a process before the crushing of the reduced product discharged from the movable hearth type heating furnace, where the reduced product is screened using a sifter b having a sieve opening of 2 to 8 mm before crushing the reduced product (screening process b), with the oversieve b obtained being sorted using a magnetic separator and the magnetically attractable substance crushed using an impact crusher (crushing process).

While the first modification subjects, of the reduced product, coarse particulate matter remaining on the sifter c having a sieve opening of 15 to 20 mm to crushing, the second modification differs from this with regard to the point that, of the reduced product, medium particulate matter which passes through the sifter c but does not pass through the sifter b having a sieve opening of 2 to 8 mm is subjected to a crushing process. On the other hand, the fourth modification subjects, of the reduced product, coarse-to-medium particulate matter which does not pass through the sifter b having a sieve opening of 2 to 8 mm, to a crushing process. Also, in comparison with the second modification, the third modification sorts the oversieve b under the sifter c using a magnetic separator, and crushes the magnetically attractable substance using an impact crusher. Also, in comparison with the fourth modification, the fifth modification sorts the oversieve b using a magnetic separator, and crushes the magnetically attractable substance using an impact crusher.

### [First Through Fifth Modifications]

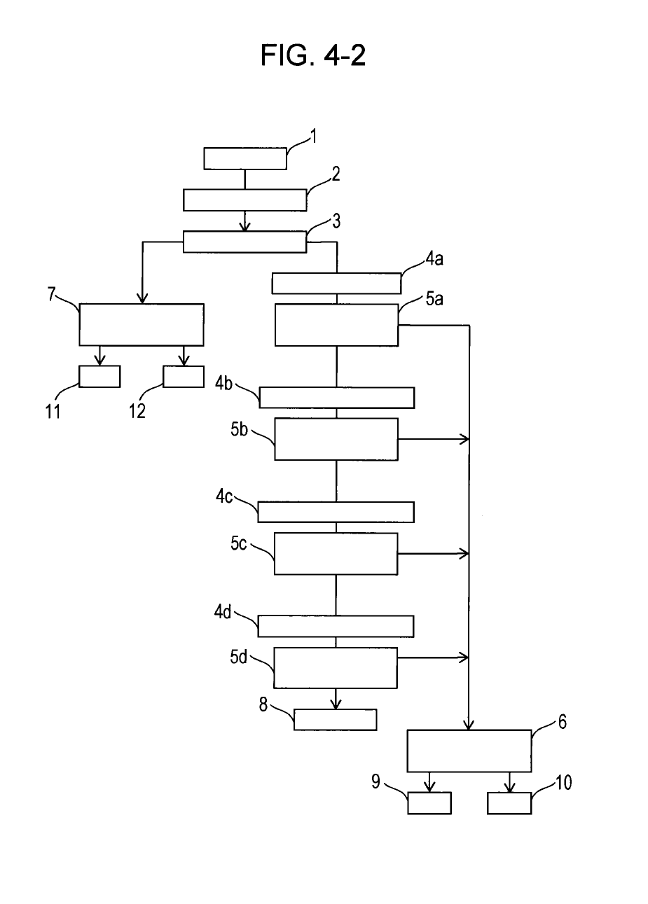

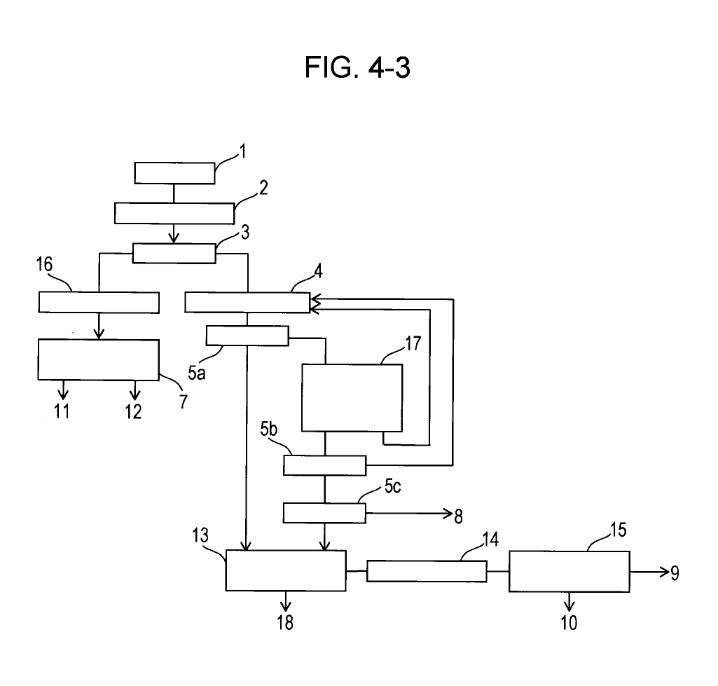

The first through third modifications will be described with reference to FIG. 3-3. Also, the fourth and fifth modifications will be described with reference to FIG. 3-4. FIG. 3-4 is a process diagram for describing another metallic iron producing method according to the present invention. Parts in FIG. 3-4 which are the same as those in FIG. 3-1 and FIG. 3-3 are denoted with the same reference numerals to avoid redundant description. In FIG. 3-4, 107g denotes a magnetic separator.

### [First Modification]

When heating the agglomerate in a movable hearth type heating furnace, there are cases where the metallic iron melts on the hearth and joins with nearby metallic iron and forms large clumps. In the same way, there are cases where slag melts on the hearth and joins with other nearby slag and forms large clumps. Slag forming large clumps is crushed during discharge from the heating furnace and subsequent handling, and thus is broken down into finer pieces. However, the metallic iron forming large clumps is not broken down into finer pieces, and remains in large clumps. Supplying the large clumps of metallic iron to the crushing process places a load on the crusher, leading to marked wear on the crusher.

Accordingly in the first modification, as illustrated in FIG. 3-3, the reduced product which is the discharged matter from the movable hearth type heating furnace 101 is screened using the sifter c having a sieve opening of 15 to 20 mm (105 in FIG. 3-3). The coarse matter (oversieve c) remaining on the sifter c is supplied to the crusher 102, and crushed by impact at the crusher 102.

### [Second Modification]

When the agglomerate is heated in a heating furnace at 1300° C. or hotter, hearth covering material such as carbonaceous particles, heat-resistant particles, and so forth may be laid on the hearth of the heating furnace for protection. The suitable granularity of the hearth covering material is said to be 0.5 to 3 mm, meaning that the material is small particles. This hearth covering material is discharged from the heating furnace along with the reduced matter after having heated the agglomerate. Accordingly, the medium particles which have passed through the sifter c in the above-described screening process c (undersieve c) include the hearth covering material.

Accordingly, in the second modification, as illustrated in FIG. 3-3, the reduced product discharged from the movable hearth type heating furnace 101 is screened using the sifter c having a sieve opening of 15 to 20 mm (105 in FIG. 3-3), and the medium particulate material which has passed through the sifter c (undersieve c) is screened using the sifter b having a sieve opening of 2 to 8 mm (106 in FIG. 3-3). The reason why the sieve opening for the sifter b used in the screening process b, is 2 to 8 mm, is so as to be slightly larger than the grain diameter of the hearth covering material, to remove the hearth covering material. The fine matter which has passed through the sifter b (undersieve b) is removed, and the medium particulate material remaining on the sifter b may be supplied to the crusher 102 via an unshown path, and crushed.

### [Third Modification]

In the third modification, the medium particulate matter collected as undersieve c on the sifter b may be sorted at the magnetic separator (107b in FIG. 3-3), thereafter supplied to the crusher 102 via an unshown path, and the magnetically attractable substance crushed by application of impact, as described above. The collecting efficiency of metallic iron obtained by crushing the magnetically attractable substance can be improved by sorting the magnetically non-attractable substance by a magnetic separator beforehand.

Also, the medium particulate matter collected as undersieve c on the sifter b may be sorted at the magnetic separator (107b in FIG. 3-3), the magnetically attractable substance thereafter supplied to the pulverizer (108b in FIG. 3-3), pulverized, and select the magnetically non-attractable substance by the magnetic separator (107e in FIG. 3-3) beforehand, thereby improving the collecting efficiency of metallic iron (104b in FIG. 3-3) obtained by pulverizing the magnetically attractable substance.

### [Fourth Modification]

In the fourth modification, as illustrated in FIG. 3-4, the reduced product which is discharged matter from the movable hearth type heating furnace 101 is screened using the sifter b having a sieve opening of 2 to 8 mm (106 in FIG. 3-4), the coarse and medium particular matter remaining on the sifter b is supplied to the crusher 102 via an unshown path, and crushed by application of impact. That is to say, in the fourth modification the sifter c having a sieve opening of 15 to 20 mm (105 in FIG. 3-3) is not used, so coarse particles large enough to remain on the sifter c are also included in the oversieve b. On the other hand, the fine particles which have passed through the sifter b (undersieve b) are removed in the fourth modification.

### [Fifth Modification]

In the fifth modification, the coarse and medium particulate matter collected as the oversieve b may be sorted in the magnetic separator (107g in FIG. 3-4), the obtained magnetically attractable substance supplied to the crusher (102 in FIG. 3-4), and crushed by application of impact. Sorting the magnetically non-attractable substance by a magnetic separator beforehand enables the collecting efficiency of the metallic iron obtained by crushing the magnetically attractable substance to be raised.

The method for producing metallic iron according to the present invention may further include a process of sorting by a magnetic separator the undersieve b obtained by screening using the sifter b and obtaining a magnetically attractable substance b (hereinafter, also referred to as magnetic selecting/separating process b), a process of pulverizing the obtained magnetically attractable substance b using a pulverizer which applies friction force and/or impact force (hereinafter, also referred to as pulverizing process b), and a process of further sorting the obtained pulverized matter using a magnetic separator and collecting the magnetically attractable substance as metallic iron (hereinafter, also referred to as metallic iron collecting process c). Description will be made below with reference to FIG. 3-3.

While the fine particulate matter which has passed through the sifter b (undersieve b) primarily is hearth covering material, there are also fine metallic iron particles intermingled therein. Slag is adhered to these fine metallic iron particles that are intermingled, and the slag inclusion percentage of the fine metallic iron particles was found to be 30%, which is high. Accordingly, the fine particulate matter which has passed through the sifter b (undersieve b) may be sorted at a magnetic separator (107c in FIG. 3-3) and the sorted magnetically attractable substance b be pulverized at a pulverizer (108c in FIG. 3-3) so as to be separated into metallic iron and slag, and thereafter sorted at a magnetic separator (107f in FIG. 3-3) and the sorted magnetically attractable substance be collected as metallic iron (104c in FIG. 3-3). That is to say, in order to separate and remove the slag from the magnetically attractable substance b obtained by sorting the undersieve b by a magnetic separator, a pulverizer which can apply at least one of friction force and impact force is suitably used. A representative example of such a pulverizer is a ball crusher. The pulverized matter pulverized at the pulverizer may be separated by magnet.

The magnetic separator used in the magnetic selecting/separating process b is not restricted in particular, and a known magnetic separator may be used, the same as in the above-described magnetic selecting/separating process a.

The pulverizer used in the above-described pulverizing process a may be used for the pulverizer in the pulverizing process b.

The conditions at the time of pulverizing the magnetically attractable substance b are preferably the same as in the pulverizing process a; the mass of the magnetically attractable substance b to be supplied to the ball crusher or rod crusher is preferably 5 to 25% the mass of the balls within the ball crusher or the rods within the rod crusher.

The time of pulverizing the magnetically attractable substance b in the pulverizer (pulverizing time) is preferably 10 minutes or less (not including 0 minutes), more preferably 2 to 7 minutes, and even more preferably 3 to 6 minutes, the same as in the pulverizing process a.

When pulverizing the magnetically attractable substance b, the magnetically attractable substance b and the magnetically attractable substance a may be mixed before pulverizing. The reason is that both the magnetically attractable substance b and the magnetically attractable substance a are fine particles with slag adhered, so the same pulverizer can be used.

The pulverizer used in the pulverizing processes a and b preferably has a mechanism capable of blowing a gas to the interior thereof at a linear speed of 20 m/second or faster. Excessive pulverizing using a ball crusher or rod crusher results in the separated metallic iron and slag re-aggregating, and becoming a magnetically attractable substance where slag is fixed to the metallic iron. Blowing so that the linear speed of the gas is 20 m/second or faster into the machine can prevent re-fixing of slag to the metallic iron. The linear speed of the gas is more preferably 30 m/second. The upper limit of the linear speed of the gas is, for example, 50 m/seconds or slower, although not restricted in particular.

Note that the present invention is similar to the known FASTMET method and ITmk3 method in with regard to the point that an agglomerate formed of a mixture containing an iron oxide-containing material and a carbonaceous reductant is heated at high temperature to produce metallic iron (reduced iron). However, this differs with regard to the point that a reduced product including metallic iron and slag, which is discharged from a movable hearth type heating furnace, is crushed by applying impact and sorted using a separator to collect the metallic iron, thereby reducing the amount of slag introduced to the refining process which is the next process.

According to the third invention described above, the reduced product containing metallic iron and slag, which is discharged matter from the movable hearth type heating furnace, is crushed by applying impact, so the metallic iron and slag can be efficiently separated. Also, the reduced product is classified using a sifter before crushing the reduced product, so the reduced product can be efficiently crushed. Also, the conditions of applying impact to the reduced product for crushing are suitably controlled, so the crushing efficiency of the reduced product can be improved. According to the present invention, metallic iron can be efficiently collected by screening the crushed matter using a sifter with screen openings of 3 to 5 mm.

Thus, the third invention has been described.

Even after having completed the above-described first invention, the above-described second invention, and the above-described third invention, the Present Inventors previously have proposed a technology where separability is high when separating into metallic iron and slag a metallic iron sintered body obtained by heating an agglomerate including an iron oxide-containing material and a carbon material in a heating furnace to reduce the iron oxide in the agglomerate (Japanese Patent Application No. 2012-99165). A feature of this technology is that the metallic iron-containing sintered body is formed as a structure where a mixture containing granular metallic iron and slag is enveloped within an outer shell containing metallic iron and slag, in a state where the temperature is 1000° C. or lower.

Even after having proposed the technology in the above Japanese Patent Application No. 2012-99165, the Present Inventors diligently studied increasing the percentage of slag removed from the metallic iron-containing sintered body, to produce metallic iron containing little slag. As a result, it was found that metallic iron containing little slag can be produced by performing processing combining pulverizing and classifying using a sieve, and thus a fourth invention was completed.

A method for producing metallic iron according to the fourth invention will be described with reference to FIG. 4-1. FIG. 4-1 is a flowchart for describing a metallic iron producing method according to the present invention.

The method for producing metallic iron according to the present invention includes a process of producing an agglomerate formed of a mixture of raw materials including an iron oxide-containing material and a carbon material (hereinafter, also referred to as agglomerate forming process), a Process 1 of heating the obtained agglomerate in a heating furnace to reduce the iron oxide in the agglomerate to produce a metallic iron-containing sintered body where a mixture containing granular metallic iron and slag is enveloped within an outer shell containing metallic iron and slag, in a state where the surface temperature is 1000° C. or lower (hereinafter, also referred to as a heating process), a Process 2 to pulverize the obtained metallic iron-containing sintered body (hereinafter, also referred to as a first pulverizing process), a Process 3 to screen the pulverized matter obtained in the first pulverizing process using a sifter a (hereinafter, also referred to as a screening process), a Process 4 of further pulverizing coarse particles remaining on the sifter a (hereinafter, also referred to as a second pulverizing process), and a Process 5 of collecting the metallic iron by removing slag from the pulverized matter obtained in the second pulverizing process (hereinafter, also referred to as a metallic iron collecting process).

First, the metallic iron-containing sintered body will be described. The structure of the metallic iron-containing sintered body itself is the same as the structure of the metallic iron-containing sintered body disclosed in the Japanese Patent Application No. 2012-99165 proposed earlier by the Present Inventors. That is to say, the outer shell making up the metallic iron-containing sintered body includes metallic iron and slag. Including slag in the outer shell means being easier to pulverize, since the strength is smaller than an outer shell made up of metallic iron alone. On the other hand, enveloped in side the outer shell is the mixture including the particulate metallic iron and slag. The mixture to be enveloped in the outer shell (hereinafter, also referred to as inclusion) is a mixture including particulate metallic iron and slag, and accordingly the inclusion also is easily pulverized. Accordingly, the metallic iron can be efficiently collected by separating the outer shell from the inclusion and removing the slag from the outer shell. Also, the particulate metallic iron can be efficiently collected by removing the slag from the inclusion.

The surface temperature of the metallic iron-containing sintered body is 1000° C. or lower. To say that the surface temperature is 1000° C. or lower means that the agglomerate has been heated in the heating furnace and thereafter cooled. That is to say, the metallic iron-containing sintered body is obtained by heating the agglomerate including the iron oxide-containing material and carbon material in the heating furnace, and the heating furnace is heated to around 1000 to 1500° C., as described later. Accordingly, a surface temperature of 1000° C. or lower means a state of having been cooled after having been heated.

The metallic iron-containing sintered body needs the entirety to be covered with the outer shell to keep the internal mixture (inclusion) enveloped within the outer shell from leaking out. It is sufficient that the strength of the metallic iron-containing sintered body be within a range where the shape can be maintained when discharging from the heating furnace by a discharger or the like. Accordingly, it is sufficient for the cross-sectional area percentage of the outer shell portion to be around 50% by area or more in a cross-section taken to pass through the center of the metallic iron-containing sintered body.

The outer shell is preferably formed in a network form (webbing) of metallic iron, with many gaps existing as in a porous matter.

It is recommended that the outer shell have a network-like composition made up of metallic particles connected to each other, and slag existing at least partially in the gaps in the composition. Slag existing at least partially in the gaps of the network-like composition means that the strength of the outer shell is weaker than if made up of metallic iron alone, and accordingly is easier to pulverize.

Next, the method for producing metallic iron according to the present invention will be described.

### [Agglomerate Forming Process]

In an agglomerate forming process, an agglomerate is formed of a raw material mixture including an iron oxide-containing material and a carbon material, thus producing an agglomerate.

Specific examples of the above iron oxide-containing material which can be used include iron ore, iron sand, ironmaking dust, non-ferrous smelting residue, ironmaking waste, and so forth.

Low-grade iron oxide-containing material which conventionally could not be normally used can be used as the iron oxide-containing material in the present invention.

That is to say, iron ore contains gangue. Gangue is a component making up iron ore mined from a mine (crude ore) other than minerals including useful metal, and normally is made up of oxides such as SiO₂ and Al₂O₃. The amount of gangue included in the iron ore differs depending on the region of production where the iron ore is mined. Iron ore containing little gangue is called high-grade iron ore, and iron ore containing a large amount of gangue is called low-grade iron ore.

Using low-grade iron ore to produce metallic iron tends to result in the following problems. That is to say, using low-grade iron ore according to the above-described method (1) results in increased amount of slag component contained in the agglomerate due to the gangue contained in the iron ore combined with the ash component contained in the carbon material, so the obtained reduced iron includes much slag, and the grade of the iron is low. Using low-grade iron ore according to the above-described method (2) results in an increased amount of slag generated when melted, and the molten slag covers unmolten reduced iron, impeding transfer of heat to the reduced iron, so the reduced iron and slag may not be able to be sufficiently separated. Also, the reduced iron obtained by the above-described methods (1) and (2) can be used as raw material in electric furnace refining, for example, but it is a prerequisite that the amount of gangue introduced into the electric furnace at once is little. Great amounts of gangue result in great amounts of slag being generated when refining in the electric furnace, and the amount of energy necessary for refining increases.

Thus, high-grade iron ore containing little gangue is recommended for producing metallic iron. However, the global production amount of steel is rising even though the supply sources of high-grade iron ore are limited, so there is concern that there will not be enough high-grade iron ore being supplied.

On the other hand, according to the present invention, the structure of the metallic iron-containing sintered body obtained by heating the agglomerate containing the iron oxide-containing material and carbon material is made up of the outer shell and inclusion as described above, and combines pulverizing and classification using a sifter, which will be described later. Accordingly, slag can be efficiently removed from the metallic iron-containing sintered body even if using low-grade iron oxide-containing material.

The aforementioned low-grade iron oxide-containing material means that where the percentage of the total mass of SiO₂ and Al₂O₃ as to the total iron mass (T.Fe) [slag percentage=(SiO₂+Al₂O₃)/T.Fe×100] is 5% or more. SiO₂ and Al₂O₃ are, of the various types of gangue contained in the iron oxide-containing material (e.g., iron ore), matter regarding which the content percentage is relatively high, and accordingly these are used as representative matter of gangue in the Present Specification. The percentage of the total mass of SiO₂ and Al₂O₃ as to the total iron mass is defined as the gangue percentage, with that having slag percentage of 5% or more being called low-grade iron oxide-containing material. The gangue percentage may be 11% or more, or may be 12% or more.

Examples of the carbon material which can be used include coal, coke, and so forth. It is sufficient for the carbon material to include enough fixed carbon to reduce the iron oxide contained in the iron oxide-containing material. Specifically, it is sufficient for the amount of carbon to be 0 to 5% by mass in excess as to the amount of fixed carbon which can reduce the iron oxide contained in the iron oxide-containing material.

The mixture containing the iron oxide-containing material and the iron oxide-containing material and the carbon material preferably further has a melting point controlling agent added thereto.

The melting point controlling agent means matter which affects the melting point of components other than the iron oxide included in the agglomerate (particularly gangue), and excludes matter which affects the melting point of metallic iron. That is to say, by adding the melting point controlling agent to the mixture of materials, the melting temperature of components other than the iron oxide included in the agglomerate (particularly gangue) can be affected, and the melting temperature thereof can be reduced, for example. This promotes melting of the gangue, thereby forming molten slag. Part of the iron oxide is dissolved in the molten slag at this time, and is reduced and becomes metallic iron in the molten slag. The metallic iron generated in the molten slag comes into contact with metallic iron reduced in its solid state, and is aggregated as solid reduced iron.

A melting point controlling agent including at least a CaO source is preferably used as the melting point controlling agent.

At least one selected from a group including CaO (quicklime), Ca(OH)₂ (slaked lime), CaCO₃ (limestone), and CaMg(CO₃)₂ (dolomite), for example, is preferably added as the CaO source.

The aforementioned CaO source alone may be used as the melting point controlling agent, or an MgO source, Al₂O₃ source, SiO₂ source, or the like, may be used in addition to the CaO source. MgO, Al₂O₃, and SiO₂ are also matters which affect the melting point of components other than iron (particularly gangue) contained in the agglomerate, in the same way as the CaO described above.

At least one selected from a group including MgO powder, Mg-containing matter extracted from natural ore or seawater or the like, and MgCO₃, for example, is preferably added as the MgO source. Al₂O₃ powder, bauxite, boehmite, gibbsite, diaspore, and so forth, for example, is preferably added as the Al₂O₃ source. Examples which can be used as the SiO₂ include SiO₂ powder, quartz sand, and so forth.

The agglomerate may further include a binder or the like, as a component other than the iron oxide-containing material, carbon material, and melting point controlling agent.

Examples which can be used as the binder include polysaccharides or the like (e.g., starches such as cornstarch, flour, and so forth).

The iron oxide-containing material, carbon material, and melting point controlling agent are preferably crushed before mixing. An average grain size of 10 to 60 μm is recommended for the iron oxide-containing material, average grain size of 10 to 60 μm for the carbon material, and average grain size of 5 to 90 μm for the melting point controlling agent, for example.

The means by which the iron oxide-containing material and so forth are crushed is not restricted in particular, and known means may be used. For example, a vibrational crusher, roll crusher, ball crusher, or the like, may be used.

A rotating container mixer or fixed container mixer, for example, may be used as a mixer to mix the mixture. Examples of the rotating container mixer which can be used include a rotating cylinder mixer, a double cone mixer, a V blender, or the like. Examples of the fixed container mixer which can be used include a mixer having paddles (e.g., spades) in a mixing vat.

Examples of a compactor to form an agglomerate of the mixture include a tumbling disc granulator, cylinder type granulator (drum type granulator), twin-roll briquetter, or the like.

The shape of the agglomerate is not restricted in particular, and may be aggregates, grains, briquettes, pellets, rods, or the like, for example, and preferably is briquettes or pellets.

### [Heating Process]

In the heating process, the agglomerate obtained in the agglomerate forming process described above is introduced to a heating furnace, and heated to reduce the iron oxide in the agglomerate, thereby producing a metallic iron-containing sintered body which has a mixture including particulate metallic iron and slag within an outer shell including metallic iron and slag, of which the surface temperature is 1000° C. or lower.

The Present Inventors took note of the structure of the metallic iron-containing sintered body, and upon having studied each of the outer shell portion making up the metallic iron-containing sintered body, and the mixture (inclusion) enveloped within the outer shell (hereinafter also referred to as center portion), with regard to improving separability when separating into (granular) metallic iron and slag, it was found that the forms of the outer shell portion and the center portion change as follows.

When introduced into the heating furnace, the agglomerate is heated by external radiant heat, the following reaction occurs, and metallic iron is generated.

Fe₂O₃+2CO→2Fe+2CO₂

### (Outer Shell Portion)

At the initial stage of heating, heating by radiant heat is insufficient, so the surface temperature of the outer shell portion is low. At this time, at temperatures lower than 1250° C. for example, there is a state where fine metallic iron and slag in a half-molten state are intermingled (hereinafter, also referred to composition A). Accordingly, the separability of metallic iron and slag is extremely poor. This form is observed in cases where heating time is insufficient, and at the lower portion of the agglomerate (near the hearth) where the amount of heat supplied is small.

As the heating of the agglomerate advances, and the surface temperature of the outer shell portion becomes somewhat high (e.g., 1250° C. or higher but lower than 1330° C.), the metallic iron is sintered and becomes like webbing, the molten slag grows somewhat large, and there is a state where molten slag is dispersed in the webbing-like form of the metallic iron (hereinafter, also referred to composition B). The growth of the molten slag is not sufficient in this form, so the separability between metallic iron and slag cannot be said to be good. This form is particularly observed on the upper portion of the outer shell portion of the agglomerate.

As the heating of the agglomerate further advances, and the surface temperature of the outer shell portion becomes even higher (e.g., 1330° C. or higher), the metallic iron is connected in a plate form, the molten slag grows large, and there is a state where the metallic iron is scattered with molten slag (hereinafter, also referred to composition C). In this state, the molten slag is sufficiently grown, so the separability of metallic iron and slag is good. This form is particularly observed on the upper portion of the outer shell portion of the agglomerate.

The composition A and composition B are observed at the overall external shell of the agglomerate at the early stages of heating, but he composition C is only observed at the upper portion of the outer shell portion, where temperature rising is high and the consumption of carbon material is great. That is to say, even if the temperature within the furnace is raised to 1300° C. or higher for example, the temperature distribution of the agglomerate is not uniform, and temperature difference occurs between the top and bottom of the agglomerate. Accordingly, while the top portion of the outer shell often becomes composition C, the lower portions of the outer shell often only become composition A or composition B.

### (Center Portion)

The center portion is heated by heat transfer from the outer shell portion, so slag melts after the metallic iron has generated the webbing form. Hardly any FeO at all exists within this molten slag. Thereafter, when the metallic iron is carburized by the carbon, the metallic iron becomes granular (hereinafter, also referred to composition D).

On the other hand, if the temperature is raised in a state where there is carbon and FeO remaining on the inner portion of the agglomerate, the FeO and carbon in the molten slag react, and fine granular metallic iron is generated in the molten slag (hereinafter, also referred to composition E). If FeO is in the vicinity when slag starts to melt, the FeO dissolves into the slag and lowers the melting point of the slag, thereby increasing the amount of slag. If carbon is in the vicinity in this state, the melting reduction according to the following Expression occurs, generating extremely fine metallic iron. This is the state of composition E. This composition E is observed on the interior of the agglomerate where temperature has risen in a state in which generation of solid metallic iron was slow.

2FeO (l)+C→2Fe (s)+CO₂ (g)

If the heating temperature is set high so that the outer shell portion assumes the composition C form, and the agglomerate is suddenly heated, so as to improve the separability of metallic iron and slag, the center portion is also rapidly heated, the composition form becomes the composition E. Accordingly, the molten slag which has grown to a large size can be removed well from the outer shell portion which has become the composition C, but the center portion has become the composition E has extremely fine granular metallic iron, so separability from the slag is poor.

In order to make the center portion to become the composition D in order to improve separability between metallic iron and slag, it is necessary that the gangue component is molten but the metallic iron is not molten. The melting state of the metallic iron depends on the starting temperature of carburization of the metallic iron and the amount of carburization. If the amount of carbon included is excessive, carburization of the metallic iron advances even if the slag is not sufficiently molten, so the metallic iron melts can forms fine spherical granules. Accordingly, it is recommended that the melting temperature of the gangue component be adjusted to be 1300° C. or lower.

In the present invention, the temperature at a position approximately 20 mm above the agglomerate introduced into the heating furnace is evaluated as being equivalent to the temperature within the heating furnace.

A known furnace may be used for the heating furnace, and a movable hearth type heating furnace may be used, for example. The movable hearth type heating furnace is a heating furnace where the hearth moves through the furnace like a belt conveyer, a specific example of which is a rotary hearth furnace. The aforementioned rotary hearth furnace is a furnace where the hearth is designed so as to have a circular (doughnut-shaped) external appearance, such that the starting point and ending point of the hearth is at the same position. An agglomerate supplied on the hearth is reduced by heating while traveling one round through the furnace, thereby generating (granular) metallic iron. Accordingly, a rotary hearth furnace has introducing means at farthest upstream in the rotational direction to supply the agglomerate to the furnace, and discharge means farthest downstream in the rotational direction (which is actually immediately upstream from the introducing side, due to the rotary structure).

### [First Pulverizing Process]

The metallic iron-containing sintered body obtained in the above heating process is pulverized in the first pulverizing process, so as to separate into the outer shell portion of the metallic iron-containing sintered body and the inclusion portion. That is to say, pulverization needs to be performed in the first pulverizing process such that the outer shell portion and the inclusion portion are separated without excessive force being applied to the outer shell portion of the metallic iron-containing sintered body and that the outer wheel portion is not pulverized into fine particles.

A jaw crusher, roll press, hammer crusher, or the like may be used in the method for pulverizing the metallic iron-containing sintered body in the above first pulverizing process.

In a case of using a roll press, pulverization is preferably performed with the gap between the rolls being set at 60 to 90% of the minor axis of the agglomerate. The term minor axis of the agglomerate means an average value calculated by measuring the grain size of ten agglomerates. Note that when obtaining the average value, agglomerates in a cracked state and agglomerates deformed into chip shapes may be eliminated, and the average value obtained based on the grain size of agglomerates having a sound form (e.g., spherical).

If the gap between the rolls exceeds 90% of the minor axis of the agglomerate, the metallic iron-containing sintered body is hardly pulverized at all, and accordingly separating into the outer shell portion and inclusion portion becomes difficult. Accordingly, the gap between the rolls is preferably 90% of the minor axis of the agglomerate or less, more preferably 85% or less, and even more preferably 80% or less. However, if the gap between the rolls is 60% of the minor axis of the agglomerate or smaller, excessive force is applied to the outer shell portion, the outer shell portion is also pulverized, and separation from the inclusion portion becomes difficult. Accordingly, the gap between the rolls is preferably 60% of the minor axis of the agglomerate or more, more preferably 65% or more, and even more preferably 70% or more.

The minor axis of the agglomerate may be based on a value obtained by measuring the minor axis of at least ten agglomerates, and averaging these.

In a case of using a hammer crusher, applying as great an impact force as possible is preferably, but there is no need to apply impact force such as that which would pulverize iron, and it is sufficient to apply impact force to crack the slag alone. Also, in a case of using a hammer crusher, pulverization is preferably performed in a state with no screen bar present.

### [Screening Process]

In the screening process, the pulverized matter obtained in the first pulverizing process is screened using the sifter a, and separated into the outer shell portion and inclusion portion. That is to say, since the metallic iron-containing sintered body is pulverized in the first pulverizing process and separated into the other shell portion and inclusion portion, this is separated into the other shell portion and inclusion portion in this screening process following the first pulverizing process, using the sifter a. In the separation into the other shell portion and inclusion portion, the inclusion portion is normally relatively smaller than the outer shell portion, so the sieve opening of the sifter a may be adjusted so as to enable separation into the other shell portion and inclusion portion.

The sifter a may be a sifter having a sieve opening smaller than 1 mm, but this easily becomes clogged, so the sieve opening is preferably 1 mm or larger. The upper limit of the sieve opening of the sifter a preferably is, for example, 8 mm or smaller, more preferably 5 mm or smaller, and even preferably 3.5 mm or smaller.

The coarse grains remaining above the sifter a are further pulverized in a later-described second pulverizing process.

On the other hand, the fine particles which have passed through the sifter a may be sorted into magnetically attractable substance and magnetically non-attractable substance at a magnetic sorter, and the magnetically attractable substance collected as metallic iron.

The fine particles which have passed through the sifter a are preferably pulverized before sorting at the magnetic separator. Magnetically selecting after pulverizing enables the T.Fe included in the magnetically attractable substance to be further raised.

Also note that the magnetically non-attractable substance sorted out at the magnetic separator may be further sorted into magnetically attractable substance and magnetically non-attractable substance at the magnetic separator, with the magnetically attractable substance being collected as metallic iron. The process of further sorting the magnetically attractable substance and collecting metallic iron may be repeated multiple times as needed.

### [Second Pulverizing Process]

In the second pulverizing process, the coarse particles remaining on the sifter a in the screening process are further pulverized. The coarse particles remaining on the sifter a primarily are equivalent to the outer shell portion making up the metallic iron-containing sintered body. In the second pulverizing process, the outer shell portion is pulverized to separate into metallic iron and slag. At this time, of the outer shell portion making up the metallic iron-containing sintered body, the portions of composition B and composition C are almost all made up of metallic iron, and accordingly are stretched rather than being pulverized in the second pulverizing process. Accordingly, these can be collected as large stretched clumps of metallic iron in a later-described metallic iron collecting process. On the other hand, of the outer shell portion, the portion which is the composition A has a great amount of slag intermingled therein, and accordingly is pulverized in the second pulverizing process and separated into metallic iron and slag. Accordingly, the slag is more readily removed from the pulverized matter in the later-described metallic iron collecting process, and the metallic iron can be efficiently collected.

A roll press, hammer crusher (hammer crusher), or the like may be used in the method for pulverizing the metallic iron-containing sintered body in the above second pulverizing process. A roll press is particularly preferably used. Using a roll press enables the metallic iron included in the outer shell portion to be stretched out, and accordingly the metallic iron can be collected in large forms. The larger the metallic iron is, the more the separability from slag improves, and so the higher the collecting efficiency of the metallic iron is.

In a case of using a roll press, the gap between the rolls is preferably set to 3 mm or smaller to perform pulverizing. The gap between the rolls spreads depending on the size of the specimen, and accordingly may be set to 0 mm.

In a case of using a hammer crusher in the second pulverizing process, pulverizing may be performed in a state with screen bars present, or screen bars not present. The peripheral speed of the hammer is preferably 30 to 40 m/second. In a case of pulverizing being performed in a state with screen bars present, specimens larger than the screen bar spacing are repeatedly pulverized by the hammers, so the hammers are preferably stopped from operating after an appropriate amount of time. According to the experience of the Present Inventors, it has been found that stopping the hammers within 10 seconds is preferable

### [Metallic Iron Collecting Process]

In the metallic iron collecting process, slag is removed from the pulverized matter obtained in the second pulverizing process, and the metallic iron is collected. That is to say, the pulverized matter obtained in the second pulverizing process is a mixture (pulverized matter) of metallic iron and slag obtained by pulverizing the outer shell portion of the metallic iron-containing sintered body, and the slag is removed from this pulverized matter in the metallic iron collecting process so as to collect the metallic iron.

While the method of removing slag from the pulverized matter is not restricted in particular, examples which can be used include a method using a magnetic separator, and a method using a sifter.

### [Magnetic Separation]

In a case of using a magnetic separator, the pulverized matter obtained in the second pulverizing process may be sorted into magnetically attractable substance and magnetically non-attractable substance by a magnetic separator, with the magnetically attractable substance being collected as metallic iron.

The magnetically non-attractable substance sorted out in the magnetic separator may be further sorted by the magnetic separator and magnetically attractable substance collected as metallic iron. The magnetically non-attractable substance is primarily slag, but magnetically non-attractable substance normally has a certain amount of metallic iron intermingled therein, so collecting metallic iron from the magnetically non-attractable substance is recommended to improve the yield of metallic iron. Note that the process of further sorting the magnetically non-attractable substance by the magnetic separator and collecting metallic iron may be repeated multiple times as needed.

### [Screening]

In a case of screening, the pulverized matter obtained in the second pulverizing process may be screened using a sifter b having a sieve opening the same as the sieve opening of the sifter a or larger than the sieve opening of the sifter a, with the coarse particles remaining on the sifter b being collected as metallic iron.

The sifter b preferably uses a sieve opening of, for example, 1 to 8 mm, more preferably 2 to 5 mm, and most preferably 2 to 3.5 mm. If the sieve opening is smaller than 1 mm, the outer shell portion not sufficiently pulverized (particularly composition A) is included in the first pulverizing process, so the yield of Fe drops. On the other hand, performing screening using a sifter of which the sieve opening is 3.35 mm or larger increases the Fe concentration of the coarse particles remaining on the sifter, so a collected matter with a higher Fe concentration can be obtained. However, if the sieve opening is set to 8 mm or larger, the amount of coarse particles remaining on the sifter is too small, so metallic iron cannot be collected.

Note that the sieve opening described above is a value set for a minor axis of 19 mm for the pellets before reduction, and if the size of pellets is changed, the sieve opening of the sifter may also be changed.

On the other hand, the fine particles which pass through the sifter b may be sorted into magnetically attractable substance and magnetically non-attractable substance by the magnetic separator, and the magnetically attractable substance collected as metallic iron. Note that the process of further sorting the magnetically non-attractable substance by the magnetic separator and collecting metallic iron may be repeated multiple times as needed.

While a known magnetic separator may be used, a dry drum magnetic separator can be preferably used. Using a wet drum magnetic separator may lead to the reduced iron coming into contact with water and being oxidized, so there is concern that the purity of the reduced iron may deteriorate.

As described above, the fourth invention involves heating an agglomerate formed of a mixture of raw materials including an iron oxide-containing material and a carbonaceous reductant to obtain a metallic iron-containing sintered body where a mixture containing granular metallic iron and slag is enveloped within an outer shell containing metallic iron and slag, in a state where the temperature is 1000° C. or lower, and this metallic iron-containing sintered body is processed by a combination of pulverization and classification using a sifter. Accordingly, the percentage of slag removal from the metallic iron-containing sintered body can be raised, and metallic iron with little slag included can be produced.

The fourth invention has thus been described.

The present invention will be further described below by way of Examples. It should be noted however, that the present invention is in no way restricted by the following Examples, and that modifications may be made and carried out without departing from the scope of the essence thereof described before and later, all of which also are encompassed within the technical scope of the present invention.

The Present application claims priority based on Japanese Patent Application No. 2012-173453 filed Aug. 3, 2012, Japanese Patent Application No. 2012-173454 filed Aug. 3, 2012, Japanese Patent Application No. 2013-110283 filed May 24, 2013, and Japanese Patent Application No. 2013-90688 filed Apr. 23, 2013. The aforementioned Japanese Patent Application No. 2012-173453, Japanese Patent Application No. 2012-173454, Japanese Patent Application No. 2013-110283, and Japanese Patent Application No. 2013-90688, are referenced in their entirety with regard to the Present application.

### EXAMPLES

The following Example 1-1 through Example 1-8 are examples of the first invention, the following Example 2-1 through Example 2-7 are examples of the second invention, the following Example 3-1 through Example 3-6 are examples of the third invention, and the following Example 4-1 and Example 4-2 are examples of the fourth invention.

### Example 1-1

In Example 1-1, dry pellets were produced based on the process diagram illustrated in FIG. 1-1. The obtained dry pellets were heated in a rotary hearth furnace, pulverized, magnetically separated, and so forth, so as to produce metallic iron.

Iron ores A and B having different component compositions were prepared, mixtures mixed with coal, limestone, and binder were formed into agglomerates, thereby producing agglomerates (pellets). Table 1-1 below illustrates the component compositions of the iron ores A and B. The component composition of the coal is illustrated in Table 1-2 below. A starch-based binder was used for the binder.

Pellet A was blended at percentages of iron ore A 76.3% by mass, coal 16.9% by mass, limestone 4.1% by mass, alumina 1.1% by mass, and binder 1.5% by mass.

Pellet B was blended at percentages of iron ore B 71.8% by mass, coal 15.8% by mass, limestone 10.9% by mass, and binder 1.5% by mass.

A pan pelletizer 1 was used for producing the pellets, producing pellets of which the average major axis was 19 mm, and the obtained pellets were dried one hour at 180° C. The component compositions of the dried pellets are illustrated in Table 1-3 below.

Next, the dried pellets were placed in a rotary hearth furnace 2, and heated. Immediately before placing the dried pellets in, coal powder having a grain diameter of 3 mm or smaller was placed on the hearth of the rotary hearth furnace to a thickness of 5 mm, as a hearth covering material to protect the hearth. Multiple burners were installed on the side walls of the rotary hearth furnace 2, and the dried pellets placed on the hearth were heated by burning natural gas using these burners. The temperature within the furnace was measured by a measurement end installed at a position 60 cm above the dried pellets, with the temperature being controlled based on the measurement being made at this temperature position.

Next, in a state where the amount of dried pellets placed on the hearth and the heating temperature was stable, 3 to 5 kg of specimen was extracted, subjected to sample reduction down to 1 to 2 kg, screening, pulverizing, and magnetic separation, thereby producing metallic iron. This will be described in detail below.

First, the reduced matter discharged from the rotary hearth furnace 2 contains hearth covering material laid on the hearth, and accordingly was screened using a sifter 3. A sifter having sieve opening of 3.35 mm was used for the sifter 3, and is equivalent to the above-described sifter a.

A hammer crusher 4 was used as a crusher which applies impact from one direction, to crush collected matter collected as the oversieve of the sifter 3. The hammer rotations of the hammer crusher 4 was set to 3600 rpm. A sifter (written as screen in Table 1-4) was attached to the hammer crusher 4 to serve as a separator, and after a predetermined pulverizing time elapsed, separation was made into three types of oversieve, undersieve, and fine powder which had been separated by wind separation. The sieve opening of the sifter provided to the hammer crusher 4 was 7.9 mm.

Oversieve #1 crushed by the hammer crusher 4 and separated at the sifter (screen) was metallic iron, and was collected as product.

Undersieve crushed by the hammer crusher 4 and separated at the sifter (screen) was screened using a sifter 5, and separated into oversieve and undersieve. The sieve opening of the sifter 5 was 3.35 mm.

The oversieve separated at the sifter 5 was magnetically selected/separated into magnetically attractable substance #2 and magnetically non-attractable substance #3 at a magnetic separator 6. As a result, the magnetically attractable substance #2 was metallic iron including slag, collected as a product. On the other hand, the magnetically non-attractable substance #3 was slag.

The undersieve separated at the sifter 5 was magnetically separated into magnetically non-attractable substance #4 and magnetically non-attractable substance #5 at the magnetic separator 7. The magnetically attractable substance #4 was metallic iron including slag. On the other hand, the magnetically non-attractable substance #5 was slag.

The wind-separated fine powder (fine powder before cyclone separator) from crushing by the hammer crusher 4 was pulverized at a pug mill 8, and thereafter selected/separated into magnetically attractable substance #6 and magnetically non-attractable substance #7 at a magnetic separator 9. As a result, the magnetically attractable substance #6 was metallic iron including slag. On the other hand, the magnetically non-attractable substance #7 was slag. Note that the granularity of the undersieve separated at the sifter 5 without being wind-separated was relatively coarse, the mass of powder 0.1 mm or larger being 95% or more.

The collected matter collected as the undersieve at the sifter 3 was magnetically selected/separated into magnetically attractable substance and magnetically non-attractable substance using a magnetic separator 10.

The magnetically attractable substance obtained by being magnetically selected/separated at the magnetic separator 10 was pulverized at a pug mill 11, and thereafter magnetically selected/separated into magnetically attractable substance #9 and magnetically non-attractable substance #10 using a magnetic separator 12.

The magnetically non-attractable substance #8 obtained by magnetic separation at the magnetic separator 10 was a mixture of hearth covering material and slag.

Table 1-5 below illustrates the component composition and percentage by mass as to the entirety, of #1 through #10 when using pellets B. In Table 1-5 below, M.Fe represents the amount of metallic iron.

Table 1-5 also illustrates the component composition and percentage by mass as to the entirety, of #9 and #10 in a combined state.

As can be understood from Table 1-5, the oversieve #1 separated at the hammer crusher 4 had T.Fe of 97.22%, and the magnetically attractable substance #2 had T.Fe of 96.79%. The oversieve #1 and magnetically attractable substance #2 were collected as product (metallic iron), and the average metallization percentage was 99.6%. Pulverization of these metallic irons was attempted using a pug mill which has a powerful fracturing force, but these were not easily fractured. As a result, it was found that the entire volume does not need to be pulverized at the hammer crusher 4, since particles 3.35 mm or larger are high-grade metallic iron. That is to say, for crushing the reduced product discharged from the rotary hearth furnace, a hammer crusher having a structure where crushing is performed a predetermined amount of time at the hammer crusher 4 which is an impact crusher, and coarse particles having a certain level of size are discharged, has been found to be preferable. Also, for the sifter 5 where the undersieve screened at the sifter provided to the hammer crusher 4 is further screened, it has been found that a sifter which yields crushed matter where the maximum grain size of the undersieve is approximately 3 mm, is preferably selected.

On the other hand, of the undersieve separated at the sifter 5, the magnetically attractable substance #4 had T.Fe of 90.55%. Also, the fine powder wind-separated at the hammer crusher 4 was pulverized at the pug mill 8 and then subjected to magnetic selection/separation at the magnetic separator 9 to yield the magnetically attractable substance #6, which exhibited a high value of 84.49% for T.Fe.

Next, Table 1-6 shows the percentages by mass with the oversieve #1, the magnetically attractable substance #2, and magnetically attractable substance #4 as 100%, and the slag percentage of each specimen.

Also, Table 1-6 shows the percentages by mass with the magnetically attractable substance #6 and magnetically attractable substance #9 as 100%, and the slag percentage of each specimen.

The analysis results of #1, #2, and #4 in Table 1-6 show that a product with a small slag percentage can be collected simply by a separation method using difference in particle size after crushing, such as sifters and wind separation and so forth. On the other hand, the analysis results of #6 and #9 show that even for post-crushing fine particles and undersieve of the sifter a, where separation of slag is difficult, performing further pulverization enables slag to be effectively removed.

TABLE 1-1

| | | | | | | | | | | | | Slag |
|---|---|---|---|---|---|---|---|---|---|---|---|---|
| Iron | Component composition (% by mass) | | | | | | | | | | | percentage |
| ore | T•Fe | FeO | T•C | CaO | SiO₂ | Al₂O₃ | MgO | S | P | Na₂O | K₂O | (%) |
| A | 63.2 | 28.5 | — | 0.54 | 9.1 | 0.46 | — | 0.005 | — | — | — | 15.1 |
| B | 58 | 0.45 | 0.026 | 0.11 | 15.4 | 0.77 | 0.07 | 0.009 | 0.019 | 0.13 | 0.017 | 27.9 |

TABLE 1-2

| Analysis value (% by mass) | | | | | | | |
|---|---|---|---|---|---|---|---|
| Ash | | | Component composition of | | | | |
| compo- | Volatile | | ash component (% by mass) | | | | |
| nent | component | Carbon | T•Fe | SiO₂ | Al₂O₃ | CaO | MgO |
| 6.8 | 15.84 | 77.34 | 10.21 | 44.41 | 25.43 | 5.19 | 1.60 |

TABLE 1-3

| | Component composition (% by mass) | | | | | | | | |
|---|---|---|---|---|---|---|---|---|---|
| Pellet | T•Fe | FeO | T•C | CaO | SiO₂ | Al₂O₃ | MgO | CaO/SiO₂ | Al₂O₃/SiO₂ |
| A | 47.3 | — | 16.6 | 2.65 | 7.33 | 1.58 | — | 0.36 | 0.21 |
| B | 42.5 | 2.2 | 15.2 | 6.27 | 10.97 | 0.92 | 0.11 | 0.57 | 0.08 |

TABLE 1-4

| Specimen | Processing procedure | | | | Feature |
|---|---|---|---|---|---|
| #1 | Oversieve | Pulverized | On screen (7.9 mm) | — | Coarse |
| | on 3.35 mm | by hammer | | | particles of |
| | sifter | crusher | | | highly pure |
| | | | | | metallic iron |
| #2 | Oversieve | Pulverized | Oversieve on 3.35 mm | Magnetically | Particles of |
| | on 3.35 mm | by hammer | sifter, under screen (7.9 mm) | attractable | highly pure |
| | sifter | crusher | | substance | metallic iron |
| #3 | Oversieve | Pulverized | Oversieve on 3.35 mm | Magnetically | Slag, slight |
| | on 3.35 mm | by hammer | sifter, under screen (7.9 mm) | non- | amount |
| | sifter | crusher | | attractable | |
| | | | | substance | |
| #4 | Oversieve | Pulverized | Undersieve from 3.35 mm | Magnetically | Metallic iron |
| | on 3.35 mm | by hammer | sifter, under screen | attractable | with relatively |
| | sifter | crusher | (7.9 mm) | substance | low slag |
| | | | | | percentage |
| #5 | Oversieve | Pulverized | Undersieve from 3.35 mm | Magnetically | Slag |
| | on 3.35 mm | by hammer | sifter, under screen | non- | |
| | sifter | crusher | (7.9 mm) | attractable | |
| | | | | substance | |
| #6 | Oversieve | Pulverized | Before cyclone separator | Magnetically | Metallic iron |
| | on 3.35 mm | by hammer | | attractable | with high slag |
| | sifter | crusher | | substance | percentage |
| #7 | Oversieve | Pulverized | Before cyclone separator | Magnetically | Slag, slight |
| | on 3.35 mm | by hammer | | non- | amount |
| | sifter | crusher | | attractable | |
| | | | | substance | |
| #8 | Undersieve | Magnetically | — | — | Hearth |
| | from 3.35 mm | non- | | | covering |
| | sifter | attractable | | | carbon |
| | | substance | | | material |
| #9 | Undersieve | Magnetically | Pulverized by pug mill | Magnetically | Metallic iron |
| | from 3.35 mm | attractable | | attractable | with high slag |
| | sifter | substance | | substance | percentage |
| #10 | Undersieve | Magnetically | Pulverized by pug mill | Magnetically | Slag, slight |
| | from 3.35 mm | attractable | | non- | amount |
| | sifter | substance | | attractable | |
| | | | | substance | |
| #9 + #10 | Undersieve | Magnetically | — | — | Metallic iron in |
| | from 3.35 mm | attractable | | | hearth |
| | sifter | substance | | | covering |
| | | | | | material |

TABLE 1-5

| | Component composition (% by mass) | | | | | | | Metallization | Slag | Percentage |
|---|---|---|---|---|---|---|---|---|---|---|
| | | | | | | | Calculated | percentage | percentage | by mass |
| Specimen | T.Fe | M.Fe | T.C | SiO₂ | Al₂O₃ | CaO | FeO | (%) | (%) | (%) |
| #1 | 97.22 | 96.90 | 2.07 | 0.40 | 0.03 | 0.20 | 0.41 | 99.67 | 0.44 | 19.7 |
| #2 | 96.79 | 96.36 | 2.32 | 0.50 | 0.04 | 0.24 | 0.55 | 99.56 | 0.55 | 7.5 |
| #3 | 12.29 | 12.24 | 0.28 | 56.48 | 4.43 | 27.87 | 0.07 | 99.56 | 495.61 | 0.1 |
| #4 | 90.55 | 89.58 | 2.24 | 4.42 | 0.41 | 1.82 | 1.25 | 98.93 | 5.33 | 7.8 |
| #5 | 10.61 | 10.50 | 0.92 | 57.14 | 4.48 | 28.20 | 0.15 | 98.93 | 580.80 | 5.4 |
| #6 | 84.49 | 82.43 | 2.90 | 7.43 | 0.73 | 3.11 | 2.65 | 97.56 | 9.66 | 25.1 |
| #7 | 14.86 | 14.50 | 1.90 | 52.02 | 4.42 | 26.46 | 0.47 | 97.56 | 379.82 | 1.8 |
| #8 | 2.22 | 2.13 | 65.15 | 20.40 | 1.73 | 10.38 | 0.11 | 95.98 | 997.08 | 24.1 |
| #9 | 79.67 | 76.47 | 2.57 | 10.68 | 0.91 | 5.43 | 4.12 | 95.98 | 14.54 | 6.9 |
| #10 | 6.78 | 6.51 | 3.03 | 56.39 | 4.79 | 28.68 | 0.35 | 95.98 | 902.32 | 1.5 |
| Calculated | 66.74 | 64.06 | 2.65 | 18.79 | 1.60 | 9.56 | 3.45 | 95.98 | 30.54 | 8.3 |
| #9 + #10 | | | | | | | | | | |

TABLE 1-6

| | Percentage | Slag percentage |
|---|---|---|
| Specimen | (% by mass) | (%) |
| #1 | 56.24 | 0.44 |
| #2 | 21.50 | 0.55 |
| #4 | 22.26 | 5.27 |
| Total | 100.00 | 1.54 |
| #6 | 78.55 | 9.66 |
| #9 | 21.45 | 14.54 |
| Total | 100.00 | 10.71 |

### Example 1-21

In Example 1-2, selecting of a crusher, for crushing the reduced product including the metallic iron and slag discharged from the rotary hearth furnace, was studied.

The dry pellets B shown in Table 1-3 were heated at 1430° C. for 11 minutes or at 1460° C. for 12 minutes in a rotary hearth furnace. The pellets obtained by being heated at 1430° C. for 11 minutes were reduced iron grains in form, while the pellets obtained by being heated at 1460° C. for 12 minutes were metallic iron grains. Reduced granular iron specimens or metallic iron granular specimens thus obtained were magnetically separated and the slag percentage in the magnetically attractable substance was measured based on the Expression (1) above. The slag percentage in the reduced iron granular specimens was 19.0%, while the slag percentage in the metallic iron granular specimens was 11.9%. The results regarding the reduced iron granular specimens obtained by heating at 1430° C. are indicated by the white bars in the bar graph in FIG. 1-2, while the results regarding the metallic iron granular specimens obtained by heating at 1460° C. are indicated by the hatched bars in the bar graph in FIG. 1-2.

Of the specimens discharged from the rotary hearth furnace, 1 kg of those having a diameter of 3.35 mm or larger was collected, and fed to and crushed in a ball crusher 30 cm in diameter and 30 cm long at 10 rpm for 20 minutes. The balls placed in the ball crusher were 20 kg. The crushed matter was magnetically separated by a magnetic separator, and the slag percentage of the magnetically attractable substance was measured based on the above Expression (1). FIG. 1-2 illustrates the results of the reduced iron granular specimens obtained by heating at 1430° C. and the results of the metallic iron granular specimens obtained by heating at 1460° C. As a result, the slag percentage of the metallic iron granular specimens fell to 3.2%, while the slag percentage of the reduced iron granular specimens hardly fell at all (slag percentage was 15.9%). The reason for this is though to be that the metallic iron deformed at a state where separation of slag had not occurred very much, so slag existing within the specimen became difficult to separate.

Next, the reduced iron granular specimens obtained by heating at 1430° C. and the metallic iron granular specimens obtained by heating at 1460° C. were crushed using a hammer crusher. FIG. 1-2 illustrates the results of the reduced iron granular specimens obtained by heating at 1430° C. and the results of the metallic iron granular specimens obtained by heating at 1460° C. As a result, the slag percentage of the metallic iron granular specimens fell to 2.4%, and the slag percentage of the reduced iron granular specimens fell to 5.9%.

From the above results, it was found that crushing using a hammer crusher is suitable to separate the metallic iron from the specimens discharged from the rotary hearth furnace of which the diameter is 3.35 mm or larger.

### Example 1-3

FIG. 1-3 is a schematic diagram illustrating a configuration example used instead of a hammer crusher. A normal hammer crusher has a screen (sifter) provided within the crusher as a separator, and crushing is performed until the same as or smaller than the sieve opening of the sifter. On the other hand, the reduced product obtained from the movable hearth type heating furnace contains hard metallic iron with large gain size, but the object of the crusher in the present invention is to remove slag attached to the metallic iron, and not to crush the metallic iron and reduce the grain size thereof. Accordingly, by providing the sifter outside of the crusher of the hammer crusher and not inside, the present invention is capable of continuously collecting product metallic iron without reducing the grain size.

FIG. 1-3 illustrates such a configuration example, where the reduced product is introduced to a crusher 21 and crushed under impact. The crusher 21 does not have a screen provided therein. The crushed matter crushed at the crusher 21 is supplied to a sifter 22 where it is screened. A sifter 22 having a sieve opening of 2 mm, for example, may be used.

The undersieve screened at the sifter 22 is a mixture of metallic iron and slag.

The oversieve screened at the sifter 22 is supplied to a sifter 23, where second-stage screening is performed. A sifter 23 having a sieve opening of 8 mm, for example, may be used. Matter having a grain size of 8 mm or more may have not been applied with sufficient impact at the crusher, so the oversieve screened at the sifter 23 may be supplied to the crusher 21 and subjected to crushing processing. On the other hand, the undersieve screened at the sifter 23 is metallic iron having a grain size around 2 to 8 mm.

### Example 1-4

FIG. 1-4 is a schematic diagram illustrating a configuration example of another metallic iron producing process according to the present invention. Parts in FIG. 1-4 which are the same as those in FIG. 1-1 are denoted with the same reference numerals to avoid redundant description.

In FIG. 1-4, a mixture including an iron oxide-containing material, a carbonaceous reductant, and an additive, is formed into an agglomerate using the pan pelletizer 1, thereby producing an agglomerate. The obtained agglomerate was introduced to the rotary hearth furnace 2 and heated. The reduced product obtained by heating in the rotary hearth furnace 2 was screened using the sifter 3. Note that, while description is made here regarding a case of using the pan pelletizer 1, the present invention is not restricted thusly, and a pelletizer other than a pan pelletizer, a briquette machine, an extruder, or the like may be used.

The collected matter collected at the sifter 3 as oversieve is supplied to a rod crusher 4a which is an impact crusher, and crushed.

The oversieve obtained by crushing at the rod crusher 4a and screening at a sifter provided outside of the rod crusher is collected as metallic iron (#1).

The undersieve obtained by crushing at the rod crusher 4a and screening at the sifter provided outside of the rod crusher is supplied to the magnetic separator 7, and separated into magnetically attractable substance and magnetically non-attractable substance. The magnetically non-attractable substance #5 sorted at the magnetic separator 7 was slag.

The collected matter collected at the sifter 3 as undersieve as supplied to the magnetic separator 10, separated into magnetically attractable substance and magnetically non-attractable substance.

The magnetically attractable substance sorted at the magnetic separator 7 and the magnetically attractable substance sorted at the magnetic separator 10 was supplied to a ball crusher 11a and pulverized, and the pulverized matter was supplied to the magnetic separator 12 and separated into magnetically attractable substance and magnetically non-attractable substance. The magnetically attractable substance sorted at the magnetic separator 12 was collected as metallic iron (#9). On the other hand, the magnetically non-attractable substance (#10) sorted at the magnetic separator 12 was metallic iron with a high slag percentage.

The magnetically non-attractable substance (#8) sorted at the magnetic separator 10 was almost all hearth covering material.

### Example 1-5

In Example 1-5, metallic iron was produced following the processes for producing metallic iron illustrated in FIG. 1-5, and crushing conditions at a crusher 34 and the type of a pulverizer suitably used as a pulverizer 38 was studied.

First, the processes for producing metallic iron will be described based on FIG. 1-5. An agglomerate was formed of a mixture including an iron oxide-containing material, a carbonaceous reductant, and an additive, thereby producing an agglomerate. The obtained agglomerate was introduced into a movable hearth type heating furnace 31, and reduced by heating. The reduced product including metallic iron and slag which was discharged from the movable hearth type heating furnace 31 was separated into coarse particular matter and fine particulate matter using a sifter a 32. The coarse particulate matter (oversieve) obtained at the sifter a 32 was crushed using an impact crusher 34. The crushed matter obtained by crushing was separated into two types using a separator 35.

A sifter was used as the separator 35. The oversieve obtained by screening by the sifter was collected out from the system as a product. On the other hand, the undersieve obtained by screening at the sifter was introduced to a magnetic separator 37. The magnetically attractable substance obtained by magnetic separating at the magnetic separator 37 was introduced to a pulverizer 38. Note that the aforementioned separator 35 and aforementioned magnetic separator 37 may be omitted.

The pulverized matter obtained at the pulverizer 38 was introduced to a magnetic separator 39 and magnetically separated. The magnetically attractable substance obtained by magnetically separating was collected from a path 48 as metallic iron. If the obtained magnetically attractable substance needed further separation from slag, it was introduced to a pulverizer 40 instead of being collected as metallic iron from the path 48.

The pulverized matter obtained at the pulverizer 40 was introduced to a magnetic separator 41, and magnetic separation was performed. The magnetically attractable substance obtained by magnetically separating was collected from a path 49 as metallic iron. If the obtained magnetically attractable substance needs further separation from slag, it may be repeatedly introduced to a pulverizer again and pulverized and magnetically separated, instead of being collected as metallic iron from the path 49.

The magnetically attractable substance obtained from the magnetic separator 41 was introduced to an agglomerate forming machine 36 (e.g., a briquette machine), formed into an agglomerate, and collected as a product 51. Note that the agglomerate forming machine 36 may be omitted. Also, FIG. 1-5 does not illustrate paths for discharging the magnetically non-attractable substance sorted out by the magnetic separators 37, 39, and 41, from the system.

Next, the crushing conditions at the crusher 34 were studied in this Example.

The pellet B shown in Table 1-3 above was used as the agglomerate. This agglomerate was introduced to the movable hearth type heating furnace 31 and reduced by heating. The reduction by heating in the furnace was performed at 1400 to 1450° C.

A sifter a 32 having a sieve opening of 3.35 mm was used.

A rod crusher was used as the crusher 34. The inner diameter of the rod crusher was 0.5 m, the length was 0.9 mm, and 460 kg of rods serving as a pulverizing medium were placed therein.

The amount of coarse particulate matter introduced into the rod crusher was 50 kg, the crushing conditions were revolutions of 40 rpm and crushing time of 3 minutes, 5 minutes, and 10 minutes. As a result, the slag percentage of the crushed product obtained by crushing for 3 minutes was 10.2%, the slag percentage of the crushed product obtained by crushing for 5 minutes was 9.8%, and the slag percentage of the crushed product obtained by crushing for 10 minutes was 9.6%.

The slag percentage indicates the percentage of the total mass of SiO₂ and Al₂O₃ as to the mass of the T.Fe contained in the crushed product [(SiO₂+Al₂O₃)/T.Fe×100 . . . (1)].

From the above results, it was found that 3 minutes crushing time at the crusher 34 is sufficient.

Also, the type of pulverizer suitably used as the pulverizer 38 was also studied in the present Example. Note that the separator 35 and magnetic separator 37 were omitted.

A rod crusher or cage crusher was used as the pulverizer 38.

In a case of using a rod crusher, pulverizing was performed once (pulverizing time 15 minutes). As a result, the slag percentage was 13.8% when using a rod crusher as the pulverizer 38.

In a case of using a cage crusher, pulverizing was performed three times. That is to say, after one pass of pulverizing, a part of the sample was collected, this was magnetically selected, and the slag percentage of the obtained magnetically attractable substance was measured. The remainder of the sample was subjected to the second pass of pulverizing. After the second pass of pulverizing, a part of the sample was collected, this was magnetically selected, and the slag percentage of the obtained magnetically attractable substance was measured. The remainder of the sample was subjected to a third pass of pulverizing, after which this was magnetically selected, and the slag percentage of the obtained magnetically attractable substance was measured. The cage crusher used had four rows, with the diameter of the outermost row being 0.75 m, with the pins of the cage colliding with the pulverization matter at a maximum speed of 40 m/second. As a result, in a case of using a cage crusher as the pulverizer 38, the first pass was 9.8%, the second pass was 7.9%, and the third pass was 6.5%. It was found that in a case of using a cage crusher, the slag percentage could be reduced even further by repeating pulverization.

From the above results, as the pulverizer 38, it was found that the slag percentage contained in the pulverized matter was relatively lower in a case of using a cage crusher as compared to using a rod crusher.

### Example 1-61

In Example 1-6, metallic iron was produced following the processes for producing metallic iron illustrated in FIG. 1-6, and the T.Fe amount included in the pulverized matter and the yield of Fe was studied.

First, the process of producing metallic iron illustrated in FIG. 1-6(a) will be described.

An agglomerate was formed of a mixture including an iron oxide-containing material, a carbonaceous reductant, and an additive, thereby producing an agglomerate. The obtained agglomerate was introduced into the movable hearth type heating furnace 31, and reduced by heating.

The reduced product including metallic iron and slag which was discharged from the movable hearth type heating furnace 31 was separated into coarse particular matter and fine particulate matter using the sifter a 32. The fine particulate matter (undersieve) obtained at the sifter a 32 was introduced to the magnetic separator 42 and magnetically separated. The magnetically non-attractable substance obtained by magnetic separation was discharged from the system by a path 43, and used as hearth covering material for the movable hearth type heating furnace. The magnetically attractable substance obtained by the magnetic separating had a T.Fe of 66.05%, and was introduced to a pulverizer 44 and pulverized.

The pulverized matter obtained by pulverizing at the pulverizer 44 was separated into two types using a separator 45. In FIG. 1-6(a), a magnetic separator 45 was used as the separator 45.

In the present Example, a ball crusher was used as the pulverizer 44 shown in FIG. 1-6(a), and magnetically attractable substance sorted at the magnetic separator 42 was pulverized. A ball crusher having an inner diameter of 0.5 m and a length of 0.5 m was used. Approximately 40 kg of pulverization specimen was introduced, 180 kg of pulverizing medium balls were placed inside, and pulverizing was performed at revolutions of 40 rpm and pulverizing time of 9 minutes. Note that the pulverizing was set to 9 minutes because raising the T.Fe percentage of the magnetically attractable substance that had been selected was difficult even of the pulverizing time was extended past 9 minutes.

The T.Fe amount contained in the pulverized matter obtained by pulverizing at the pulverizer 44, and the Fe yield, were measured. As a result, the T.Fe was 84.5% and the Fe yield was 96.3%.

Next, the process of producing metallic iron illustrated in FIG. 1-6(b) will be described. The process of producing metallic iron illustrated in FIG. 1-6(b) is a modification of the process of producing metallic iron illustrated in FIG. 1-6(a) described above.

The process of producing metallic iron illustrated in FIG. 1-6(b) is the same as the process of producing metallic iron illustrated in FIG. 1-6(a), except that a process of pulverizing the magnetically attractable substance obtained by the magnetic separator 45 using a pulverizer 46, and a process of a magnetic separator 52 magnetically separating pulverized matter obtained at the pulverizer 46, have been added. Note that the separator 45 (magnetic separator 45) may be omitted.

In the present Example, cage crushers were used as the pulverizer 44 and pulverizer 46 illustrated in FIG. 1-6(b). That is to say, the magnetically attractable substance separated at the magnetic separator 42 was pulverized at the cage crusher 44, part of the specimen was collected, and the remainder was introduced to the cage crusher 46 and pulverized.

The pulverizing conditions at the cage crusher were the same as the conditions given in Example 1-5 above.

A specimen collected from the pulverized matter obtained by the pulverizing at the cage crusher 44 (e.g., first pulverizing) was separated by magnetic separation at an unshown magnetic separator. The T.Fe contained in the obtained magnetically attractable substance was 85.8%, and the yield of Fe was 97.7%. The specimen collected from pulverized matter obtained by pulverizing at the cage crusher 44 (i.e., first pulverizing) was separated at an unshown magnetic separator, and the obtained magnetically attractable substance was screened using a sifter with a sieve opening of 0.3 mm so as to remove fine powder having a grain size of 0.3 mm or smaller. Fine powder which has a grain size of 0.3 mm or smaller contains a great amount of slag but little T.Fe amount, so while the yield of Fe fell somewhat to 89.4%, the T.Fe amount increased to 93.6%, providing an iron product with even higher usage value.

Pulverized matter obtained by pulverizing at the cage crusher 46 (i.e., second pulverizing) was separated at the magnetic separator 52. The T.Fe contained in the obtained magnetically attractable substance was 88.7%, and the yield of Fe was 95.9%.

### Example 1-7

In Example 1-7, metallic iron was produced following the processes for producing metallic iron illustrated in FIG. 1-7, and the effects which the type of pulverizer 44 have on the T.Fe contained in the pulverized matter and the yield of Fe were studied.

First, the processes for producing metallic iron will be described based on FIG. 1-7.

An agglomerate was formed of a mixture including an iron oxide-containing material and a carbonaceous reductant, thereby producing an agglomerate. The obtained agglomerate was introduced into the movable hearth type heating furnace 31, and reduced by heating. The reduced product including metallic iron and slag which was discharged from the movable hearth type heating furnace 31 was separated into coarse particular matter and fine particulate matter using the sifter a 32. The sieve opening of the sifter used as the sifter a 32 was 3.35 mm.

The coarse particulate matter (oversieve) obtained at the sifter a 32 was magnetically separated and the magnetically attractable substance was collected as product. The fine particular matter obtained from the sifter a 32 (undersieve) was introduced to the magnetic separator 42 and separated by magnetic separation. The separated magnetically non-attractable was substance was discharged from the system by a path 43, and used as hearth covering material for the movable hearth type heating furnace. The magnetically attractable substance obtained by the magnetic separating was introduced to the pulverizer 44 and pulverized.

The pulverized matter obtained by pulverizing at the pulverizer 44 was introduced to a magnetic separator 55 and separated by magnetic separation.

The magnetically attractable substance obtained by separating at the magnetic separator 55 was separated into two types using the separator 45. FIG. 1-7 illustrates an example of using a sifter 45 as the separator 45. The sieve opening of the sifter was 0.3 mm.

The undersieve screened at the sifter 45 used as the separator 45 was discharged from the system. The oversieve was introduced to an agglomerate forming machine 53 (e.g., a briquette machine), formed into an agglomerate having a shape such as a briquette or the like, and collected as a product 54.

In a case of giving priority to iron yield over the purity of the iron in the product, the sifter 45 may be omitted, with the magnetically attractable substance of the magnetic separator 55 being formed and taken as a product.

In the present Example, a ball crusher or cage crusher was used as the pulverizer 44 shown in FIG. 1-7.

A ball crusher having an inner diameter of 0.5 m and a length of 0.5 m was used. Approximately 40 kg of pulverization specimen was introduced, 180 kg of pulverizing medium balls were placed inside, and pulverizing was performed at revolutions of 40 rpm and pulverizing time of 9 minutes. Note that the pulverizing time was set to 9 minutes because raising the T.Fe percentage of the magnetically attractable substance that had been selected by magnetic separation was difficult even of the pulverizing time was extended past 9 minutes.

The T.Fe amount contained in the pulverized matter obtained by pulverizing at the pulverizer 44, and the Fe yield, were measured. As a result, the T.Fe was 84.46% and the yield was 96.27%.

On the other hand, in a case of using a cage crusher, the magnetically attractable substance separated at the magnetic separator 42 was pulverized at the cage crusher 44. After pulverizing at the cage crusher 44 (after first pulverizing), the collected specimen was separated by magnetic separation at a magnetic separator 55. The T.Fe contained in the obtained magnetically attractable substance was 85.77% and the Fe yield was 97.7%.

Also, the oversieve obtained at the sifter 45 was screened using sifters having sieve openings of 0.045 mm, 0.3 mm, 1.0 mm, 3.35 mm, so as to classify into five stages of 0.045 mm or smaller, larger than 0.045 mm but 0.3 mm or smaller, larger than 0.3 mm but 1.0 mm or smaller, larger than 1.0 mm but 3.35 mm or smaller, and larger than 3.35 mm. The T.Fe amount at each frequency was calculated. As a result, the T.Fe amount in the powder 0.045 mm or smaller was 32.30%, the T.Fe amount in the powder larger than 0.045 mm but 0.3 mm or smaller was 45.27%, the T.Fe amount in the powder larger than 0.3 mm but 1.0 mm or smaller was 86.82%, the T.Fe amount in the powder larger than 1.0 mm but 3.35 mm or smaller was 96.18%, and the T.Fe amount in the powder larger than 3.35 mm was 96.20%. As can be seen from these results, the finer the powder, the greater the slag component and smaller the T.Fe amount is. Accordingly, removing the fine powder slightly reduces the yield of Fe, but the effects thereof are small. On the other hand, the average T.Fe can be raised, so this is effective. Note that while a sifter was used for sorting the fine powder, a wind separator may be used instead of the sifter in a case of sorting great amounts of fine powder having a grain diameter of 2 mm or smaller, for example.

Also, the specimen collected from pulverized matter obtained by pulverizing at the cage crusher 44 (i.e., first pulverizing) was separated at the magnetic separator 55, and the obtained magnetically attractable substance was screened using a sifter with a sieve opening of 0.3 mm so as to remove fine powder having a grain size of 0.3 mm or smaller. Fine powder which has a grain size of 0.3 mm or smaller contains a great amount of slag but little T.Fe, so while the yield of Fe fell somewhat to 89.4%, the T.Fe amount increased to 93.6%, providing an iron product with even higher usage value.

Also, after pulverizing at the cage crusher as a first pass, a part is returned to the cage crusher again and a second pass of pulverizing is performed. The pulverized matter is then introduced to the magnetic separator 55 and separated by magnetic separation so as to sort into magnetically attractable substance and magnetically non-attractable substance. The magnetically non-attractable substance obtained by sorting was screened by the separator 25. The T.Fe amount contained in the oversieve and the yield of the Fe was calculated. As a result, the T.Fe amount was 88.72% and the Fe yield was 95.9%.

From the above results, it can be seen that the T.Fe amount contained in the obtained pulverized matter and the Fe yield changes depending on the type of the pulverizer 44.

### Example 1-8

In Example 1-8, all processes of the method of producing metallic iron according to the present invention will be described with reference to FIG. 1-8.

An agglomerate was formed of a mixture including an iron oxide-containing material and a carbonaceous reductant, thereby producing an agglomerate. The obtained agglomerate was introduced into the movable hearth type heating furnace 31, and reduced by heating.

The reduced product including metallic iron and slag which was discharged from the movable hearth type heating furnace 31 was separated into coarse particular matter and fine particulate matter using the sifter a 32. The coarse particulate matter (oversieve) obtained at the sifter a 32 was magnetically separated using the magnetic separator 33. The separated magnetically non-attractable substance was discharged from the system by an unshown path. The magnetically attractable substance obtained by the magnetic separating was crushed using the impact crusher 34.

The crushed matter obtained by crushing was separated into two types using a separator 35. A magnetic separator, wind separator, sifter b, or the like may be used as the separator 35, for example.

In a case of using a magnetic separator as the separator 35, the magnetically attractable substance obtained by magnetically separating may be introduced to the agglomerate forming machine 36, and the magnetically non-attractable substance introduced to the magnetic separator 37. In a case of using a magnetic separator as the separator 35, the magnetic force is preferably set so as to be weaker than the magnetic separator 37 used downstream.

In a case of using a wind separator as the separator 35, the coarse particulate matter and matter with large specific gravity, obtained by separating by wind, may be introduced to the agglomerate forming machine 36, and the fine particulate matter introduced to the magnetic separator 37.

In a case of using a sifter b as the separator 35, the oversieve obtained by screening may be introduced to the agglomerate forming machine 36, and the undersieve introduced to the magnetic separator 37.

The magnetically non-attractable substance obtained by magnetically separating at the magnetic separator 37 may be discharged from the system, and the magnetically attractable substance introduced to the magnetic separator 36. If the obtained magnetically attractable substance needs further separation from slag, the magnetically attractable substance may be introduced to the pulverizer 38.

The pulverized matter obtained at the pulverizer 38 may be introduced to the magnetic separator 39 and separated by magnetic separation. The magnetically non-attractable substance obtained by magnetic separating may be discharged from the system, and the magnetically attractable substance introduced to the agglomerate forming machine 36. If the obtained magnetically attractable substance needs further separation from slag, the magnetically attractable substance may be introduced to the pulverizer 40.

The pulverized matter obtained at the pulverizer 40 may be introduced to the magnetic separator 41 and separated by magnetic separation. The magnetically attractable substance obtained by magnetic separating may be introduced to the agglomerate forming machine 36, and the magnetically non-attractable substance discharged from the system by an unshown path.

While an example has been illustrated in FIG. 1-8 where the magnetic separator 37, magnetic separator 39, and magnetic separator 41 are provided separately, a single magnetic separator may substitute for these. Also, while an example has been illustrated in FIG. 1-8 where the pulverizer 38 and pulverizer 40 are provided separately, a single pulverizer may substitute for these. The number of times of repeating magnetic separating and pulverizing is not restricted to the number of times shown in FIG. 1-8, and may be one time each, as a matter of course.

Next, description will be made returning to the sifter a 32.

The fine particulate matter (undersieve) obtained at the sifter a 32 was introduced to the magnetic separator 42 and separated by magnetic separation. Note that a wind separator may be used instead of the magnetic separator 42.

The magnetically non-attractable substance obtained by magnetic separation may be discharged from the system by the path 43, and reused as hearth covering material, for example. The magnetically attractable substance obtained by the magnetic separation may be introduced from the magnetic separator 42 to the agglomerate forming machine 36, or may be introduced from the magnetic separator 42 to the pulverizer 44 and pulverized.

The pulverized matter obtained by pulverizing at the pulverizer 44 was separated into two types using the separator 45. A magnetic separator, wind separator, or the like, may be used as the separator 45, for example. In a case of using a magnetic separator as the separator 45, the magnetically attractable substance obtained by magnetically separating may be introduced to pulverizer 46, and the magnetically non-attractable substance discharged from the system by the path 47. In a case of using a wind separator as the separator 45, the coarse particulate matter and matter with large specific gravity, obtained by separating by wind, may be introduced to the pulverizer 46, and the fine particulate matter discharged from the system by the path 47. Both a magnetic separator and wind separator may be used as the separator 45.

The pulverized matter obtained by pulverizing at the pulverizer 46 is introduced to a magnetic separator 56 and separated by magnetic separation to remove magnetically non-attractable substance. The magnetically attractable substance obtained by the magnetic separation may be introduced to the agglomerate forming machine 36, formed into briquettes or the like, for example, and used as an iron source.

Note that the pulverizer 44 and pulverizer 46 may be pulverizer of different types, and in a case of a specimen where separation of slag is easy, the pulverizer 46 may be omitted and the number of times that pulverizing is performed be made to be once.

### Example 2-1

In Example 2-1, the relationship between the granularity and external appearance of discharged matter discharged from a movable hearth type heating furnace, when heating an agglomerate containing an iron oxide-containing material and a carbonaceous reductant is heated in a movable hearth type heating furnace, was studied.

First, a mixture of iron ore, coal, limestone, and binder were formed into agglomerates, thereby producing agglomerates (pellets). A starch-based binder was used for the binder. A pan pelletizer was used for producing the pellets, producing spherical pellets of which the average diameter was 19 mm, and the obtained spherical pellets were dried one hour at 180° C. The component compositions of the dried pellets are illustrated in Table 2-1 below.

Next, the dried pellets were placed in a rotary hearth furnace, heated for 10 minutes at approximately 1450° C., and the pellets were melted to form molten metallic iron and molten slag. A reduced product was also generated in the furnace. The obtained mixture was cooled by cooling means provided downstream of the rotary hearth furnace, and the obtained solid matter was discharged from the rotary hearth furnace and further cooled.

The discharged matter including metallic iron, slag, and hearth covering material, that was discharged form the rotary hearth furnace, was screened using a sifter having a sieve opening of 2.5 mm.

The undersieve obtained by the screening was sorted by magnetically separating using a magnetic separator into magnetically attractable substance and magnetically non-attractable substance. The magnetically attractable substance was collected as metallic iron. The magnetically non-attractable substance was primarily hearth covering material, and accordingly was recycled.

On the other hand, the oversieve obtained by the screening was metallic iron which could be collected as a product, and was classified into four types based on the external form. The percentage by mass of each of the four types of metallic iron as to the total was calculated, and the percentage by mass for each granularity was also calculated for each metallic iron. The results thereof are shown in Table 2-2 below. The component compositions of the four types of metallic iron were also measured, and the results thereof are shown in Table 2-3 below.

Based on Table 2-2 and Table 2-3, the following observations can be made.

### (Metallic Iron A)

The external form of the metallic iron A was granular. The percentage by mass of the metallic iron A as to the total was 60.5%. As can be seen from Table 2-2, the metallic iron A primarily had a range of granularity of 5 to 15 mm, and was high-grade granular metallic iron containing little slag, as can be seen from Table 2-3.

### (Metallic Iron B)

The external form of the metallic iron B was oblate, with multiple pieces of metallic iron adhered to each other. The percentage by mass of the metallic iron B as to the total was 13.8%. As can be seen from Table 2-2, the metallic iron B had a wide range of granularity, of 5 to 25.4 mm, and was metallic iron containing somewhat more slag than the metallic iron A, as can be seen from Table 2-3.

### (Metallic Iron C)

The external form of the metallic iron C was multiple large metallic iron clumps joined together, with much slag present therebetween. The percentage by mass of the metallic iron C as to the total was 10.6%. As can be seen from Table 2-2, the metallic iron C primarily had a range of granularity of 15 to 25.4 mm, and was metallic iron containing more slag than the metallic irons A and B, as can be seen from Table 2-3.

### (Metallic Iron D)

The external form of the metallic iron D was a mixture of outer shell-shaped metallic iron and spherical pellets. The percentage by mass of the metallic iron D as to the total was 15.1%. As can be seen from Table 2-2, the metallic iron D primarily had a range of granularity of 15 to 19 mm, and was metallic iron which, of the four types of metallic iron, contained much slag, as with the case of the metallic iron C, as can be seen from Table 2-3. FIG. 2-1 shows a photograph serving in the stead of a diagram, in which the external form of the metallic iron D has been photographed.

TABLE 2-1

Component composition (% by mass)

| Pellet | T.Fe | FeO | T.C | CaO | SiO₂ | Al₂O₃ |
|---|---|---|---|---|---|---|
| a | 45.8 | 0.4 | 14.6 | 6.7 | 4.8 | 0.6 |

TABLE 2-2

| Metallic | Percentage | Grain size (mm) | | | |
|---|---|---|---|---|---|
| iron | (%) | 5 to 10 | 10 to 15 | 15 to 19 | 19 to 25.4 |
| A | 60.5 | 12.1 | 38.2 | 5.1 | 5.1 |
| B | 13.8 | 4 | 6.4 | 1.1 | 2.3 |
| C | 10.6 | 0 | 0.5 | 3.4 | 6.7 |
| D | 15.1 | 1.4 | 9.0 | 3.9 | 0.8 |
| Mix. | 100 | 17.5 | 54.1 | 13.5 | 14.9 |

TABLE 2-3

| | Per- | | | | | | |
|---|---|---|---|---|---|---|---|
| | cent- | | | | | | |
| Metallic | age | Component composition (% by mass) | | | | | |
| iron | (%) | C | T.Fe | FeO | CaO | SiO₂ | Al₂O₃ |
| A | 60.5 | 2.65 | 96.20 | 0.29 | 0.18 | 0.17 | 0.02 |
| B | 13.8 | 1.56 | 94.27 | 0.31 | 1.59 | 1.25 | 0.19 |
| C | 10.6 | 1.16 | 87.27 | 0.75 | 5.37 | 4.22 | 0.65 |
| D | 15.1 | 1.88 | 85.75 | 1.34 | 5.70 | 4.19 | 0.69 |
| Average | 100 | 2.22 | 93.39 | 0.50 | 1.77 | 1.36 | 0.21 |

Next, a method was studied to separate the metallic iron and slag in the metallic iron D which contained the greatest amount of slag and was low grade.

The metallic iron D was pulverized in a disc crusher, which is a type of a vibrational crusher. Specifically, 112 g of the metallic iron D was placed in a disc crusher, pulverized for 30 seconds, screened using a sifter with a sieve opening of 1 mm, and the oversieve was further pulverized for 3 minutes.

The granular distribution of the pulverized matter obtained by the oversieve having been pulverized for 3.5 minutes was studied, and the results thereof are shown in Table 2-4 below. As can be seen from Table 2-4, coarse particles having a granularity range of 3.35 mm or greater was 46.92% of the total. These coarse particles were metallic iron, and accordingly were difficult to be pulverized any further.

Next, the pulverized matter obtained by the oversieve having been pulverized for 3.5 minutes was magnetically separated, and the percentage by mass of magnetically attractable substance and magnetically non-attractable substance was measured. The measurement results are shown in Table 2-5 below. In Table 2-5, M.Fe means metallic iron amount. 12.71% of the magnetically non-attractable substance was removed in the magnetic separation, as can be seen in Table 2-5. The amount of slag (SiO₂+CaO+Al₂O₃) contained in the magnetically non-attractable substance was 77%.

The metallization percentage, total amount of SiO₂ and Al₂O₃, slag percentage, and slag removal percentage were calculated for the magnetically attractable substance, the results of which are illustrated in Table 2-6 below.

Metallization percentage (%)=(M.Fe/T.Fe)×100

Slag percentage (%)=(SiO₂+Al₂O₃)/T.Fe×100

Slag removal percentage (%)=[1−(slag amount in magnetically attractable substance after pulverizing/slag amount in specimen before pulverizing)]×100

Note that the slag amount for calculation of the slag removal percentage means the total amount of SiO₂+CaO+Al₂O₃.

As can be seen in Table 2-6, the metallization percentage was 94.99% which is high, the slag percentage was reduced from 5.69% to 4.81%, and the slag removal percentage was 56.63%. Thus, it was found that metallic iron having a slag percentage of 4.81% could be produced even from the low-grade metallic iron D, by pulverizing and magnetic separation.

TABLE 2-4

| | Grain size (mm) | | | | | | | |
|---|---|---|---|---|---|---|---|---|
| | 3.35 or | 3.35 to | 1.0 to | 0.500 to | 0.300 to | 0.106 to | Smaller | |
| | larger | 1.0 | 0.500 | 0.300 | 0.106 | 0.045 | than 0.045 | Total |
| Mass (g) | 52.01 | 10.78 | 12.55 | 8.51 | 10.81 | 6.63 | 9.55 | 110.84 |
| Percentage | 46.92 | 9.73 | 11.32 | 7.68 | 9.75 | 5.98 | 8.62 | 100.00 |
| by mass (%) | | | | | | | | |

TABLE 2-5

| | Per- | | | | | | | |
|---|---|---|---|---|---|---|---|---|
| | cent- | | | | | | | |
| | age | | | | | | | |
| | (% | | | | | | | |
| | by | Component composition (% by mass) | | | | | | |
| | mass) | T.Fe | FeO | M.Fe | T.C | SiO₂ | CaO | Al₂O₃ |
| Magnetically | 87.29 | 87.76 | 3.50 | 83.36 | 1.23 | 3.52 | 4.18 | 0.70 |
| attractable | | | | | | | | |
| substance | | | | | | | | |
| Magnetically | 12.71 | 10.75 | 11.35 | 1.32 | 4.25 | 32.01 | 38.84 | 5.84 |
| non- | | | | | | | | |
| attractable | | | | | | | | |
| substance | | | | | | | | |
| Average | — | 85.70 | 4.74 | 80.32 | 1.70 | 7.27 | 8.73 | 1.38 |

TABLE 2-6
Magnetically attractable substance

| Metallization | SiO₂ + Al₂O₃ | Slag percentage | Slag removal |
|---|---|---|---|
| percentage (%) | (% by mass) | (%) | percentage (%) |
| 94.99 | 4.22 | 4.81 | 56.63 |

### Example 2-2

As illustrated in the above-described Example 2-1, it is reasonable to screen discharged matter containing metallic iron and slag, that is discharged from the rotary hearth furnace, the oversieve then be separated based on the external form, the metallic iron of which the amount of slag contained is the greatest be pulverized, and the obtained pulverized matter be magnetically separated to collect metallic iron. However, from an industrial perspective, there are cases where a suitable separating method is not available as an option.

Accordingly, in Example 2-2, a method to pulverize the mixed specimen in Table 2-2 (the mixture of metallic irons A through D, which is the oversieve obtained by screening the discharged matter containing metallic iron and slag that has been discharged from the rotary hearth furnace), magnetically select, and recover metallic iron, was studied.

A hammer crusher capable of impact crushing was used for crushing the mixed specimen. The rotations of the hammers were 1200 rpm, and the screen bar spacing was set to 10 mm. 2.4 kg of the mixed specimen was introduced, and crushed for approximately 40 seconds. This was repeated twice, following which granularity distribution was measured. The results are shown in Table 2-7 below. The granularity distribution before crushing is also shown in Table 2-7.

As can be seen from Table 2-7, powder of which the grain size was 5.66 mm or larger accounted for 90.7% before crushing, but after crushing the powder of which the grain size was 5.66 mm or larger decreased to for 66.8%, and the percentage of powder having a grain size smaller than 5.66 mm increased.

The powder after crushing was separated by hand using a magnet, and the granularity distribution of the magnetically attractable substance and magnetically non-attractable substance was studied. The results thereof are illustrated in FIG. 2-2. In FIG. 2-2, the granularity distribution of the magnetically attractable substance is indicated by solid squares, and the granularity distribution of the magnetically non-attractable substance is indicated by solid triangles. The granularity distribution of the powder before crushing is also shown in FIG. 2-2, indicated by solid diamonds.

It can be seen from FIG. 2-2 that the fine matter from crushing is magnetically non-attractable substance.

The component compositions of the magnetically attractable substance and magnetically non-attractable substance are illustrated in Table 2-8 below. Table 2-8 also illustrates the component composition of the powder after crushing but before magnetic separation (calculated value). As can be seen from Table 2-8 below, the magnetically non-attractable substance contains 12.14% T.Fe, but otherwise is almost all slag.

The T.Fe, basicity (CaO/SiO₂), slag percentage, and T.C were calculated regarding the powder after crushing but before magnetic separation, and the magnetically attractable substance, the results of which are shown in Table 2-9 below. While the powder after crushing but before magnetic separation had a slag percentage of 1.69%, this dropped to 0.72% for the magnetically attractable substance.

FIG. 2-3 shows a photograph serving in the stead of a diagram, in which the magnetically attractable substance has been photographed. It can be seen that crushing using the hammer crusher has worn the surface of the particles, and that the slag has been separated and removed, as illustrated in FIG. 2-3.

TABLE 2-7

| | Grain size (mm) | | | | | | |
|---|---|---|---|---|---|---|---|
| | 0.177 or | | 0.5 to | 1 to | | | 5.66 or |
| | smaller | 0.177 to 0.5 | 1 | 2.38 | 2.38 to 3.36 | 3.36 to 5.66 | larger |
| Percentage | 0.9 | 0.6 | 1.0 | 1.7 | 1.2 | 3.9 | 90.7 |
| before | | | | | | | |
| crushing | | | | | | | |
| (%) | | | | | | | |
| Percentage | 1.9 | 2.4 | 3.2 | 6.0 | 4.9 | 14.7 | 66.8 |
| after | | | | | | | |
| crushing | | | | | | | |
| (%) | | | | | | | |

TABLE 2-8

| | Per- | | | | | | | |
|---|---|---|---|---|---|---|---|---|
| | cent- | | | | | | | |
| | age | Component composition (% by mass) | | | | | | |
| | (%) | T.Fe | FeO | M.Fe | T.C | SiO₂ | CaO | Al₂O₃ |
| Before | — | 93.39 | 0.50 | — | 2.22 | 1.36 | 1.77 | 0.21 |
| magnetic | | | | | | | | |
| separation | | | | | | | | |
| (calculated | | | | | | | | |
| value) | | | | | | | | |
| Magnetically | 95.53 | 96.16 | 0.48 | 95.57 | 2.35 | 0.59 | 0.48 | |
| attractable | | | | | | | | 0.10 |
| substance | | | | | | | | |
| Magnetically | 4.47 | 12.14 | 8.17 | 4.63 | 2.47 | 32.41 | 36.04 | 5.86 |
| non- | | | | | | | | |
| attractable | | | | | | | | |
| substance | | | | | | | | |

TABLE 2-9

| | T.Fe | CaO/SiO₂ | | T.C |
|---|---|---|---|---|
| | (%) | (—) | Slag percentage (%) | (%) |
| Before magnetic | 93.53 | 1.30 | 1.69 | 2.22 |
| separation | | | | |
| Magnetically | 96.16 | 0.80 | 0.72 | 2.35 |
| attractable | | | | |
| substance | | | | |

### Example 2-3

In Example 2-3, a method was studied regarding collecting metallic iron from undersieve obtained by screening the discharged matter including metallic iron and slag, discharged from the rotary hearth furnace in the above-described Example 2-1, using a sifter having a sieve opening of 2.5 mm.

Table 2-10 below shows granularity distribution of magnetically attractable substance obtained by magnetically separating undersieve from screening using a sifter having a sieve opening of 2.5 mm, using a magnetic separator. Powder having a grain size smaller than 1.0 mm accounted for 53.38% of the entire magnetically attractable substance, as can be seen from Table 2-10.

Also, Table 2-11 below shows component composition of the magnetically attractable substance obtained by magnetically separating undersieve from screening using a sifter having a sieve opening of 2.5 mm, using the magnetic separator. The metallization percentage was high at 98.5% (=73.87/74.97×100), but the slag percentage was also high at 13.6% [=(8.43+1.73)/74.97×100], as can be seen from Table 2-11.

Accordingly, the magnetically attractable substance, obtained by magnetically separating undersieve from screening using a sifter having a sieve opening of 2.5 mm, using a magnetic separator, was pulverized, and the obtained pulverized matter was subjected to magnetic separation again and the metallic iron was collected. That is to say, the magnetically attractable substance obtained by magnetically separating undersieve from screening using a sifter having a sieve opening of 2.5 mm, using a magnetic separator, was pulverized, by placing 1.4 kg of the magnetically attractable substance (specimen) in a cylindrical container having a diameter of 305 mm and length of 305 mm along with 20 kg of steel balls, and rotated at 68 rpm. The pulverization time was 0 minutes (not pulverized), 5 minutes, 15 minutes, and 30 minutes. The obtained pulverized matter was magnetically separated at a magnetic separator, and the granularity distributions of the magnetically attractable substance and magnetically non-attractable substance were each studied. The results are shown in Table 2-12 below. Table 2-12 also shows the percentage of the magnetically attractable substance and the percentage of the magnetically non-attractable substance.

The slag percentage was calculated for the magnetically attractable substance, the results of which are shown in Table 2-12, and also the relationship between pulverizing time and slag percentage is illustrated in FIG. 2-4. The magnetically attractable substance obtained when the crushing time was 5 minutes had a slag percentage of 9.44%, whereas the magnetically attractable substance obtained when the crushing time was 30 minutes had a slag percentage when had fallen to 5.89%, as can be seen from Table 2-12 and FIG. 2-4. Accordingly, it can be seen that a longer pulverizing time enables the slag percentage to be reduced, and high-grade metallic iron to be collected. However, there was little reduction in slag percentage after 15 minutes pulverizing time, and the effects of pulverizing had been mostly obtained at 15 minutes.

FIG. 2-5 shows the granularity distribution of the magnetically attractable substance and magnetically non-attractable substance. In FIG. 2-5, the solid diamonds represent the results regarding the magnetically attractable substance at pulverizing time of 0 minutes, the unfilled diamonds represent the results regarding the magnetically non-attractable substance at pulverizing time of 0 minutes, the solid squares represent the results regarding the magnetically attractable substance at pulverizing time of 5 minutes, the unfilled squares represent the results regarding the magnetically non-attractable substance at pulverizing time of 5 minutes, the solid triangles represent the results regarding the magnetically attractable substance at pulverizing time of 15 minutes, the unfilled triangles represent the results regarding the magnetically non-attractable substance at pulverizing time of 15 minutes, the solid circles represent the results regarding the magnetically attractable substance at pulverizing time of 30 minutes, and the unfilled circles represent the results regarding the magnetically non-attractable substance at pulverizing time of 30 minutes.

It can be seen from Table 2-12 and FIG. 2-5 that the granular distribution of the magnetically attractable substance does not change much even of the pulverizing time is extended, but the amount of fine powder having a grain size of 0.50 mm or smaller increases in the magnetically non-attractable substance as the pulverizing time becomes longer.

TABLE 2-10

| | Grain size (mm) | | | | | | |
|---|---|---|---|---|---|---|---|
| | 4.75 or | | | | | Smaller | |
| | larger | 4.75 to 3.35 | 3.35 to 2.36 | 2.36 to 1.70 | 1.70 to 1.0 | than 1.0 | Total |
| Magnetically | 2950 | 2565 | 2900 | 3310 | 5745 | 20000 | 37470 |
| attractable | | | | | | | |
| substance (g) | | | | | | | |
| Magnetically | 7.87 | 6.85 | 7.74 | 8.83 | 15.33 | 53.38 | 100 |
| attractable | | | | | | | |
| substance (%) | | | | | | | |

TABLE 2-11
Component composition (% by mass)

| T.Fe | FeO | M.Fe | T.C | CaO | SiO₂ | Al₂O₃ |
|---|---|---|---|---|---|---|
| 74.97 | 0.74 | 73.87 | 2.90 | 9.62 | 8.43 | 1.73 |

TABLE 2-12

| | Crushing time | | | | | | | |
|---|---|---|---|---|---|---|---|---|
| | 0 minutes | | 5 minutes | | 15 minutes | | 30 minutes | |
| | | Magnetically | | Magnetically | | Magnetically | | Magnetically |
| | Magnetically | non- | Magnetically | non- | Magnetically | non- | Magnetically | non- |
| | attractable | attractable | attractable | attractable | attractable | attactable | attractable | attactable |
| Grain size | substance | substance | substance | substance | substance | substance | substance | substance |
| (mm) | (%) | (%) | (%) | (%) | (%) | (%) | (%) | (%) |
| 1.0 or | 42.78 | 13.62 | 34.66 | 8.91 | 33.77 | 5.11 | 33.28 | 1.01 |
| larger | | | | | | | | |
| 1.00 to | 11.57 | 2.24 | 9.00 | 9.10 | 7.56 | 1.45 | 7.07 | 0.42 |
| 0.710 | | | | | | | | |
| 0.710 to | 9.93 | 47.32 | 9.36 | 27.55 | 8.94 | 4.01 | 7.92 | 0.59 |
| 0.50 | | | | | | | | |
| 0.50 to | 24.86 | 26.93 | 32.45 | 28.35 | 31.28 | 41.89 | 30.72 | 25.71 |
| 0.21 | | | | | | | | |
| 0.21 to | 7.32 | 5.63 | 9.93 | 13.73 | 12.16 | 25.88 | 13.55 | 33.82 |
| 0.106 | | | | | | | | |
| 0.106 to | 1.70 | 2.11 | 2.20 | 6.07 | 3.00 | 10.94 | 3.48 | 18.04 |
| 0.075 | | | | | | | | |
| Smaller | 1.85 | 2.16 | 2.40 | 6.29 | 3.29 | 10.72 | 3.97 | 20.41 |
| than 0.075 | | | | | | | | |
| Total | 100 | 100 | 100 | 100 | 100 | 100 | 100 | 100 |
| Percentage | 97.50 | 2.50 | 89.94 | 10.06 | 84.40 | 15.60 | 83.37 | 16.63 |
| (%) | | | | | | | | |
| Slag | 13.54 | — | 9.44 | — | 6.44 | — | 5.89 | — |
| percentage | | | | | | | | |
| (%) | | | | | | | | |

### Example 2-4

In Example 2-4, metallic iron was produced following the production procedures of metallic iron illustrated in FIG. 2-6, and the crushing conditions at the crusher 34 and the type of pulverizer suitably used for the pulverizer 38 were studied.

First, the processes for producing metallic iron will be described based on FIG. 2-6. An agglomerate was formed of a mixture including an iron oxide-containing material and a carbonaceous reductant, thereby producing an agglomerate. The obtained agglomerate was introduced into the movable hearth type heating furnace 31 and heated, so that the agglomerate was melted and formed molten metallic iron, molten slag, and a reduced product. The obtained mixture was cooled, and the solid matter obtained by cooling was discharged from the movable hearth type heating furnace 31. The discharged matter containing metallic iron, slag, and hearth covering material, which was discharged from the movable hearth type heating furnace 31, was separated into coarse particular matter and fine particulate matter using the sifter a 32. The coarse particulate matter (oversieve) obtained at the sifter a 32 was crushed using the impact crusher 34. The crushed matter obtained by crushing was separated into two types using the separator 35.

The sifter was used as the separator 35. The oversieve obtained by screening by the sifter was collected out from the system as a product. On the other hand, the undersieve obtained by screening at the sifter was introduced to the magnetic separator 37. The magnetically attractable substance obtained by magnetic separating at the magnetic separator 37 was introduced to the pulverizer 38. Note that the aforementioned separator 35 and aforementioned magnetic separator 37 may be omitted.

The pulverized matter obtained at the pulverizer 38 was introduced to the magnetic separator 39 and magnetically separated. The magnetically attractable substance obtained by magnetically separating was collected from the path 48 as metallic iron. If the obtained magnetically attractable substance needed further separation from slag, it was introduced to the pulverizer 40 instead of being collected as metallic iron from the path 48.

The pulverized matter obtained at the pulverizer 40 was introduced to the magnetic separator 41, and magnetic separation was performed. The magnetically attractable substance obtained by magnetically separating was collected from the path 49 as metallic iron. If the obtained magnetically attractable substance needs further separation from slag, it may be repeatedly introduced to a pulverizer again and pulverized and magnetically separated, instead of being collected as metallic iron from the path 49.

The magnetically attractable substance obtained from the magnetic separator 41 was introduced to the agglomerate forming machine 36 (e.g., a briquette machine), formed into an agglomerate, and collected as the product 51. Note that the agglomerate forming machine 36 may be omitted. Also, FIG. 2-6 does not illustrate paths for discharging the magnetically non-attractable substance sorted out by the magnetic separators 37, 39, and 41, from the system.

Next, the crushing conditions at the crusher 34 were studied in this Example.

The pellet A shown in Table 2-13 below was used as the agglomerate. This agglomerate was introduced to the movable hearth type heating furnace 31 and reduced by heating. The reduction by heating in the furnace was performed at 1400 to 1450° C.

TABLE 2-13

| | Component composition (% by mass) | | | | | | | | |
|---|---|---|---|---|---|---|---|---|---|
| Pellet | T.Fe | FeO | T.C | CaO | SiO₂ | Al₂O₃ | MgO | CaO/SiO₂ | Al₂O₃/SiO₂ |
| A | 42.5 | 2.2 | 15.2 | 6.27 | 10.97 | 0.92 | 0.11 | 0.57 | 0.08 |

A sifter a 32 having a sieve opening of 3.35 mm was used.

A rod crusher was used as the crusher 34. The inner diameter of the rod crusher was 0.5 m, the length was 0.9 m, and 460 kg of rods serving as a pulverizing medium were placed therein.

The amount of coarse particulate matter introduced into the rod crusher was 50 kg, the crushing conditions were revolutions of 40 rpm and crushing time of 3 minutes, 5 minutes, and 10 minutes. As a result, the slag percentage of the crushed product obtained by crushing for 3 minutes was 10.2%, the slag percentage of the crushed product obtained by crushing for 5 minutes was 9.8%, and the slag percentage of the crushed product obtained by crushing for 10 minutes was 9.6%. Note that the slag percentage of the coarse matter introduced to the rod crusher was 28.0%.

The slag percentage indicates the percentage of the total mass of SiO₂ and Al₂O₃ as to the mass of the T.Fe contained in the coarse granular matter or crushed product [(SiO₂+Al₂O₃)/T.Fe×100 . . . (1)].

From the above, it was found that 3 minutes crushing time at the crusher 34 is sufficient.

Also, the type of pulverizer suitably used as the pulverizer 38 was also studied in the present Example. Note that the separator 35 and magnetic separator 37 were omitted.

A rod crusher or cage crusher was used as the pulverizer 38.

In a case of using a rod crusher, pulverizing was performed once (pulverizing time 15 minutes). As a result, the slag percentage was 13.8% when using a rod crusher as the pulverizer 38.

In a case of using a cage crusher, pulverizing was performed three times. That is to say, after one pass of pulverizing, a part of the sample was collected, this was magnetically selected, and the slag percentage of the obtained magnetically attractable substance was measured. The remainder of the sample was subjected to the second pass of pulverizing. After the second pass of pulverizing, a part of the sample was collected, this was magnetically selected, and the slag percentage of the obtained magnetically attractable substance was measured. The remainder of the sample was subjected to a third pass of pulverizing, after which this was magnetically selected, and the slag percentage of the obtained magnetically attractable substance was measured. The cage crusher used had four rows, with the diameter of the outermost row being 0.75 m, with the pins of the cage colliding with the pulverization matter at a maximum speed of 40 m/second. As a result, in a case of using a cage crusher as the pulverizer 38, the first pass was 9.8%, the second pass was 7.9%, and the third pass was 6.5%. It was found that in a case of using a cage crusher, the slag percentage could be reduced even further by repeating pulverization.

From the above results, it was found that the slag percentage contained in the pulverized matter was relatively lower in a case of using a cage crusher as compared to using a rod crusher as the pulverizer 38.

### Example 2-5

In Example 2-5, metallic iron was produced following the processes for producing metallic iron illustrated in FIG. 2-7, and the T.Fe amount included in the pulverized matter and the yield of Fe was studied.

First, the process of producing metallic iron illustrated in FIG. 2-7(a) will be described.

An agglomerate was formed of a mixture including an iron oxide-containing material and a carbonaceous reductant, thereby producing an agglomerate. The obtained agglomerate was introduced into the movable hearth type heating furnace 31, and heated, and the agglomerate was melted to form molten metallic iron, molten slag, and reduced agglomerate. The obtained mixture was cooled, and the solid matter obtained by cooling was discharged from the movable hearth type heating furnace 31.

The reduced product including metallic iron, slag, and hearth covering material, which was discharged from the movable hearth type heating furnace 31 was separated into coarse particular matter and fine particulate matter using the sifter a 32. The fine particulate matter (undersieve) obtained at the sifter a 32 was introduced to the magnetic separator 42 and magnetically separated. The magnetically non-attractable substance obtained by magnetic separation was discharged from the system by a path 43, and used as hearth covering material for the movable hearth type heating furnace. The magnetically attractable substance obtained by the magnetic separating had a T.Fe of 66.05%, and was introduced to a pulverizer 44 and pulverized.

The pulverized matter obtained by pulverizing at the pulverizer 44 was separated into two types using a separator 45. In FIG. 2-7(a), a magnetic separator 45 was used as the separator 45.

In the present Example, a ball crusher was used as the pulverizer 44 shown in FIG. 2-7(a), and magnetically attractable substance sorted at the magnetic separator 42 was pulverized. A ball crusher having an inner diameter of 0.5 m and a length of 0.5 m was used. Approximately 40 kg of pulverization specimen was introduced, 180 kg of pulverizing medium balls were placed inside, and pulverizing was performed at revolutions of 40 rpm and pulverizing time of 9 minutes. Note that the pulverizing was set to 9 minutes because raising the T.Fe percentage of the magnetically attractable substance that had been magnetically selected was difficult even of the pulverizing time was extended past 9 minutes.

The T.Fe amount contained in the pulverized matter obtained by pulverizing at the pulverizer 44, and the Fe yield, were measured. As a result, the T.Fe was 84.5% and the Fe yield was 96.3%.

Next, the process of producing metallic iron illustrated in FIG. 2-7(b) will be described. The process of producing metallic iron illustrated in FIG. 2-7(b) is a modification of the process of producing metallic iron illustrated in FIG. 2-7(a) described above.

The process of producing metallic iron illustrated in FIG. 2-7(b) is the same as the process of producing metallic iron illustrated in FIG. 2-7(a), except that a process of pulverizing the magnetically attractable substance obtained at the magnetic separator 45 using a pulverizer 46, and a process of the magnetic separator 52 magnetically separating pulverized matter obtained at the pulverizer 46, have been added. Note that the separator 45 (magnetic separator 45) may be omitted.

In the present Example, cage crushers were used as the pulverizer 44 and pulverizer 46 illustrated in FIG. 2-7(b). That is to say, the magnetically attractable substance separated at the magnetic separator 42 was pulverized at the cage crusher 44, part of the specimen was collected, and the remainder was introduced to the cage crusher 46 and pulverized.

The pulverizing conditions at the cage crusher were the same as the conditions given in Example 2-5 above.

A specimen collected from the pulverized matter obtained by the pulverizing at the cage crusher 44 (e.g., first pulverizing) was magnetically separated at an unshown magnetic separator. The T.Fe contained in the obtained magnetically attractable substance was 85.8%, and the yield of Fe was 97.7%. The specimen collected from pulverized matter obtained by pulverizing at the cage crusher 44 (i.e., first pulverizing) was magnetically separated at an unshown magnetic separator, and the obtained magnetically attractable substance was screened using a sifter with a sieve opening of 0.3 mm so as to remove fine powder having a grain size of 0.3 mm or smaller. Fine powder which has a grain size of 0.3 mm or smaller contains a great amount of slag but little T.Fe, so while the yield of Fe fell somewhat to 89.4%, the T.Fe amount increased to 93.6%, providing an iron product with even higher usage value.

Pulverized matter obtained by pulverizing at the cage crusher 46 (i.e., second pulverizing) was magnetically separated at the magnetic separator 52. The T.Fe contained in the obtained magnetically attractable substance was 88.7%, and the yield of Fe was 95.9%.

### Example 2-6

In Example 2-6, metallic iron was produced following the processes for producing metallic iron illustrated in FIG. 2-8, and the effects which the type of pulverizer 44 have on the T.Fe contained in the pulverized matter and the yield of Fe were studied.

First, the processes for producing metallic iron will be described based on FIG. 2-8.

An agglomerate was formed of a mixture including an iron oxide-containing material and a carbonaceous reductant, thereby producing an agglomerate. The obtained agglomerate was introduced into the movable hearth type heating furnace 31, and heated so that the agglomerate was melted to form molten metallic iron, molten slag, and a reduce agglomerate. The obtained mixture was cooled, and the solid matter obtained by cooling was discharged from the movable hearth type heating furnace 31. The reduced product including metallic iron, slag, and hearth covering material, which was discharged from the movable hearth type heating furnace 31 was separated into coarse particular matter and fine particulate matter using the sifter a 32. The sieve opening of the sifter used as the sifter a was 3.35 mm.

The coarse particulate matter (oversieve) obtained at the sifter a 32 was magnetically separated and the magnetically attractable substance was collected as product. The fine particular matter obtained from the sifter a 32 (undersieve) was introduced to the magnetic separator 42 and magnetically separated. The magnetically separated magnetically non-attractable was substance was discharged from the system by a path 43, and used as hearth covering material for the movable hearth type heating furnace. The magnetically attractable substance obtained by the magnetic separating was introduced to the pulverizer 44 and pulverized.

The pulverized matter obtained by pulverizing at the pulverizer 44 was introduced to the magnetic separator 55 and magnetically separated.

The magnetically attractable substance obtained by separating at the magnetic separator 55 was separated into two types using the separator 45. FIG. 2-8 illustrates an example of using a sifter 45 as the separator 45. The sieve opening of the sifter was 0.3 mm.

The undersieve screened at the sifter 45 used as the separator 45 was discharged from the system. The oversieve was introduced to the agglomerate forming machine 53 (e.g., a briquette machine), formed into an agglomerate having a shape such as a briquette or the like, and collected as the product 54.

In a case of giving priority to iron yield over the purity of the iron in the product, the sifter 45 may be omitted, with the magnetically attractable substance of the magnetic separator 55 being formed and taken as a product.

In the present Example, a ball crusher or cage crusher was used as the pulverizer 44 shown in FIG. 2-8.

A ball crusher having an inner diameter of 0.5 m and a length of 0.5 m was used. Approximately 40 kg of pulverization specimen was introduced, 180 kg of pulverizing medium balls were placed inside, and pulverizing was performed at revolutions of 40 rpm and pulverizing time of 9 minutes. Note that the pulverizing was set to 9 minutes because raising the T.Fe percentage of the magnetically attractable substance that had been magnetically selected was difficult even of the pulverizing time was extended past 9 minutes.

The T.Fe amount contained in the pulverized matter obtained by pulverizing at the pulverizer 44, and the Fe yield, were measured. As a result, the T.Fe was 84.46% and the Fe yield was 96.27%.

On the other hand, in a case of using a cage crusher, the magnetically attractable substance separated at the magnetic separator 42 was pulverized at the cage crusher 44. After pulverizing at the cage crusher 44 (after first pulverizing), the collected specimen was magnetically separated at a magnetic separator 55. The T.Fe contained in the obtained magnetically attractable substance was 85.77% and the Fe yield was 97.7%.

Also, the magnetically attractable substance obtained by magnetic separation at the magnetic separator 55 was screened using sifters having sieve openings of 0.045 mm, 0.3 mm, 1.0 mm, 3.35 mm, so as to classify into five stages of 0.045 mm or smaller, larger than 0.045 mm but 0.3 mm or smaller, larger than 0.3 mm but 1.0 mm or smaller, larger than 1.0 mm but 3.35 mm or smaller, and larger than 3.35 mm. The T.Fe at each frequency was calculated. As a result, the T.Fe amount in the powder 0.045 mm or smaller was 32.30%, the T.Fe amount in the powder larger than 0.045 mm but 0.3 mm or smaller was 45.27%, the T.Fe amount in the powder larger than 0.3 mm but 1.0 mm or smaller was 86.82%, the T.Fe amount in the powder larger than 1.0 mm but 3.35 mm or smaller was 96.18%, and the T.Fe amount in the powder larger than 3.35 mm was 96.20%. As can be seen from these results, the finer the powder, the greater the slag component and smaller the T.Fe amount is. Accordingly, removing the fine powder slightly reduces the yield of Fe, but the effects thereof are small. On the other hand, the average T.Fe can be raised, so this is effective. Note that while a sifter was used for sorting the fine powder, a wind separator may be used instead of the sifter in a case of sorting great amounts of fine powder having a grain diameter of 2 mm or smaller, for example.

Also, the specimen collected from pulverized matter obtained by pulverizing at the cage crusher 44 (i.e., first pulverizing) was magnetically separated at the magnetic separator 55, and the obtained magnetically attractable substance was screened using a sifter with a sieve opening of 0.3 mm so as to remove fine powder having a grain size of 0.3 mm or smaller. Fine powder which has a grain size of 0.3 mm or smaller contains a great amount of slag but little T.Fe, so while the yield of Fe fell somewhat to 89.4%, the T.Fe amount increased to 93.6%, providing an iron product with even higher usage value.

Also, after pulverizing at the cage crusher as a first pass, a part is returned to the cage crusher again and a second pass of pulverizing is performed. The pulverized matter is then introduced to the magnetic separator 55 and separated so as to sort into magnetically attractable substance and magnetically non-attractable substance. The magnetically non-attractable substance obtained by sorting was screened by the separator 25. The T.Fe contained in the oversieve and the yield of the Fe was calculated. As a result, the T.Fe amount was 88.72% and the Fe yield was 95.9%.

From the above results, it can be seen that the T.Fe amount contained in the obtained pulverized matter and the Fe yield changes depending on the type of the pulverizer 44.

### Example 2-7

In Example 2-7, all processes of the method of producing metallic iron according to the present invention will be described with reference to FIG. 2-9.

An agglomerate was formed of a mixture including an iron oxide-containing material and a carbonaceous reductant, thereby producing an agglomerate. The obtained agglomerate was introduced into the movable hearth type heating furnace 31, and heated to melt the agglomerate so as to form molten iron, molten slag, and a reduced agglomerate. The obtained mixture was cooled, and the solid matter obtained by cooling was discharged from the movable hearth type heating furnace 31.

The reduced product including metallic iron, slag, and hearth covering material, which was discharged from the movable hearth type heating furnace 31 was separated into coarse particular matter and fine particulate matter using the sifter a 32. The coarse particulate matter (oversieve) obtained at the sifter a 32 was magnetically separated using the magnetic separator 33. The separated magnetically non-attractable substance was discharged from the system by an unshown path. The magnetically attractable substance obtained by the magnetic separating was crushed using the impact crusher 34.

The crushed matter obtained by crushing was separated into two types using a separator 35. A magnetic separator, wind separator, sifter b, or the like may be used as the separator 35, for example.

In a case of using a magnetic separator as the separator 35, the magnetically attractable substance obtained by magnetically separating may be introduced to the agglomerate forming machine 36, and the magnetically non-attractable substance introduced to the magnetic separator 37. In a case of using a magnetic separator as the separator 35, the magnetic force is preferably set so as to be weaker than the magnetic separator 37 used downstream.

In a case of using a wind separator as the separator 35, the coarse particulate matter and matter with large specific gravity, obtained by separating by wind, may be introduced to the agglomerate forming machine 36, and the fine particulate matter introduced to the magnetic separator 37.

In a case of using a sifter b as the separator 35, the oversieve obtained by screening may be introduced to the agglomerate forming machine 36, and the undersieve introduced to the magnetic separator 37.

The magnetically non-attractable substance obtained by separating at the magnetic separator 37 may be discharged from the system, and the magnetically attractable substance introduced to the magnetic separator 36. If the obtained magnetically attractable substance needs further separation from slag, the magnetically attractable substance may be introduced to the pulverizer 38.

The pulverized matter obtained at the pulverizer 38 may be introduced to the magnetic separator 39 and separated. The magnetically non-attractable substance obtained by separating may be discharged from the system, and the magnetically attractable substance introduced to the agglomerate forming machine 36. If the obtained magnetically attractable substance needs further separation from slag, the magnetically attractable substance may be introduced to the pulverizer 40.

The pulverized matter obtained at the pulverizer 40 may be introduced to the magnetic separator 41 and separated. The magnetically attractable substance obtained by separating may be introduced to the agglomerate forming machine 36, and the magnetically non-attractable substance discharged from the system by an unshown path.

While an example has been illustrated in FIG. 2-9 where the magnetic separator 37, magnetic separator 39, and magnetic separator 41 are provided separately, a single magnetic separator may substitute for these. Also, while an example has been illustrated in FIG. 2-9 where the pulverizer 38 and pulverizer 40 are provided separately, a single pulverizer may substitute for these. The number of times of repeating magnetic separating and pulverizing is not restricted to the number of times shown in FIG. 2-9, and may be one time each, as a matter of course.

Next, description will be made returning to the sifter a 32.

The fine particulate matter obtained at the sifter a 32 was introduced to the magnetic separator 42 and separated. Note that a wind separator may be used instead of the magnetic separator 42.

The magnetically non-attractable substance obtained by magnetic separation may be discharged from the system by the path 43, and reused as hearth covering material, for example. The magnetically non-attractable substance obtained by the separation may be introduced from the magnetic separator 42 to the agglomerate forming machine 36, or may be introduced from the magnetic separator 42 to the pulverizer 44 and pulverized.

The pulverized matter obtained by pulverizing at the pulverizer 44 was separated into two types using the separator 45. A magnetic separator, wind separator, or the like, may be used as the separator 45, for example. In a case of using a magnetic separator as the separator 45, the magnetically attractable substance obtained by magnetically separating may be introduced to pulverizer 46, and the magnetically non-attractable substance discharged from the system by the path 47. In a case of using a wind separator as the separator 45, the coarse particulate matter and matter with large specific gravity, obtained by separating by wind, may be introduced to the pulverizer 46, and the fine particulate matter discharged from the system by the path 47. Both a magnetic separator and wind separator may be used as the separator 45.

The pulverized matter obtained by pulverizing at the pulverizer 46 is introduced to the magnetic separator 56 and separated to remove magnetically non-attractable substance. The magnetically attractable substance obtained by the magnetic separation may be introduced to the agglomerate forming machine 36, formed into briquettes or the like, for example, and used as an iron source.

Note that the pulverizer 44 and pulverizer 46 may be pulverizer of different types, and in a case of a specimen where separation of slag is easy, the pulverizer 46 may be omitted and the number of times that pulverizing is performed be made to be once.

### Example 3-1

After heating an agglomerate containing an iron oxide-containing material and a carbonaceous reductant in a movable hearth type heating furnace, and having screened the reduced product discharged from the heating furnace using a sifter c having a sieve opening of 15 to 20 mm, screening was performed on the undersieve c using a sifter having a sieve opening of 3.35 mm (equivalent to the above-described sifter b). The mixture above the sifter b was crushed using a crusher, and slag adhered to or enveloped by metallic iron was separated. The conditions at the time of crushing the mixture on the sifter were studied in Example 3-1.

Carbon material-containing pellets (average diameter: 19 mm) were prepared as the agglomerate, the carbon material-containing pellets were introduced into a heating furnace, and heated for 11 minutes at 1450° C. The component composition of the carbon material-containing pellets is shown in Table 3-1 below.

After screening the reduced product discharged from the heating furnace using a sifter c having a sieve opening of 15 to 20 mm, screening was performed on the undersieve c using a sifter having a sieve opening of 3.35 mm (equivalent to the above-described sifter b). The reduced product contained metallic iron, reduced pellets (i.e., a mixture of metallic iron and slag), slag, hearth covering material, and so forth.

The mixture classified as the oversieve was crushed using a crusher. A horizontal-shaft hammer crusher such as illustrated in FIG. 3-2 was used for the crusher. The specifications of the hammer crusher are as follows.

Hammer rotation speed: 3600 rpm
Hammer blade tip width: 4.8 mm
Maximum rotor length: 254 mm
Hammer blade tip speed: 48 m/second
Sieve opening of screen provided to hammer crusher: 7.8 mm

1 kg of mixture classified as the oversieve was introduced into the hammer crusher, and crushing was performed for a crushing time of 5 seconds and 10 seconds. As a result, in a case where the crushing time was 10 seconds, the surface of the particles remaining on the screen provided to the hammer crusher exhibited metallic gloss, and thus it was observed that slag was sufficiently separated.

Also, in a case where the crushing time was 5 seconds, the surface of the particles remaining on the screen provided to the hammer crusher also exhibited metallic gloss in the same way as in the case where the crushing time was 10 seconds. Thus, it was found that 5 seconds crushing time is sufficient.

The granular distribution (cumulative granularity) was measured for the powder obtained by the crushing at the hammer crusher. The measurement results are illustrated in FIG. 3-5. In FIG. 3-5, the diamonds represent the powder remaining on the screen provided to the hammer crusher, the squares represent the powder which passed through the screen provided to the hammer crusher, and the triangles represent the powder transported by gas discharged from the hammer crusher and collected by a cyclone separator provided connected to the hammer crusher, as respective results.

It can be seen from FIG. 3-5 that the gradient of the cumulative granularity has changed between grain size of 2 mm and 3 mm for the powder which has passed through the screen provided to the hammer crusher (squares in FIG. 3-5). Accordingly, the powder which has passed through the screen provided to the hammer crusher (squares in FIG. 3-5) was screened using a sifter having a sieve opening of 3.35 mm. The slag percentages [(SiO₂+Al₂O₃)/T.Fe] of the powder remaining on the sifter (hereinafter indicated as +3.35 mm) and the powder which passed through the sifter (hereinafter indicated as −3.35 mm) was calculated based on chemical analysis values. As a result it was found that the slag percentage of the +3.35 mm was 7.1%, whereas the slag percentage of the −3.35 mm was 240.7%, so the slag percentage changed greatly between the oversieve and the undersieve.

As can be thus seen from the results of Example 3-1, the large grain size powder remaining on the sifter having the sieve opening of 3.35 mm contains a high amount of metallic iron, while the small grain size powder which has passed through the sifter having the sieve opening of 3.35 mm contains a high amount of slag. Accordingly, it was found that the metallic iron and slag have different granularity distributions.

### Example 3-2

Crushing was performed in Example 3-2 under different crushing conditions with a hammer crusher, using the same type of equipment as the hammer crusher used in Example 3-1 described above but with different specifications. The rotational speed of the hammers, the hammer blade tip width, the maximum length of the rotor, the blade speed of the hammers, the sieve opening of the screen provided to the hammer crusher, and the crushing time, are illustrated in Table 3-2 below as crushing conditions of the hammer crusher. The results of No. 1 shown in Table 3-2 below indicate the results of the above-described Example 3-1.

The percentage of the powder obtained by crushing with the hammer crusher of which the grain size was 5 mm or smaller, the percentage of the powder of which the grain size was 3 mm or smaller, and the percentage of the powder of which the grain size was 1 mm or smaller, was extracted from the granularity distribution. The results are also shown in Table 3-2 below.

Also, crushing indices were calculated based on the blade speed of the hammers, the sieve opening of the screen provided to the hammer crusher, and the crushing time, which are also shown in Table 3-2.

The following observation can be made based on Table 3-2 below.

No. 1 is an example satisfying the prerequisites stipulated in the present invention, and while the percentage of particles of which the grain size exceeded 5 mm was 53.7%, the percentage of particles of which the grain size was 3 mm or smaller was 33.2%. The 66.8% particles of which the grain size exceeded 3 mm exhibited metallic gloss, and so it is conceivable that the metallic iron and slag have been suitably separated.

The blade tip speed of No. 2 is slower than in No. 1, but even of the hammer blade tip speed is 30 m/second excessive crushing occurs if the crushing index exceeds 2000, and the entire volume became particles having a grain size of 5 mm or smaller. The particles after crushing did not exhibit metallic gloss, and so it is conceivable that separation of the metallic iron and slag was insufficient.

As for No. 3, the hammer blade tip speed was 105 m/second and the crushing index far exceeds 2000, so the undersieve obtained by screening using a sifter having a sieve opening of 1 mm was 100%, indicating that not only the slag but also the metallic iron had been crushed. Accordingly, it can be seen that the crushing conditions given for No. 3 result in excessive crushing.

From the above results, it is conceivable that conditions where the blade tip speed is great and the pulverizing index is small is suitable for crushing the mixture of metallic iron and slag. A blade tip speed of 30 to 60 m/second, and a crushing index of 800 to 2000, are considered to be suitable.

TABLE 3-1
Component composition (% by mass)

| T.Fe | FeO | T.C | CaO | SiO₂ | Al₂O₃ |
|---|---|---|---|---|---|
| 48.19 | 20.47 | 16.37 | 2.90 | 7.71 | 1.87 |

TABLE 3-2

| | | Blade | Maximum | | | | | | | |
|---|---|---|---|---|---|---|---|---|---|---|
| | Rotational | tip | length of | Blade | Sieve | Crushing | | | | |
| | speed | width | rotor | speed | opening of | time | Granularity (%) | | | Crushing |
| No. | (rpm) | (mm) | (mm) | (m/sec) | screen (m) | (sec) | −5 mm | −3 mm | −1 mm | index |
| 1 | 3600 | 4.8 | 254 | 48 | 0.0078 | 5 | 46.3 | 33.2 | 22.5 | 1215 |
| 2 | 1200 | 43.0 | 460 | 30 | 0.0060 | 40 | 100 | 66.9 | 36.7 | 2449 |
| 3 | 3600 | 9.5 | 559 | 105 | 0.0100 | 60 | 0 | 0 | 100 | 8133 |

### Example 3-3

In Example 3-3, the reduced product discharged from the heating furnace in the above-described Example 3-1 was screened using a sifter having a sieve opening of 3.35 mm (equivalent to the above-described sifter b), and the mixture of the obtained undersieve was magnetically separated using a magnet. The magnetically attractable substance obtained by the magnetic separation was primarily fine metallic iron and slag, while hearth covering material accounted for the great part of the magnetically non-attractable substance.

Accordingly, raising the grade of iron of the magnetically attractable substance obtained by magnetic separation was studied in the present Example. That is to say, the undersieve mixture was pulverized using a ball crusher in the present embodiment to raise the grade of iron of the magnetically attractable substance, and separability of the metallic iron and slag was studied. This will be described below in detail.

In the above Example 3-1, the reduced product which is the discharged matter from the heating furnace was screened using a sifter having a sieve opening of 3.35 mm (equivalent to the above-described sifter b), and the mixture of the obtained undersieve was magnetically separated using a drum magnetic separator. Note that in the present Example, the component composition of the carbon material-containing pellets was changed, and reduced products (A and B) containing different amounts of slag were prepared. The amount of slag contained in the reduced product A was around 8%, and the amount of slag contained in the reduced product B was around 18%. Regarding the obtained magnetically attractable substance, 20 kg of balls and 1.4 kg of the undersieve mixture (specimen A or specimen B) were placed in a ball crusher (304 mm in diameter and 304 mm long), and pulverizing was performed at a rotation speed of 68 rotations per minute, for different pulverizing times. The pulverizing times were 0 minutes, 10 minutes, 20 minutes, and 30 minutes. The pulverized specimens were separated by hand using a magnet, and the percentage of the magnetically non-attractable substance was calculated. The percentage of magnetically non-attractable substance was calculated as the percentage by mass of the magnetically non-attractable substance as to the mass of the pulverized specimen. FIG. 3-6 illustrates the relationship between pulverizing time and percentage of magnetically non-attractable substance.

The following observation can be made based on FIG. 3-6. Pulverizing time of 0 minutes means that pulverizing using the ball crusher has not been performed, so the percentage of magnetically non-attractable substance in the specimen A was around 8%, and the percentage of magnetically non-attractable substance in the specimen B was around 18%. The fact that magnetically non-attractable substance was included in the specimen that had not been pulverized means that the magnetically non-attractable substance included in the reduced product was not sufficiently separated in the drum magnetic separator. While the specimen A and specimen B exhibit difference percentages of magnetically non-attractable substance before pulverizing using the ball crusher, the percentages of magnetically non-attractable substance increased by performing pulverization, and after having pulverized for 20 minutes, the percentage of magnetically non-attractable substance was approximately the same. Comparing pulverizing time of 20 minutes and 30 minutes shows that after 20 minutes, it can be seen that the rate of increase of the percentage of magnetically non-attractable substance becomes small, and almost flattens out. Accordingly, it is sufficient for the pulverizing time to be set to around 20 minutes. Now, with regard to specimen B, the percentage of magnetically non-attractable substance after pulverizing for 20 minutes can be found to be 33% from FIG. 3-6, so calculating the percentage of increase in the percentage of magnetically non-attractable substance based on the following expression yields approximately 84%. Thus, according to the present invention, the percentage of magnetically non-attractable substance can be increased by approximately 84% by performing pulverizing using a ball crusher.

[(percentage of magnetically non-attractable substance with pulverizing time 20 minutes−percentage of magnetically non-attractable substance with pulverizing time 0 minutes)/percentage of magnetically non-attractable substance with pulverizing time 0 minutes]×100=84(%)

### Example 3-4

In the above Example 3-1, the reduced product which is the discharged matter from the heating furnace was screened using a sifter having a sieve opening of 3.35 mm (equivalent to the above-described sifter b), and the mixture of the obtained oversieve was coarsely crushed by a hammer crusher. The coarse crushing conditions were the conditions given in the above-described Example 3-1.

The crushed matter was screened using a sifter having a sieve opening of 4.8 mm, the undersieve mixture was collected, and magnetically separated using a drum magnetic separator. The magnetically attractable substance was pulverized using a ball crusher, in order to raise the grade of iron of the magnetically attractable substance obtained by magnetic separation. Regarding pulverization of the obtained magnetically attractable substance, 20 kg of balls and 1.4 kg of the magnetically attractable substance were placed in a ball crusher (304 mm in diameter and 304 mm long), and pulverizing was performed at a rotation speed of 68 rotations per minute, for different pulverizing times. The pulverizing times were 0 minutes, 10 minutes, 20 minutes, and 30 minutes.

The pulverized magnetically attractable substance was separated by hand using a magnet, and the percentage of the magnetically non-attractable substance was calculated. The relationship between pulverizing time and percentage of magnetically non-attractable substance is shown in FIG. 3-7.

The following observation can be made based on FIG. 3-7. The reason that the value of the percentage of magnetically non-attractable substance was 12% or 19% at pulverizing time of 0 minutes means that magnetically non-attractable substance which could not be separated by magnetic separation using the drum magnetic separator has been separated by manually performing magnetic separation using the magnet. This means that the metallic iron and slag were already separated even without pulverizing. Setting the pulverizing time to 10 minutes raises the percentage of increase of the percentage of magnetically non-attractable substance by 10 to 25%, but further extending the pulverizing time tends to reduce the percentage of magnetically non-attractable substance. This phenomenon is estimated to be due to the pulverized slag being adhered to the metallic iron again. Accordingly, it can be seen that when pulverizing using a ball crusher, the pulverizing time is preferably within 10 minutes.

### Example 3-5

Example 3-5 was performed the same as in the above-described Example 3-4 but differing with regard to the point of performing coarse crushing using a cage crusher instead of performing coarse crushing using a hammer crusher, and the point of using a ball crusher or rod crusher for pulverizing the magnetically attractable substance. That is to say, in the above-described Example 3-1, the reduced product which is the discharged from the heating furnace was screened using a sifter having a sieve opening of 3.35 mm (equivalent to the above-described sifter b), and the mixture of the obtained oversieve was coarsely crushed by a cage crusher. The coarse crushing conditions were that the cage had four rows (the diameter of the outermost row being 745 mm and the diameter of the inner side being 610 mm), the rotations were 1000 rpm, the charging volume was 10 tons per hour, with the charging amount being 13 kg each time.

The crushed product was screened using a sifter having a sieve opening of 3.35 mm, the undersieve mixture was collected, and magnetically separated using a drum magnetic separator. The magnetically attractable substance was pulverized using a ball crusher or rod crusher, to raise the grade of iron of the magnetically attractable substance obtained by magnetic separation.

### (Ball Crusher)

Pulverizing of the magnetically attractable substance was performed by loading 180 kg of balls and 38 kg of magnetically attractable substance into a ball crusher (525 mm diameter×450 mm long), the rotational speed was set to 41 rotations per minute, and the pulverizing time was set to 0 minutes, 3 minutes, 6 minutes, 9 minutes, and 12 minutes.

### (Rod Crusher)

Pulverizing of the magnetically attractable substance was performed by loading 460 kg of rods and 42 kg of magnetically attractable substance into a rod crusher (525 mm diameter×900 mm long), the rotational speed was set to 41 rotations per minute, and the pulverizing time was set to 0 minutes, 3 minutes, 6 minutes, 9 minutes, and 12 minutes.

The pulverized magnetically attractable substance was manually magnetically separated using a magnet, and the percentage of magnetically non-attractable substance was obtained.

The relationship between the pulverizing time and percentage of magnetically non-attractable substance is shown in FIG. 3-8. The diamonds represent the results of pulverizing using a ball crusher, and the squares represent the results of pulverizing using a rod crusher, in FIG. 3-8.

The following observation can be made based on FIG. 3-8. The percentage of magnetically non-attractable substance shown is 10% when the pulverizing time is 0 minutes, regardless of whether pulverizing using a ball crusher or a rod crusher. This means that magnetically non-attractable substance which could not be separated by magnetic separation using the drum magnetic separator has been separated by manually performing magnetic separation using the magnet. Pulverizing using the ball crusher and pulverizing using the rod crusher both exhibit very similar results. It can be seen that the percentage of magnetically non-attractable substance is the greatest at 6 minutes pulverizing time, and making the pulverizing time even longer reduces the percentage of magnetically non-attractable substance. It can also be seen that the amount of decrease is greater when pulverizing using a ball crusher.

As a result of the above, it can be seen that the percentage of magnetically non-attractable substance increases around 54% by pulverizing the magnetically attractable substance for 6 minutes using a ball crusher or rod crusher, and that the grade of metallic iron improves.

### Example 3-6

FIG. 3-9 is a schematic diagram illustrating another metallic iron producing process according to the present invention. In FIG. 3-9, a mixture including an iron oxide-containing material, a carbonaceous reductant, and an additive, is formed into an agglomerate using the pan pelletizer 1, thereby producing an agglomerate. The obtained agglomerate is introduced to the rotary hearth furnace 2 and heated. The reduced product obtained by heating in the rotary hearth furnace 2 is screened using the sifter 3 having a sieve opening of 3.35 mm (equivalent to the sifter b).

The collected matter collected at the sifter 3 as oversieve is supplied to the rod crusher 4a which is an impact crusher, and crushed. The oversieve obtained by crushing at the rod crusher 4a and screening at a sifter (equivalent to the sifter a) provided outside of the rod crusher is collected as metallic iron. On the other hand, the undersieve obtained by crushing at the rod crusher 4a and screening at the sifter (equivalent to the sifter a) provided outside of the rod crusher is supplied to the magnetic separator 10, and separated into magnetically attractable substance and magnetically non-attractable substance. The collected matter collected at the sifter 3 as undersieve is supplied to the magnetic separator 10, and separated into magnetically attractable substance and magnetically non-attractable substance.

The magnetically attractable substance sorted at the magnetic separator 10 is collected as metallic iron. The magnetically non-attractable substance sorted at the magnetic separator 10 is supplied to a ball crusher 11a and pulverized, and the pulverized matter is supplied to the magnetic separator 12 and separated into magnetically attractable substance and magnetically non-attractable substance.

The magnetically attractable substance sorted at the magnetic separator 12 is collected as metallic iron. On the other hand, the magnetically non-attractable substance sorted at the magnetic separator 12 is almost all slag.

As described above, metallic iron can be produced by the configuration example illustrated in FIG. 3-9 as well.

### Example 4-1

An agglomerate formed of a mixture of raw materials including an iron oxide-containing material and a carbon material was heated in a heating furnace, and iron oxide in the agglomerate was reduced, thereby producing a metallic iron-containing sintered body.

Iron ore having the component composition shown in Table 4-1 below was used as the iron oxide-containing material. In the Table, T.Fe means total iron amount. Coal having the component composition illustrated in Table 4-2 below was used as the carbon material. A raw material mixture was formed of the iron ore and coal, to which were further added a powder of limestone and Al₂O₃ as a melting point controlling agent and flour as a binder, to which a small amount of water was added, and carbon material-containing pellets having a minor axis of 19 mm were produced in a tumbling granulator.

The obtained carbon material-containing pellets were dried at 180° C., thereby producing dry pellets (agglomerate). Table 4-3 below shows the component composition of the dry pellets. The basicity (CaO/SiO₂) and ratio of Al₂O₃ and SiO₂ (Al₂O₃/SiO₂) were calculated based on the component composition of the dry pellets shown in Table 4-3, and are shown along therewith.

A horizontal electrical furnace was prepared as the heating furnace, and the dry pellets were heated for a total of 11 minutes in the horizontal electrical furnace which the temperature was raised in the three stages of 1200° C., 1350° C., and 1370° C. to cause a reducing reaction. Thereafter, the dry pellets were extracted to a cooling zone and cooled to room temperature, thereby producing metallic iron-containing sintered bodies. The atmosphere within the horizontal electrical furnace and the atmosphere in the cooling zone was a mixed gas atmosphere of a mixture of carbon dioxide gas and nitrogen gas by 75% to 25% by volume.

The state of the obtained metallic iron-containing sintered bodies was a mixture containing granular metallic iron and slag being enveloped on the inner side of an outer wheel containing metallic iron and slag, and the surface temperature was 1000° C. or lower. The average minor axis of the metallic iron-containing sintered bodies was 15 mm.

The obtained metallic iron-containing sintered bodies were pulverized, and slag was removed to produce metallic iron. FIG. 4-2 is a flowchart of this. Description will be made hereinafter with reference to FIG. 4-2. Note that parts corresponding to FIG. 4-1 have been denoted with the same reference numerals.

After the metallic iron-containing sintered bodies 1 (9 kg) were pulverized using a jaw crusher denoted by 2 in FIG. 4-2 (first pulverizing process), the pulverized matter was screened using a sifter a denoted by 3 in FIG. 4-2 (screening process). A sifter having a sieve opening of 1 mm was used as the sifter a.

The fine particles which passed through the sifter a were sorted into magnetically attractable substance 11 and magnetically non-attractable substance 12 using the magnetic separator 7, with the magnetically attractable substance 11 being collected as metallic iron. The mass of the magnetically attractable substance was 2.38 kg, and T.Fe was 72.8%.

On the other hand, the coarse particles remaining on the sifter a were supplied to a roll press 4a using a vibrational feeder at a specimen supply speed of 0.1 kg/minute, and after pulverizing using the roll press 4a (gap between rolls set at 1 mm) (second pulverizing process), a magnetic separator 5a was used to sort the magnetically attractable substance and magnetically non-attractable substance.

The magnetically attractable substance obtained by sorting at the magnetic separator 5a was subjected to another three times of repeated pulverization at roll presses 4b through 4d and separation at magnetic separators 5b through 5d, and the magnetically attractable substance was collected as metallic iron (metallic iron collecting process). That is to say, the magnetically attractable substance sorted at the magnetic separator 5a was pulverized using the roll press 4b (gap between rolls set at 0.15 mm), and thereafter sorted into magnetically attractable substance and magnetically non-attractable substance using the magnetic separator 5b. The magnetically attractable substance sorted at the magnetic separator 5b was pulverized using the roll press 4c (gap between rolls set at 0.15 mm), and thereafter sorted into magnetically attractable substance and magnetically non-attractable substance using the magnetic separator 5c. The magnetically attractable substance sorted at the magnetic separator 5c was pulverized using the roll press 4d (gap between rolls set at 0.15 mm), and thereafter sorted into magnetically attractable substance and magnetically non-attractable substance using the magnetic separator 5d. The magnetically attractable substance sorted at the magnetic separator 5d was collected as metallic iron. The mass of the magnetically attractable substance sorted at the magnetic separator 5d was 3.9 kg, and T.Fe was 88.1%.

The magnetically non-attractable substance sorted at the magnetic separators 5a, 5b, 5c, and 5d was sorted into magnetically attractable substance 9 and magnetically non-attractable substance 10 at a manual magnetic separator 6, with the magnetically attractable substance 9 being collected as metallic iron. The mass of the magnetically attractable substance 9 was 1.23 kg, and T.Fe was 75.9%.

From the above results, according to the present invention, out of the mass (9 kg) of the metallic iron-containing sintered bodies, 83.4% [(2.38+3.9+1.23)/9×100] was collected as metallic iron.

TABLE 4-1
Component composition iron ore (% by mass)

| T.Fe | FeO | T.C | CaO | SiO₂ | Al₂O₃ | MgO | S | P | Na₂O | K₂O |
|---|---|---|---|---|---|---|---|---|---|---|
| 65.17 | 25.63 | 0.04 | 0.22 | 8.61 | 0.03 | 0.25 | 0.007 | 0.013 | 0.067 | 0.18 |

TABLE 4-2

| Component composition of coal | | | | | | | |
|---|---|---|---|---|---|---|---|
| (% by mass) | | | | | | | |
| | | Fixed | Component composition of | | | | |
| Volatile | Ash | car- | ash component (% by mass) | | | | |
| component | component | bon | T.Fe | CaO | SiO₂ | Al₂O₃ | MgO |
| 17.95 | 9.43 | 72.62 | 5.12 | 6.06 | 45.93 | 29.24 | 2.24 |

TABLE 4-3

| Component composition of dry pellet (% by mass) | | | | | | | | Al₂O₃/ |
|---|---|---|---|---|---|---|---|---|
| T.Fe | FeO | CaO | SiO2 | Al₂O₃ | MgO | T.C | CaO/SiO₂ | SiO₂ |
| 49.33 | 20.64 | 2.19 | 7.56 | 0.61 | 0.23 | 16.81 | 0.290 | 0.081 |

### Example 4-2

The metallic iron-containing sintered bodies obtained in the above-described Example 4-1 were pulverized by other means, and slag was removed to produce metallic iron. FIG. 4-3 is a flowchart of this. Description will be made hereinafter with reference to FIG. 4-3. Note that parts corresponding to FIG. 4-1 and FIG. 4-2 have been denoted with the same reference numerals. In FIG. 4-3, 13 denotes a drum magnetic separator, 14 denotes pulverizing means, 15 denotes a magnetic separator, and 18 denotes magnetically non-attractable substance.

After the metallic iron-containing sintered bodies 1 (34.5 kg) were pulverized using a roll press denoted by 2 in FIG. 4-3 (first pulverizing process), the pulverized matter was screened using a sifter a denoted by 3 in FIG. 4-3 (screening process). A sifter having a sieve opening of 1 mm was used as the sifter a.

The fine particles which passed through the sifter a were pulverized at a disc crusher 16, and thereafter sorted into magnetically attractable substance 11 and magnetically non-attractable substance 12 using the magnetic separator 7, with the magnetically attractable substance 11 being collected as metallic iron. The mass of the magnetically attractable substance 11 magnetically separated at the magnetic separator 7 was 6.28 kg, and T.Fe was 75.25%.

In a case of sorting the fine particles which passed through the sifter a into magnetically attractable substance 11 and magnetically non-attractable substance 12 using the magnetic separator 7, as they were without being pulverized at the disc crusher 16, and the magnetically attractable substance 11 was collected as metallic iron, the T.Fe of the magnetically attractable substance 11 sorted by the magnetic separator 7 was 71.26%. It can thus be seen that the T.Fe contained in the magnetically attractable substance was raised by 4% by being pulverized at the disc crusher 16.

On the other hand, the coarse particles remaining on the sifter a were supplied to the hammer crusher 4 and pulverized, and a sifter 5a (sieve opening of 2.38 mm) was used to classify into coarse particles remaining on the sifter 5a and fine particles passing through the sifter 5a.

The coarse particles remaining on the sifter 5a were supplied to a splitter 17 and stored, while a part thereof was returned to the hammer crusher 4 and pulverized again, a part was supplied to a sifter 5b, and classified into coarse particles remaining on the sifter 5b and fine particles passing through the sifter 5b, using the sifter 5b (sieve opening of 4.76 mm).

The coarse particles remaining on the sifter 5b were returned to the hammer crusher 4 and pulverized again. The process of returning the coarse particles remaining on the sifter 5b to the hammer crusher 4 and pulverizing again was repeated three times. As a result, the mass of the fine particles obtained by passing through the sifter 5b the first time was 7.0 kg, the percentage of magnetically non-attractable substance contained in these fine particles was 2.5%, and the percentage of slag was 17.8%. The mass of the fine particles obtained by passing through the sifter 5b the second time was 2.0 kg and the percentage of magnetically non-attractable substance contained therein was 1.5%, and the percentage of slag was 16.4%. The mass of the fine particles obtained by passing through the sifter 5b the third time was 1.1 kg and the percentage of magnetically non-attractable substance contained therein was 1.0%, and the percentage of slag was 14.7%.

The fine particles which passed through the sifter 5b were supplied to a sifter 5c, and the sifter 5c (sieve opening of 2.38 mm) was used to classify into coarse particles remaining on the sifter 5c and fine particles passing through the sifter 5c. The coarse particles 8 remaining on the sifter 5c were collected as metallic iron. The mass of the coarse particles 8 was 15.7 kg, and T.Fe was 78%.

1. A method for producing metallic iron, the method comprising:
a process of forming an agglomerate of a mixture containing an iron oxide-containing material and a carbonaceous reductant;
a process of introducing the obtained agglomerate into a movable hearth type heating furnace and reducing by heating;
a process of crushing a reduced product containing metallic iron and slag that has been discharged from the movable hearth type heating furnace, using a crusher; and
a process of sorting using a separator and collecting the metallic iron.

2. The method for producing according to claim 1, wherein an impact crusher is used as the crusher.

3. The method for producing according to claim 2, further comprising:
a process of screening the reduced product containing metallic iron and slag that has been discharged from the movable hearth type heating furnace, into coarse particulate matter and fine particulate matter, using a sifter a;
a process of crushing the obtained coarse particulate matter using an impact crusher; and
a process of sorting using a separator and collecting the metallic iron.

4. The method for producing according to claim 2, wherein a hammer crusher, cage crusher, rotor crusher, ball crusher, roller crusher, or rod crusher is used as the crusher.

5. The method for producing according to claim 4, wherein a crusher which applies impact from one direction is used as the crusher.

6. The method for producing according to claim 3, wherein the bulk density of the coarse particulate matter is 1.2 to 3.5 kg/L.

7. The method for producing according to claim 3, wherein the coarse particulate matter is magnetically separated using a magnetic separator prior to crushing the coarse particulate matter and a magnetically attractable substance is collected, and the collected magnetically attractable substance is crushed.

8. The method for producing according to claim 2, wherein a magnetic separator is used as the separator.

9. The method for producing according to claim 2, wherein a wind separator is used as the separator.

10. The method for producing according to claim 2, wherein a sifter b is used as the separator.

11. The method for producing according to claim 10, wherein screening is performed using the sifter b, following which an undersieve is separated using a magnetic separator and metallic iron is collected.

12. The method for producing according to claim 10, wherein a sifter having a sieve opening of 1 to 8 mm is used as the sifter b.

13. The method for producing according to claim 8, further comprising:
a pulverizing process of pulverizing the magnetically attractable substance, obtained by selecting using the magnetic selector, using a pulverizer.

14. The method for producing according to claim 13, wherein the pulverized matter obtained in the pulverizing process is pulverized again using the pulverizer.

15. The method for producing according to claim 13, wherein the pulverized matter obtained in the pulverizing process is separated using a magnetic selector and magnetically attractable substance is collected.

16. The method for producing according to claim 15, wherein the collected magnetically attractable substance is formed into an agglomerate.

17. The method for producing according to claim 13, wherein a ball crusher, rod crusher, cage crusher, rotor crusher, or roller crusher, is used as the crusher.

18. A method for producing metallic iron, the method comprising:
a process of forming an agglomerate of a mixture containing an iron oxide-containing material and a carbonaceous reductant;
a process of introducing the obtained agglomerate into a movable hearth type heating furnace and reducing by heating;
a process of separating a reduced product containing metallic iron and slag that has been discharged from the movable hearth type heating furnace, into coarse particulate matter and fine particulate matter, using a sifter a; and
a process of sorting the obtained fine particulate matter using a separator, and collecting the metallic iron.

19. The method for producing according to claim 18, wherein a magnetic separator is used as the separator, and the magnetically attractable substance obtained by selection by the magnetic separator is collected as the metallic iron.

20. The method for producing according to claim 18, further comprising:
a process of pulverizing the fine particulate matter using a pulverizer;
wherein metallic iron contained in the obtained pulverized matter is collected using the separator.

21. The method for producing according to claim 20, wherein the pulverized matter obtained in the pulverizing process using the pulverizer is pulverized again using the pulverizer.

22. The method for producing according to claim 20, wherein a ball crusher, rod crusher, cage crusher, rotor crusher, or roller crusher, is used as the crusher.

23. The method for producing according to claim 20, wherein the fine particulate matter is magnetically separated using a magnetic separator prior to crushing the fine particulate matter using a pulverizer, and a magnetically attractable substance obtained by selecting by the magnetic separator is collected.

24. The method for producing according to claim 19, wherein the collected magnetically attractable substance is formed into an agglomerate.

25. The method for producing according to claim 3, wherein a sifter having a sieve opening of 2 to 8 mm is used as the sifter a.

26. The method for producing according to claim 1, where the process of reducing by heating is a process in which the agglomerate formed in the process of forming an agglomerate is introduced into a movable hearth type heating furnace and heated, and the agglomerate is melted to form molten metallic iron, molten slag, and a reduced agglomerate, the method further comprising:
a process of cooling the mixture obtained in this process; and
a process of discharging a solid matter obtained by cooling, from the movable hearth type heating furnace;
wherein, in the process of crushing, discharged matter including metallic iron, slag, and hearth covering material discharged from the movable hearth type heating furnace, is crushed using a crusher.

27. The method for producing according to claim 26, further comprising:
a process of screening the discharged matter including metallic iron, slag, and hearth covering material that has been discharged from the movable hearth type heating furnace, into oversieve and undersieve, using a sifter a;
a process of crushing the obtained oversieve using a crusher; and
a process of sorting the obtained crushed matter using a separator and collecting the metallic iron.

28. The method for producing according to claim 26, wherein a hammer crusher, cage crusher, rotor crusher, ball crusher, roller crusher, or rod crusher is used as the crusher.

29. The method for producing according to claim 27, wherein the oversieve contains 95% or more iron in equivalent to iron component.

30. The method for producing according to claim 27, wherein the oversieve is magnetically separated using a magnetic separator prior to crushing the oversieve and a magnetically attractable substance is collected, and the collected magnetically attractable substance is crushed.

31. The method for producing according to claim 26, wherein a magnetic separator is used as the separator.

32. The method for producing according to claim 26, wherein a wind separator is used as the separator.

33. The method for producing according to claim 26, wherein a sifter b is used as the separator.

34. The method for producing according to claim 33, wherein screening is performed using the sifter b, following which an undersieve is separated using a magnetic separator and metallic iron is collected.

35. The method for producing according to claim 33, wherein a sifter having a sieve opening of 1 to 8 mm is used as the sifter b.

36. The method for producing according to claim 34, further comprising:
a pulverizing process of pulverizing the magnetically attractable substance, obtained by selecting using the magnetic selector, using a pulverizer.

37. The method for producing according to claim 36, wherein the pulverized matter obtained in the pulverizing process is pulverized again using the pulverizer.

38. The method for producing according to claim 36, wherein the pulverized matter obtained in the pulverizing process is separated using a magnetic selector and magnetically attractable substance is collected.

39. The method for producing according to claim 38, wherein the collected magnetically attractable substance is formed into an agglomerate.

40. The method for producing according to claim 36, wherein a ball crusher, rod crusher, cage crusher, rotor crusher, or roller crusher, is used as the crusher.

41. A method for producing metallic iron, the method comprising:
a process of forming an agglomerate of a mixture containing an iron oxide-containing material and a carbonaceous reductant;
a process of introducing the obtained agglomerate into a movable hearth type heating furnace and heating, so that the agglomerate is melted to form molten metallic iron, molten slag, and a reduced agglomerate;
a process of cooling the obtained mixture;
a process of discharging a solid matter obtained by cooling, from the movable hearth type heating furnace;
a process of screening discharged matter containing metallic iron, slag, and hearth covering material that has been discharged from the movable hearth type heating furnace, using a sifter a; and
a process of sorting the undersieve obtained in the process of screening using a separator, and collecting the metallic iron.

42. The method for producing according to claim 41, wherein a magnetic separator is used as the separator, and a magnetically attractable substance obtained by selection by the magnetic separator is collected as the metallic iron.

43. The method for producing according to claim 42, further comprising:
a process of pulverizing the obtained magnetically attractable substance using a pulverizer; and
a process of separating the obtained pulverized matter using a separator and collecting metallic iron.

44. The method for producing according to claim 41, further comprising:
a process of pulverizing at least a part of undersieve obtained in the process of screening, using a pulverizer.

45. The method for producing according to claim 44, wherein the pulverized matter obtained in the process of pulverizing using the pulverizer is magnetically separated using a magnetic separator, and an obtained magnetically attractable substance is collected.

46. The method for producing according to claim 44, wherein the pulverized matter obtained in the process of pulverizing using the pulverizer is pulverized again using the pulverizer.

47. The method for producing according to claim 43, wherein the collected metallic iron or the collected magnetically attractable substance is formed into an agglomerate.

48. The method for producing according to claim 43, wherein the pulverizer applies the magnetically attractable substance with at least one selected from a group consisting of impact force, friction force, and compression force.

49. The method for producing according to claim 48, wherein a ball crusher, rod crusher, cage crusher, rotor crusher, or roller crusher, is used as the crusher.

50. The method for producing according to claim 27, wherein a sifter having a sieve opening of 2 to 8 mm is used as the sifter a.
